SEQUENCE LISTING (7 sequences)

SEQ ID NO: 1 - DNA, 10 bp, Artificial Sequence
  synthetic construct; consensus sequence of SRF binding site
ccwtatawgg

SEQ ID NO: 2 - DNA, 15 bp, Artificial Sequence
  synthetic construct; combined binding site of SOX2 and POU5F1
cattgtyatgcaaat

SEQ ID NO: 3 - DNA, 12 bp, artificial sequence
  synthetic construct; ESRRB motif
dbysaagstsan

SEQ ID NO: 4 - DNA, 11 bp, Artificial Sequence
  synthetic construct; GRBE motif
rgacagwgtcy

SEQ ID NO: 5 - DNA, 10 bp, Artificial Sequence
  synthetic construct; HNF3 motif
awrryaaaya

SEQ ID NO: 6 - DNA, 12 bp, Artificial Sequence
  synthetic construct; NF1 motif
ywgrwsswgcca

SEQ ID NO: 7 - DNA, 12 bp, Artificial Sequence
  synthetic construct; TEAD1 motif
nrcattcywvbb

(19) United States
(12) Patent Application Publication
(10) Pub. No.: US 2014/0129152 A1
(43) Pub. Date: May 8, 2014

(54) Methods, Systems and Devices Comprising Support Vector Machine for Regulatory Sequence Features

(71) Applicants: Michael Beer, Baltimore, MD (US); Dongwon Lee, Ellicott City, MD (US)

(72) Inventors: Michael Beer, Baltimore, MD (US); Dongwon Lee, Ellicott City, MD (US)

(21) Appl. No.: 14/013,920

(22) Filed: Aug. 29, 2013

Related U.S. Application Data
(60) Provisional application No. 61/694,641, filed on Aug. 29, 2012.

(51) Int. Cl. G06F 19/18

(52) U.S. Cl. CPC G06F 19/18
USPC 702/19

(57) ABSTRACT

The present invention comprises methods and systems for identifying enhancer sequences in DNA, for example, in mammalian genomes. The enhancer sequences are identified using a trained support vector machine (SVM) as disclosed herein.

### RELATED APPLICATIONS

The present application claims the benefit of priority and filing date of U.S. Provisional Patent Application Ser. No. 61/694,641, filed Aug. 29, 2012, which is incorporated herein by reference in its entirety.

### STATEMENT REGARDING FEDERALLY SPONSORED RESEARCH

This invention was made with government support under NS062972 awarded by the National Institute of Health. The government has certain rights in the invention.

### REFERENCE TO SEQUENCE LISTING

The Sequence Listing submitted Jan. 3, 2013 as a text file named “36406_{—}0003U2_Sequence Listing.txt,” created on Jan. 2, 2014, and having a size of 1,984 bytes is hereby incorporated by reference pursuant to 37 C.F.R. §1.52(e)(5).

### FIELD OF THE INVENTION

Disclosed herein are methods, systems and compositions relating to computer-implemented methods for identifying nucleic acid regulatory sequences comprising methods and systems comprising a support vector machine classifier.

### BACKGROUND

Gene regulatory sequences, such as enhancers, can control cellular activities, such as transcriptional activities, at a distance, independent of their position and orientation with respect to affected genes (Banerji 1981). For example, enhancer activity is modulated by interactions between sequence specific DNA binding proteins and sequence elements in the enhancer. Since individual transcription factor binding sites (TFBSs) can be relatively short and degenerate, TFBSs tend to be clustered to achieve precise temporal and developmental specificity (Kadonaga 2004). Factors bound to these sequences often interact with common coactivators, which, in turn, recruit the basal transcription machinery (Blackwood and Kadonaga 1998; Carter et al. 2002).

Identifying the sequence elements and the combinatorial rules that determine enhancer function is necessary to fully understand how enhancers direct the spatial and temporal regulation of gene expression. Experimentally identified enhancers with similar functions can be a good starting point for in-depth study of the underlying rules encoded in the regulatory DNA sequence. However, the systematic functional identification of such enhancers has been limited due to the fact that they are often distant from the genes they regulate, requiring the interrogation of large amounts of potential regulatory sequence.

What is needed are methods and systems for identifying regulatory sequences.

### SUMMARY

The present invention comprises computer implemented systems and methods for enhancing knowledge discovered from data using a learning machine in general and a support vector machine in particular. In particular, the present invention comprises methods of using a learning machine for identifying regulatory sequences such as those that provide direction or control for cellular transcription, such as enhancers, repressors and/or insulators.

In an exemplary embodiment, a system is provided for identifying regulatory sequences such as enhancer sequences in DNA from data using a support vector machine (SVM). An exemplary system comprises a storage device for storing a training data set and a test data set, and a processor for executing a support vector machine. The processor is also operable for collecting the training data set from the database, training the support vector machine using the training data set, collecting the test data set from the database, operating the trained support vector machine with the test data set, and identifying the sequences that are enhancer sequences by the trained SVM. Steps, such as in vivo or in vitro testing of the identified sequences to function as regulatory sequences, such as enhancer sequences, may be performed. An exemplary system may also comprise a communications device for receiving the test data set and the training data set from a remote source. In such a case, the processor may be operable to store the training data set and the test data set in a storage device. The exemplary system may also comprise a display device for displaying the test data results. The processor of the exemplary system may further be operable for performing each additional function described above. The communications device may be further operable to send a computationally derived alphanumeric classifier or other SVM-based raw output data to a remote source.

The invention may further comprise providing the SVM for others to use, such as providing an Internet-based SVM that may or may not be trained, for use by others.

Disclosed herein is a training data set of enhancer sequences as described herein.

Disclosed herein is an algorithm used in training the SVM.

Disclosed herein are enhancer sequences identified by the trained SVM.

### BRIEF DESCRIPTION OF THE FIGURES

The accompanying figures, which are incorporated in and constitute a part of this specification, illustrate several aspects and together with the description serve to explain the principles of the invention.

FIG. 1 is a flowchart showing an overview of a method of the present invention.

FIG. 2 provides an overview of the methodology. (A) k-mer frequencies were calculated for each of the EP300-bound and negative genomic training sequences. These feature vectors (x1, . . . , xn) were used to find SVM weights, w, which most accurately separate the positive (enhancer) and negative (genomic) training sets. (B) These weights were used to predict genome-wide enhancers (light green), based on their SVM score. (Brown) positive, (blue) negative. A well-studied region around Dlx1 and Dlx2 was shown here, both known to be expressed in the forebrain. While the predicted enhancers often overlapped the training EP300 set (blue), novel enhancers were also predicted and often identified previously experimentally verified enhancers (red) absent from the EP300 training set. The predicted enhancers also preferentially occurred in conserved nonexonic regions (dark green) and regions enriched in EP300 signal (dark blue).

FIG. 3 shows classification results on each tissue-specific enhancer set. (A) Classification of forebrain enhancers vs. random genomic sequences. (B) Classification of midbrain enhancers vs. random genomic sequences. (C) Classification of limb enhancers vs. random genomic sequences. Each graph in A, B, and C compared an SVM trained on the full set of 6-mers (solid), the top 100 selected 6-mers (dashed), and an alternative Naive Bayes classifier (dotted). Each curve was an average of five cross-fold validations on a reserved test set; error bars denote one standard deviation over the five cross-fold validation sets. Numbers in parentheses indicate the area under each ROC curve (auROC) for overall comparison. Both the full SVM and SVM with selected features performed very well and significantly better than Naive Bayes. Individually, each tissue-specific set can be accurately discriminated from nonenhancer genomic sequences. (D) Classification of specific tissues vs. other tissues. Forebrain (fb) and midbrain (mb) can be accurately discriminated from limb (lb) but not from each other (fb vs. mb), indicating common or overlapping modes of regulation. (E) Classification ROC curves for forebrain enhancers vs. random genomic sequences for larger negative set sizes. (F) Precision-recall curves for forebrain enhancers vs. random sequences corresponding to the ROC curves and negative sets in E; numbers in parentheses are auPRC. (G) Classification of EP300 forebrain enhancers, neuronal stimulus-dependent enhancers (CREBBP neuron), and mouse embryonic stem cell enhancers (EP300 ES) vs. random genomic sequence. Although the embryonic stem cell data set is somewhat less accurately classified, these SVMs successfully discriminated EP300 or CREBBP bound regions from random sequences. (H) Classification of EP300 fb, CREBBP neuron, and EP300 ES data sets vs. each other was also robust.

FIG. 4 shows predictive SVM sequence features were more conserved. Scatter plot between SVM weights and conservation scores (phastCons scores) for 6-mers in forebrain enhancers was shown. Two well-known TFBS, TAAT cores (red rectangles), and E-box elements (blue triangles) were highlighted. Three standard deviations above the mean (corresponding to P-value of ˜0.001) was denoted for each axis independently. The sequence of all 6-mers beyond three standard deviations above the mean was displayed.

FIG. 5 shows predictive SVM sequence features were spatially clustered and distributions of minimum pairwise distances between the most predictive sequence features in forebrain enhancers vs. random genomic sequences. Ten 6-mers with the largest positive SVM weights (Table 1) were used. To measure the significance of these differences, 100 distinct full negative genomic sequence sets were generated (using the null model; disclosed herein). Each negative set had the same length, repeat fraction, and number of sequences as the EP300 forebrain enhancer training set. The predictive elements were significantly clustered in the forebrain enhancers compared to the random genomic sequences (the red distribution is significantly shifted toward smaller minimum distance). At higher resolution (inset), distinct peaks around 11 bp, 22 bp, etc., were observed, suggesting positioning in phase with the periodicity of the DNA helix. P-values were indicated: (*)<0.01, (**)<0.001, (***)<0.0001.

FIG. 6 shows SVM-predicted regions were hypersensitive to DNase I in the relevant context. To independently confirm predictions with DNase I measurements in the embryonic mouse brain, the distributions of the average intensity of DNase I hypersensitivity of different forebrain SVM scoring regions were plotted. (A) DNase I hypersensitivity measured in E14.5 wholebrain. (B) DNase I hypersensitivity measured in an adult 8-wk kidney, as a negative control. Significant enrichments were observed only in high-scoring SVM-predicted regions in the brain.

FIG. 7 shows SVM-predicted enhancers were preferentially located near transcript start sites (TSSs) of forebrain-expressed genes. Here, plotted were the distribution of the distance between the EP300 and SVM predicted regions and the nearest forebrain-expressed gene [as assessed by the microarray experiments of Visel et al. (2009)]. Any region which overlapped a training set region was excluded from the analysis. Both the EP300 (red) and SVM-predicted regions were preferentially located within 10 kb of the TSS of a forebrain-overexpressed gene (above the axis). This was true whether a cut-off of SVM>1.5 (green) or a more restrictive SVM>2.0 (blue) was used to define the enhancer set. As a null set, the average of 100 randomized genomic positions, with a 95% confidence interval shown (gray) was compared. Interestingly, when calculating the same distributions for the distance between a EP300 or SVM predicted region and the nearest forebrain-underexpressed gene (below the axis), only the SVM predicted regions showed significant clustering toward the TSS, relative to the randomized control. Although the EP300 data preferentially identified activating enhancers in the forebrain, the SVM may have been detecting common sequence features shared in enhancers, which were repressive in the forebrain but were activating in other contexts.

FIG. 8 shows Table 1, Predictive 6-mers of EP300 forebrain.

FIG. 9 shows Table 2, Precision and sensitivity of detecting DNase I hypersensitive enhancers.

FIGS. 10A and B shows a comparison of the performance of SVM models with different kernels and k-mer lengths, and a Naïve bayes classifier, using Visel's data set. ROC curves are shown for each of the three mouse tissues. Each curve is an average of 5 cross-fold validations on a reserved test set, and error bars denote one standard deviation over the 5 cross-fold validation sets. The numbers in the parenthesis indicate the average of the area under ROC curves (auROC). Three different lengths of k-mers, k=3, 5, 7, were tested. Generally, larger k exhibits better performance in terms of auROCs with some exceptions caused by over-fitting. (A) Using the full set of k-mers, SVM Classification results with three different kernels (Spectrum, Mismatch, and Gaussian) and Naïve Bayes classification results are shown. SVMs outperform Naïve Bayes classifiers in every case but one which failed to converge (SVM with 3-spectrum kernel on Midbrain). (B) Using only selected 6-mers, results of SVMs with spectrum kernels are presented. For each classification, a half of N 6-mers with the largest positive SVM weights and a half of N 6-mers with the largest negative SVM weights were selected (N=40, 100 and 200).

FIGS. 11 A and B show graphs of length distribution and repeat fraction distribution between enhancers and random genomic sequences matched to EP300 enhancer set. For the null-sequence model, random sequences from the genome were selected to match the repeat fraction and length distribution of the sequences in the EP300 data set. The combined set of all Visel's EP300 bound regions are shown in red (the righthand bar), and the null sequence set is shown in blue (the lefthand bar).

FIG. 12 A-L are graphs showing the comparison between ROC curves and prevision-recall curves with larger negative sets. The scaling of negative set size is compared for all comparisons of positive sets vs. random genomic sequence for the 6-mer spectrum kernel SVM (Table 4, FIG. 24). The genomic ratio of enhancers to non-enhancer sequence is very large (it is estimated that enhancers comprise 1-2% of the genome), so three negative sets (1×; 50× larger; and 100× larger than the positive enhancer set) were used for each case. The area under the ROC curve (auROC) or the area under the precision-recall curve (auPRC) is shown in parentheses. For large negative set size, auPRC is a more reliable measure of performance than the auROC curve, which is independent of negative set size, as expected.

FIGS. 13 A and B show comparison between frequencies and SVM weights of k-mers. While the SVM features which are assigned large positive weights are generally over-represented in the EP300 bound regions relative to background genomic sequence, there was not a strictly direct correlation between SVM weights and k-mer frequencies. (A) k-mer frequency in forebrain vs. SVM weights. (B) Normalized frequency difference between forebrain and random sequences, Δf=(freq(fb)−freq(rand))/(freq(fb)+freq(rand))/2.

FIG. 14 shows average EP300 ChIPseq read coverage in the SVM predicted regions. In the graph shown, the 1% predicted is the highest/top line (at the 0 distance point), the 1% predicted without training is the middle line (at the 0 distance point), and the 1% random is the lowest/bottom line (at the 0 distance point). EP300 reads were significantly enriched in the SVM predicted regions: The middle point of the top 1% SVM predicted regions in forebrain were aligned at 0 bp, the sequence around each peak was extended +/−10 kb in each direction, and the average coverage of EP300 reads in the surrounding regions is shown. Significant enrichments compared to random genomic sequence (by about two fold) is observed even after those regions which overlap with the original training set are excluded. This is further evidence that the SVM predicted regions which are not in the EP300 positive test set are in fact EP300-bound.

FIGS. 15 A and B show correlation of SVM predictions and EP300 read density for genome wide scan. The correlation of SVM score and EP300 read density for all 1 kbp regions across the genome is shown. (A) are all regions that partially overlap any positive training set region. (B) are all other genomic regions. The cloud of points with EP300>2 (log₁₀2=0.301) and SVM score >1 are the predicted enhancers, and it was expected that about 50% of these were true positive enhancers. Most regions with EP300>3 are be in the positive training set, and are in (A) by construction. The regions in (A) with EP300<3 are genomic 1 kbp chunks which partially overlap a positive training set region.

FIGS. 16 A and B show distribution of SVM scores for varying negative set size. In the graphs A and B, the line starting farthest to the left is the negative set, the line starting to the first line's left is the positive set. The distributions of SVM scores for negative set size (N=4000) and (N=120,000) are shown. While there was a shift in the (arbritary) scale, the distributions were very similar, reflecting the fact that auROC is similar for N=4000, N=120,000, or N=240,000 negative sequences. On the other hand, as the negative set size increases, auPRC drops, because the higher scoring tail of the negative sequence score distribution becomes comparable to the bulk distribution of the positive sequences.

FIG. 17 shows the correlation between SVM scores from two separately trained SVMs. To investigate the robustness of the top SVM scoring regions, separate SVMs were trained using independently sampled random negative sequence sets, and compared the top SVM scoring regions using these different negative sequence sets. While there is some variation between the top scoring regions from different negative sets, only rarely do high scoring regions in one SVM not score highly the other SVMs, indicating that the predictions are robust to different realizations of the negative set. As shown in Table 5, FIG. 25, there is 64.5% overlap between the top 1.0% regions for “Set1” and “Set2” SVMs, but 84.5% and 92.2% of the top 1% sites in Set1 are found in the top 2% and 3% of Set2, respectively. This graph compares the scores of chromosome 1 regions (to reduce the number of plotted points) from these two SVMs, showing very high correlation (C=0.915).

FIG. 18 shows classification of human homologous regions of the EP300 mouse training set. SVMs can discriminate human homologous EP300 bound regions from human random sequence. A positive human test set was generated by sequence alignment of the mouse EP300 training set regions to the human genome, varying the stringency for assigning homologous regions (70% identical, 90% identical, and 95% identical). As shown in the figure, all three of these sets can be classified with high accuracy (auROC=0.87, 0.88, 0.89), and classification power is relatively unaffected by the cut-off for determining homologous regions, again demonstrating the robustness of the SVM predicted enhancers.

FIG. 19 shows SVM predictions at the human Otx2 locus. To further compare the predictions of the SVM trained on the mouse EP300 bound regions and the SVM trained on human homologous sequence, two SVMs (mmSVM and hgSVM) were used to score the human genome Otx2, which is known to play a role in forebrain development. The raw hgSVM and mmSVM scores were quite similar, and most of the predicted enhancers above the 1% threshold overlap. One of these enhancers has been experimentally verified to have enhancer activity (CR).

FIG. 20 is Table 3, showing 6-mer SVM scores across the SOX-2 POU5F1(OCT4)-NANOG. Many large weight k-mers from the SVM trained on the EP300 ES dataset are subsequences that tile across the SOX2-OCT4 consensus oligo. The SOX2-OCT4-NANOG sequence, CATTGTYATGCAAAT, is SEQ ID NO:2.

FIG. 21A-D shows graphs of PWMs vs k-mers as feature sets on forebrain and ZNF263. The figure shows comparisons of SVM performance using k-mers to an SVM using 811 known PWMs as features using ROC (A,C) and P-R curves (B,D). (A) On the forebrain enhancers, the k-mer SVM was more accurate than known PWMs alone, but a combination of k-mers and PWMs performed slightly better. (B) These differences in auROC translated to a dramatic reduction in auPRC for PWMs relative to k-mers only or combined k-mers and PWMs. (C) The k-mer SVM predicts ZNF263 bound regions from ChIP-seq with high accuracy (auROC=0.94), but the 811 PWM SVM is less accurate (auROC=0.83). (D) Again the lower auROC for PWMs corresponds to a significant decrease in auPRC for PWMs on the ZNF263 data (0.14 vs. 0.51), and a much higher false discovery rate.

FIG. 22 is a graph showing classifications using one negative set shared between different data sets. When training the SVMs for the three data sets (EP300 forebrain, CREBBP neuron, and EP300 ES), independent negative sets were used. To ensure that the predictive k-mers with large negative weights reflect their absence in the positive training set, not presence in various negative set realizations, one common negative set shared between the three data sets was generated. Since the length distribution and repeat fractions of the three data sets are different, the length of the positive sets was modified to be able to generate a single appropriate negative set. For Chen's and Kim's dataset, a fixed length was extended from the peaks reported. 800 bps (+−400 bp from the peaks) was chosen to match with the lengths of forebrain data set as closely as possible (mean length of the forebrain data set is 816 bp). The fixed 800 bp length was chosen for the negative set because forebrain data set was relatively unaffected by the length distribution. 20000 random genomic sites for the negative set were sampled. To deal with the unbalanced positives and negative set sizes, the class weights were optimized for the positive sequences, and report the best result of each case. This figure shows the ROC curves of three different dataset classifications against the common negative set. This result is comparable to the original analysis. Table 11, FIGS. 31A and B show the top 15 positive 6-mers and top 10 negative 6-mers of each dataset from this analysis, which largely overlaps the results from the independent random negative sets, as shown in Table 1, FIG. 8, Table 8, FIG. 28 and Table 9, FIG. 29.

FIG. 23 is a graph showing auROC and BEP using single chromosomes as test sets in 20-fold cross validation. To show that the cross validation procedure does not impact classification performance, SVMs were trained using 20-fold cross validation with test sets consisting of all elements on a single chromosome (1-19, and X=20), instead of 5-fold cross validation used in the main text. The variation in auROC and Precision at the break-even point (BEP, where precision equals recall) is consistent with the varying size of the test sets. No chromosome is significantly more or less accurately predicted than the others.

FIG. 24 is Table 4, showing an outline of several analyses disclosed herein.

FIG. 25 is Table 5, showing further quantifying of the similarity of the predictions from the mouse and human SVMs, FIG. 25 Table 5 shows the overlap of the top SVM scoring regions of the two SVMs. The mouse SVM (Set1) uses the mouse EP300 training set as positives and mouse random genomic regions as negatives, and the human SVM (Set2) uses human homologous regions of the mouse EP300 training set as positives and human random genomic regions as negatives. One third of top 1% scoring regions of Set1 are also found in the top 1% scoring regions of Set2. This overlap was quite significant considering the fact that the two SVMs were trained (learned) on different genomes.

FIG. 26 is Table 6, showing human enhancer prediction using a mouse vs. a human SVM.

FIGS. 27A and B are Table 7, which (A) shows EP300-bound regions in each tissue of mouse embryo vs CREBBP peaks in activated cultured neurons; and (B), shows EP300 bound regions in each tissue of mouse embryo vs EP 300 peaks in embryonic stem cells. The significance of the overlap between Visel's EP300 bound regions and two other data sets were assessed: EP300 bound regions in ES cells and CREBBP bound regions in activated neurons. The number of EP300/CREBBP ChIP-seq peaks were counted in the new data sets which are located within the regions of Visel's data set (EP300 forebrain, midbrain, and limb), and calculated the p-value of the overlap. For a null hypothesis, it was assumed that the observed peaks could have been detected anywhere in potential regulatory regions, which were estimated as roughly 3.5% of entire genome (Waterston et al. 2002). Then the p-value of the overlap was calculated from the binomial distribution.

FIGS. 28A and B is Table 8 showing predictive 6-mers of CREBBP Neuron, where (A) shows fifteen 6-mers with the largest positive SVM weights and (B) shows five 6-mers with the largest negative SVM weights.

FIGS. 29A and B is Table 9 showing predictive 6-mers of embryonic stem cells, (A) fifteen 6-mers with the largest positive SVM weights, and (B) five 6-mers with the largest negative SVM weights.

FIGS. 30 A and B are Table 10, showing a comparison of Predictive k-mers from the different data sets, (A) shows fifteen 6-mers with the largest positive SVM weights, and (B) shows fifteen 6-mers with the largest negative SVM weights.

FIGS. 31 A and B are Table 11 showing predictive k-mers of three different datasets using common random negative sequences, (A) shows fifteen 6-mers with the largest positive SVM weights, and (B) shows fifteen 6-mers with the largest negative SVM weights.

FIG. 32 shows a workflow canvas for an exemplary method of the present invention. Shown are three different components from the kmer-SVM method disclosed herein, ‘Generate Null Sequence’, ‘Train SVM’ and ‘Plot ROC Curve’ and one optional module, ‘Extract Genomic DNA’.

FIG. 33A-D-shows kmer-SVM analysis of ESRRB-binding sites. (A) ROC and PR curves for a kmer-SVM trained on ESRRB-bound genomic loci in ES cells versus 10-fold larger random genomic sequence. Default parameters were used for this analysis; Kernel type=Spectrum, K=6, C=1, E=1e-5, PSW=auto. (B) ROC and PR curves for the ESRRB PWM scores. (C) The top five positive and negative 6 mers recover the ESRRB motif (D) reported in Chen et al., (2008) Integration of external signaling pathways with the core transcriptional network in embryonic stem cells. Cell, 133, 1106-1117. The sequence shown by the ESRRB motif is DBYSAAGSTSAN (SEQ ID NO:3), wherein D can be G, T, or A, wherein B can be G, C, or T, wherein Y can be T or C, wherein S can be G or C, and wherein N can be any nucleotide.

FIG. 34A-C shows kmer-SVM analysis of GR-binding sites. (A) ROC and PR curves for a kmer-SVM trained on GR bound loci in 3134 cells and AtT20 cells versus 10-fold larger random sequence. Default parameters were used; Kernel type=Spectrum, K=6, C=1, E=1e-5, PSW=auto. (B) The 10 most positive and negative 6 mers from 3134 cells and AtT20 cells recover the previously reported GRBE, AP1, AML1, HNF3, TAL1 and NF1 motifs (C) from John et al. ((2011) Chromatin accessibility pre-determines glucocorticoid receptor binding patterns. Nat. Genet., 43, 264-268), and additional novel accessory factors: CREB, TEAD1 and ZEB1. The GRBE motif is RGACAGWGTCY (SEQ ID NO:4); the HNF3 motif is AWRRYAAAYA (SEQ ID NO:5); and the NF1 motif is YWGRWSSWGCCA (SEQ ID NO:6). R can be G or A, W can be A or T, Y can be T or C, and S can be G or C.

FIG. 35 A-C shows kmer-SVM analysis of sequence determinants of cell-type-specific GR binding. (A) ROC and PR curves for a kmer-SVM trained on GR-bound regions in AtT20 cells (positive set) versus GR-bound regions in 3134 Cells (negative set). Default parameters were used; Kernel type=Spectrum, K=6, C=1, E=1e-5, PSW=auto. (B) The accessory factor binding sites, including ZEB1, TAL1, HNF3, AML1 and AP1, are sufficient to distinguish the distinct sets of GR-bound regions in these two cell lines. The GRBE element is now present in both sets, is not predictive in this context and therefore does not receive a large weight. (C) ZEB1 motif from JASPAR database (Sandelin, A., et al. (2004) JASPAR: an open-access database for eukaryotic transcription factor binding profiles. Nucleic Acids Res., 32, 91D-94D.) is shown.

FIG. 36 A-C shows kmer-SVM analysis of EWS-FLI-binding sites. (A) ROC and PR curves for a kmer-SVM trained on EWS-FLI-bound regions in EWS502 cells and HUVEC cells versus random genomic sequence. Default parameters were used; Kernel type=Spectrum, K=6, C=1, E=1e-5, PSW=auto. (B) The 10 most positive, negative 6 mers from EWS502 cells and HUVEC Cells include binding sites the previously reported ETS and AP1 accessory factors, and novel accessory factors TEAD1 and ZEB1. (C) ETS (FLI™) from UniPROBE (16) and TEAD1 motif from JASPAR database are shown. The TEAD1 motif is NRCATTCYWVBB (SEQ ID NO:7). N can be any nucleotide, R can be G or A, W can be A or T, Y can be T or C, V can be A, G, or C, and B can be G, C or T.

FIG. 37 shows kmer-SVM versus PWM scores. The kmer-SVM AUROCs (Y-axis) of the 467 ChIP-seq data sets are compared with the best PWM AUROCs (X-axis). Default parameters were used; Kernel type=Spectrum, K=6, C=1, E=1e-5, PSW=auto. In general, kmer-SVM is much more accurate than any single PWM with one exception; the CTCF PWM (circle within triangle).

FIG. 38 A-D shows EP300 and H3K4me1 ChIP-seq signature at melanocyte enhancers. (A, left) Schematic of chr15:78,984,500-79,034,500 (UCSC Genome Browser; mm9) showing Sox10 and previously characterized melanocyte enhancer Sox10 MSC#5. (Right) Detailed view of the region immediately surrounding Sox10 MSC#5 (chr15:79030709-79033709), showing ChIP-seq data for EP300 (green) and H3K4me1 (blue) in melan-a. Rectangles are ChIP-seq peaks, and colored vertical bars below peaks show density of ChIP-seq reads in 10-bp bins. Gray bars at the bottom of inset show the phastCons score (Euarchontoglires). (B) Same scheme as in A, but showing the interval chr7:94,575,283-94,662,322 containing the Tyr gene and previously characterized melanocyte enhancer Tyr DRE-15 kb. Interval shown to the right is chr7:94655287-94658287. (C) Number of ChIP-seq reads for H3K4me1 (blue, left axis) and EP300 (green, right axis) in a 5-kb window around the summits of 3622 EP300 peaks (averaged in 100-bp bins). (D) Heatmap showing the number of H3K4me1 ChIP-seq reads in a 3-kb window around 3,622 EP300 peaks.

FIG. 39 A-E shows H3K4me1-flanked EP300 peaks have multiple characteristics of melanocyte enhancers. (A) Visual representation of an exemplary method to identify putative melanocyte enhancers. (B) Average phastCons score (vertebrate, mm9) in a 1.5-kb window around the summit of 2489 putative melanocyte enhancers. (C) Top four motifs enriched in sequences of putative enhancers, with corresponding E-values (enrichment P-value times number of motifs tested; calculated by DREME) and factors predicted to bind to these motifs. (D) Number of putative enhancers in 1-MB window (100-kb bins) around the TSS of 2000 genes with the most abundant transcripts in melan-a (dark red), 2000 genes with least abundant transcripts in melan-a (light red), and 2000 randomly selected genes (white; average of five sets with SD represented by error bars). (E) Similar analysis to D, but using a 10-kb window and 1-kb bins.

FIG. 40 shows Table 12, which shows Gene Ontology (GO) terms associated with genes proximal to putative melanocyte enhancers.

FIG. 41 shows EP300 peaks that overlap H3K4me1-flanked regions have distinct properties. (A) Percent of EP300 peaks that directly overlap an annotated TSS (UCSC Genes; [dark green] peaks that overlap H3K4me1-flanked regions; [light green] peaks that do not overlap H3K4me1-flanked regions). Data for Heart (C57bl/6 mouse tissue taken at 8 wk), mES (Mouse ES-Bruce 4), and GM12878 generated by ENCODE and modENCODE consortia. (B) Average number ChIP-seq reads per peak for Pol2 (top row), H3K4me3 (middle row), and CTCF (bottom row) in a 2-kb window around the summits of indicated EP300 peaks (H3K4me1-flanked indicated by fl and dark green; non-H3K4me1-flanked, n-fl and light green). Three columns show data from the heart, mES, and GM12878, respectively. (C) EP300 ChIP-seq fold enrichment (determined by MACS) of EP300 peaks that overlap H3K4me1-flanked regions (fl; darker green), and EP300 peaks that do not overlap H3K4me1-flanked regions (n-fl; lighter green). Corresponding P-values calculated by two-tailed t-test. Numbers of peaks are as follows: melan-a fl, 2489; n-fl, 1133; heart fl, 3324; heart n-fl, 23,236; mES fl, 1258; mES n-fl, 20,062; GM12878 fl, 3404; and GM12878 n-fl, 6703.

FIGS. 42 A and B show Putative melanocyte enhancers direct reporter expression in melan-a. (A) Fold increase in luciferase reporter expression directed by indicated sequence relative to promoter-only control (P; white bar). Gray bars show fold increase of randomly selected putative enhancers (numbered 1-50). N (orange bar) represents the average of 10 negative regions. (Error bars) SD of three biological replicates, except in the case of N, where error bars show the standard deviation of 10 different negative regions. Note the difference in scale between bottom panel (onefold to 10-fold by one) and top panel (10-fold to 115-fold by 10). (Dotted lines) 10-fold, fivefold, and threefold thresholds (top to bottom). (B) Box plot summarizing results of reporter assays for 10 negative regions (top, orange) and 50 putative enhancers (bottom, gray). P=9.564 3 107 by two-tailed t-test. Four outliers in putative enhancer group not shown in box plot (nos. 14, 22, 27, 46).

### DETAILED DESCRIPTION

The present invention provides methods, systems and computer programs for identifying regulatory sequences, for example enhancer sequences, repressor sequences and/or insulator sequences in nucleic acid sequences, using learning machines. For example, the present invention is directed to methods and systems for identifying enhancer sequences from DNA using a trained SVM (support vector machine) that provides information regarding known enhancer sequences. Though the description herein is directed to enhancer sequences, one of skill in the art is capable of using the methods described herein for identifying other sequences found in nucleic acid genomes.

The present invention comprises a discriminative computational framework to detect regulatory sequences from DNA sequence alone that does not rely on conservation or known TF binding specificities. Methods comprise using a support vector machine (SVM) to differentiate enhancers from nonfunctional regions, using DNA sequence elements as features. SVMs (Boser et al. 1992; Vapnik 1995) have been successfully applied in many biological contexts (for review, see Schölkopf et al. 2004; Ben-Hur et al. 2008): cancer tissue classification (Furey et al. 2000); protein domain classification (Karchin et al. 2002; Leslie et al. 2002, 2004); splice site prediction (Rätsch et al. 2005; Sonnenburg et al. 2007); and nucleosome positioning (Peckham et al. 2007). For example, for identifying enhancer sequences, because of the potentially diverse mechanisms which direct EP300 and CREBBP binding, a complete set of DNA sequence features was used to capture combinations of binding sites active in different tissues and times of development. To study these distinct modes of regulation, EP300/CREBBP binding in mouse embryos (Visel et al. 2009), activated cultured neurons (Kim et al. 2010), and embryonic stem (ES) cells (Chen et al. 2008) was investigated. Visel's data set was first used, where several thousands of EP300-bound DNA elements were collected by ChIP-seq in dissected mouse embryo forebrain, midbrain, and limb. A method was tested by predicting enhancers vs. random sequence and between EP300/CREBBP ChIP-seq data sets. These comparisons revealed a diversity of predictive sequence features, both within and across data sets. Table 3, FIG. 24 provides an outline of the analyses performed.

In general, the present invention comprises computer-implemented systems and methods for identifying regulatory nucleic acid sequence features, wherein the methods and systems comprise three main components: (i) generating positive and negative sequence sets, (ii) training the SVM classifier and (iii) analyzing its performance and predictive sequence features. In an aspect, a positive training sequence set may be provided by the user, and such data may be, for example, in the form of a BED file of coordinates or sequence data in FASTA format, including genomic coordinates. The negative sequence set is generated by methods disclosed herein as a ‘Generate Null Sequence’ module. SVM training was fairly transparent, and takes the positive and negative sequence sets as input and produces a set of k-mer weights and predicted class labels as output using cross-validation. The performance of the SVM classifier is summarized by Receiver Operating Characteristic (ROC) and Precision-Recall (PR) curves, and features are ranked by their significance. FIG. 32 shows a general workflow and this workflow can also be used as a template for an exemplary analysis method and system of the present invention.

### Generation of Sequence Sets

In a method of the present invention the kmer-SVM classifier can use as training data a set of positive sequences provided by a user. Such positive data set may be for example, a FASTA file of positive sequences obtained through ChIP-seq, DNase-seq or another experimental assay. A negative sequence set may be provided by a user or may be generated as described herein. In an aspect, it is desirable that a SVM identifies sequence features specific to the positive regions, the GC content, length and repeat fraction is matched when constructing the negative set, otherwise sequence features could be predictive simply by their enrichment or absence in the biased negative set. A set of the three distributions of GC, length and repeats in the positive set are referred to herein as its ‘sequence profile’ and the Generate Null Sequence method in general matches this sequence profile for the negative set by using the following random sampling procedure. First, a positive sequence is randomly selected, and the same chromosome is sampled (examined) for a match in terms of length, GC content and repeat fraction, which does not overlap any positive sequence or existing negative sequences by even one base pair. This random selection process is then repeated until the negative set has reached a predetermined size. In an example, the random selection process used a pre-computed table of genomic indices, for example, those provided for the Caenorhabditis elegans, Drosophila melanogaster, mouse and/or human genome. A full negative sequence set then by construction closely approximates the sequence profile of the positive set. In some methods, a user can exclude regions other than the input positive sequences from consideration for negative sequence generation. A method of the present invention may comprise the use of a negative set which is larger than the positive set, as doing so may improve the statistical robustness of the classifier. A method of the present invention may comprise the use of a negative set which is smaller than the positive set. A user may specify (predetermine) the size of the negative set as an integral multiple of the number of positive sequences (e.g. 10×). As some positive sequences may not have exact matches in terms of GC content or repeat fraction, a user can specify the percentage of GC content or repeat fractions by which a generated null sequence may differ from its corresponding positive sequence. This additional flexibility speeds the generation of the negative set and affects how precisely the negative set sequence profile matches the positive set sequence profile. Also, distinct realizations of null sequence sets may be generated by varying the Random Number Seed parameter. In an example, the output of the Generate Null Sequence tool was a BED file that described the coordinates of the negative genomic intervals.

After the coordinates are specified, the actual sequences needed for SVM training are generated from the positive and negative coordinates, for example, which may be obtained in a BED file by a built-in Galaxy tool: ‘Fetch Sequences’, whose output may be FASTA format DNA sequence files.

### SVM Training

An SVM is a classifier, which attempts to find a hyper-plane boundary in feature space that separates elements of the positive and negative sequence sets. SVMs use techniques known as ‘kernels’, which allows for defining similarities between any two data points without explicit mapping of the data into a higher-dimensional feature vector space. A set of kernels called ‘string kernels’ have been developed for analyses of sequence data sets and have achieved great success in computational biology. A Train SVM step may a string kernel, for example, the spectrum kernel (Leslie, C. et al., (2002) The spectrum kernel: a string kernel for SVM protein classification. Pac. Symp. Biocomput., 7, 566-575.). In an aspect, the features may be the complete set of k-mers, and their frequencies may be calculated from the input data (positive and negative sequence sets), such as that provided by FASTA files. The training method step, Train SVM, may comprise generating the normalized k-mer count vector for each sequence and then finding the SVM internal parameters (support vectors) that most accurately distinguished the positive and negative sets. Train SVM may comprise one or more kernels, for example, the spectrum kernel (using a single length k-mer) and/or the weighted spectrum kernel (using a user specified range of k's, with equal weighting). In both cases, reverse complement k-mers may be treated as separate instances of the same feature. An example comprises using the SVM Shogun toolbox (Sonnenburg, S., et al., (2010) The SHOGUN machine learning toolbox. J. Mach. Learn. Res., 11, 1799-1802.). A method step of training the SVM performs two tasks: it generates a set of ranked k-mer-SVM weights, and it generates a set of class predictions using CV. A given k-mer's score can be thought of as a measure of the degree to which that k-mer contributes to the discriminatory power of the classifier. The weights may be output to a table, for example, labeled Weights.

### CV

As is standard in machine learning, CV may be used to assess classifier performance. The initial positive and negative sets may be randomly partitioned into n distinct sets (for n-fold CV), and the ROC and PR performance of each test set may be generated using a classifier trained on the other n−1 sets. The number of CV sets is a parameter, which can be specified by the user. This may be repeated for all n partitions such that in the end each partition may be used for both training and test-set scoring. The result of this process may be the set of scores for test-set sequences in each round of CV, which may be output to a table, for example, labeled Predictions.

An aspect of a method of the present invention comprises three parameters for SVM learning that may be adjustable (k, C and E). If the spectrum kernel is used, k specifies a single kmer length, whereas if the weighted spectrum kernel is used, minimum and maximum values for k must be set. Using a single k is somewhat easier to interpret in the beginning, as the vocabulary is simpler. Using a range of k values does have the advantage that similar k-mers of slightly varying length and composition should all receive significant weights, increasing confidence in interpretation. Also, using a range (e.g. 5-8) usually performs incrementally better than a single k in terms of overall classification accuracy.

The SVM maximizes the margin between the positive and negative sequences while simultaneously minimizing errors (sequences on the wrong side of the boundary). The relative importance of misclassification error is weighted by the regularization parameter, C. In practice, this affects over-fitting. A small C will result in less over-fitting of the SVM at the expense of slightly greater training classification error, whereas a large C will result in more over-fitting of the SVM. With unbalanced positive and negative set sizes, a user may want to use a separate regularization parameter for positive and negative sequences, reflecting the relative importance of errors. For example, as disclosed herein, methods may comprise using an additional parameter Positive Set Weight or PSW. In an example, the regularization parameter for the positive set was C*PSW, whereas for the negative set, it was C. The default setting was PSW=1+log(N/P), which weighed positives more heavily when the negative set was large. The rationale behind this formula appears to be that optimal PSWs usually follow the logarithm of the ratio between positives and negatives. In practice, results were insensitive to C and PSW, unless there was a significant imbalance between the positive and negative set sizes. The precision parameter E constrains the precision of the SVM classifier. Increasing E results in a reduced number of support vectors and can lead to a more robust classifier by reducing the requirements on the accuracy of the classifier on the training set. In practice, the results should be insensitive to the choice of E, and a default value is adequate. Runtime may increase as a function of the total number of sequences in the positive and negative data sets, and may range from under 1 to 40 min, for example, see the data sets shown in Examples.

Interpretation of kmer SVM Weights

The output of SVM training may be a list of k-mer weights, and it is the weighted sum of normalized k-mer counts in a sequence that determines the predicted class. In biological terms, the presence of k-mers with large positive weights significantly increases a sequence's likelihood of being positive (e.g. being an enhancer or being bound by a TF in a specific cell type). Large negative weights are equally informative, as their absence significantly increases the probability of being positive (e.g. a binding site for a transcriptional repressor). For example, in a method the weights file output by the Train SVM step may list all k-mers and their corresponding scores. The SVM weight is a continuous valued quantity, and large absolute value is a direct measure of significance. It is the scores with large absolute values that will be of particular value to the biologist. The TFs binding the highest and lowest scoring k-mers, if previously studied, can be found using database matching programs such as TOMTOM, using the UniPROBE, TRANSFAC and JASPAR databases. Finding the best PWM match to a k-mer does not necessarily imply that that factor binds the k-mer in the given context because many TFs have overlapping specificities, and the PWM databases are far from complete. However, large positive scoring k-mers are often recognizable as TF-binding sites known to be important in the cell type of interest, whereas large negative scoring k-mers have identified an important role for repressors in previously unknown contexts (3).

### Classification Performance Analysis

The area under the ROC curve (AUROC) and the PR curve (AUPRC) are measures of the accuracy of the classifier. AUROC corresponds to the probability that a randomly selected positive sequence will score higher than a randomly selected negative sequence. For example, for each possible SVM score threshold, the true positive rate [TPR=TP/(TP+FN), or sensitivity] and false positive rate [FPR=FP/(FP+TN), or 1-specificity] at this threshold may be calculated, where TP is the number of true positives, TN is the number of true negatives, FP is the number of false positives and the FN is the number of false negatives. The ROC curve plots TPR versus FPR. The PR curve plots Precision versus Recall, where, Precision=TP/(TP+FP) and Recall=TPR. A method of the present invention may comprise assessing the accuracy of the classifier, wherein assessing may comprise calculating ROC and/or PR curves, and/or AUROC and/or USPRC using the classifier output information.

The ROC and PR curves are slightly different measures of the classification performance of the trained SVM: the ROC emphasizes true and false positive rates, whereas the PR curve emphasizes true positive predictions. This difference results in the ROC possibly overestimating the accuracy of a classifier for data sets with large imbalances in the positive and negative class sizes, as is typical of genomic predictions with large negative sets. The PR curve is more appropriate in the case of large negative sets, yielding more accurate evaluations of classifier performance because it directly assesses the accuracy of positive predictions.

Sequence features in an experimentally identified enhancer set were sufficient to train the SVM to accurately discriminate enhancers from random genomic regions. Data presented herein shows that the most predictive sequence elements were related to biologically relevant transcription factor binding sites. Examples herein show that some sequence elements were significantly absent in the enhancers (those with large negative SVM weights). For example, binding sites for the zinc finger E-box binding homeobox (ZEB) transcription factor family was depleted in the forebrain enhancers, consistent with its biological role as a transcriptional repressor (Vandewalle et al. 2008). In addition, it was found that enriched sequence elements were positionally constrained within the enhancers, and that they were more evolutionarily conserved than less predictive elements in the enhancers, reflecting the combinatorial structure of tissue-specific enhancers.

The SVM methods and systems of the present invention can predict putative enhancers in both the mouse genome and the human genome from DNA sequence alone. Many of these novel enhancers overlap with regions enriched in EP300 ChIP-seq reads, exhibit greatly increased hypersensitivity to DNase I in the mouse brain, and were proximal to biologically relevant genes. All of these assessments exclude the original EP300 training set enhancers from the analysis. The successful identification of tissue-specific DNase I hypersensitive sites provides powerful independent evidence for the validity of the method disclosed herein for identifying enhancer sequences.

Most investigations make use of two complementary approaches to detect putative regulatory regions: comparative genomics, which identifies enhancers by their sequence conservation across related species; and functional genomics, which identifies enhancers by the common binding of transcriptionally associated factors or marks (for review, see Noonan and McCallion 2010). Comparative genomics is based on the generally accepted hypothesis that functionally important regulatory sequences are under purifying selection. As a result, conserved noncoding sequences (CNSs) are natural candidates for putative enhancers. Early studies used CNSs to detect putative enhancers and test their activity in zebrafish or mouse reporter assays (Woolfe et al. 2004; Pennacchio et al. 2006; Visel et al. 2008). Although these conservation-based approaches achieve some success, limitations also exist. The function and spatio-temporal specificity of CNSs cannot be determined by conservation alone and, therefore, requires additional experimentation. More importantly, several studies have shown that noncoding sequences that apparently lack conservation (as assessed by sequence alignment) may still contain functional regulatory elements (Fisher et al. 2006; ENCODE Project Consortium 2007; McGaughey et al. 2008).

Functional genomics is an experimentally driven approach that utilizes recently developed techniques of microarray hybridization or massively parallel sequencing in combination with chromatin immunoprecipitation (ChIP) on specific transcription factors (Johnson et al. 2007; Robertson et al. 2007), chromatin signatures (Heintzman et al. 2007, 2009), or coactivators (Visel et al. 2009; Kim et al. 2010). Specifically, some chromatin signatures or coactivator association (such as monomethylation of lysine 4 of histone H3, acetylation of lysine 27 of histone H3, and binding by coactivators EP300/CREBBP) are predictive markers of enhancer activity (Heintzman et al. 2007, 2009). The transcriptional coactivators EP300 (also known as P300) and CREBBP (also known as CBP) have proven to be useful for enhancer identification because of their general roles as cofactors in mammalian transcription. Through highly conserved protein-protein interactions, EP300/CREBBP are hypothesized to operate as coactivators in at least three ways: as a direct bridge between sequence-specific transcription factors (TFs) and RNA Polymerase II, as an indirect bridge between sequence specific TFs and other coactivators which recruit RNA Pol II, or by modifying chromatin structure via intrinsic acetyl-transferase activity (Chan and La Thangue 2001). Several studies have reported genome-wide mapping of EP300/CREBBP-bound enhancers in different contexts, for example, tissue-specific activity in dissected mouse tissue (Visel et al. 2009) and environment-dependent activity in neurons (Kim et al. 2010). Visel et al. validated that 90% of the EP300 enhancers tested recapitulated the expected spatial and temporal activity in vivo in a transgenic mouse enhancer assay. Functionally identified EP300bound regions, thus, provide a robust starting point for further investigation of enhancers and their sequence properties.

In principle, a complete understanding of enhancer mechanism would include a description of specific internal sequence features and how they contribute to enhancer function. Previous studies that have attempted to predict enhancers from sequence have typically used sequence conservation, colocalization of previously characterized TFBSs [from databases such as TRANSFAC (Matys et al. 2003) or JASPAR (Bryne et al. 2008)], or a combination of the two. Many of these existing approaches were assessed by Su et al. (2010), who found that some were successful in identifying enhancers in Drosophila but that few generalized to mammalian systems. The most successful method in mammalian enhancer prediction used a combination of conservation and low-order Markov models of sequence features (Elnitski et al. 2003; King et al. 2005). In more recent work, Leung and Eisen (2009) used word frequency profile similarity between pairs of sequences to detect novel enhancers, but training on small numbers of enhancers can be susceptible to noise. Another notable recent computational approach uses combinations of known TFBSs and de novo position weight matrices (PWMs) to detect enhancers (Narlikar et al. 2010).

### SVM Description

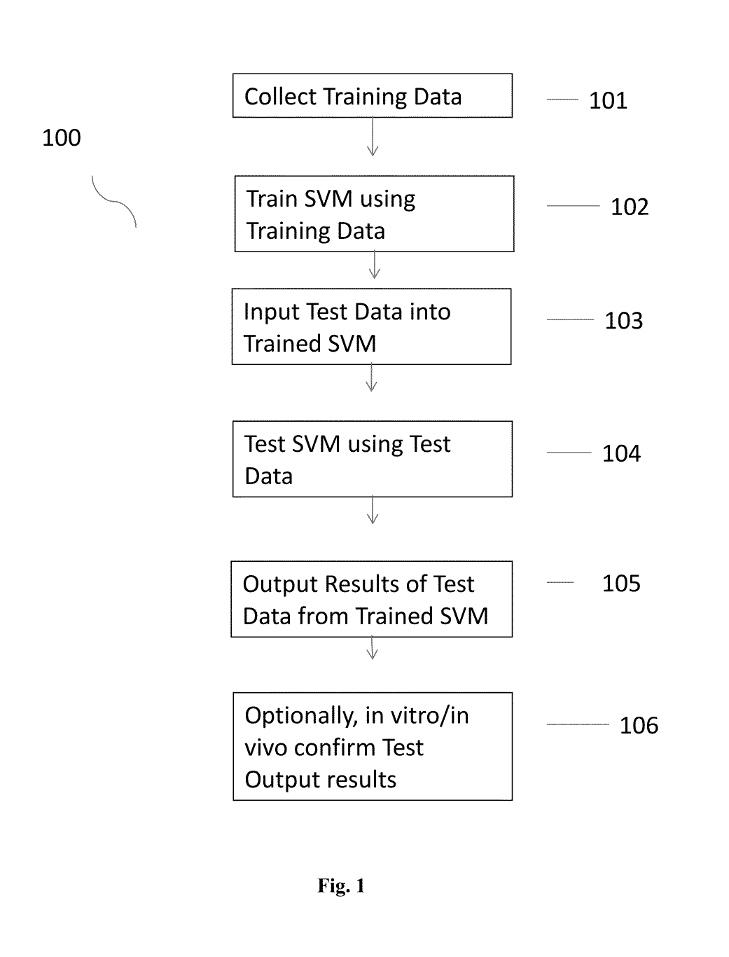

Exemplary embodiments of the present invention will hereinafter be described with reference to the drawing, in which like numerals indicate like elements throughout the several figures. FIG. 1 is a flowchart illustrating a general method 100 for identifying enhancer sequences using an SVM. The method 100 begins at collection of training data, step 101. Training data comprises a set of data points having known characteristics. Training data may be collected from one or more local and/or remote sources. The collection of training data may be accomplished manually or by way of an automated process, such as known electronic data transfer methods. Accordingly, an exemplary embodiment of the present invention may be implemented in a networked computer environment. As described herein, training data may comprise positive and negative sequence sets. Next, at step 102, the learning machine is trained using the training data. As is known in the art, a learning machine is trained by adjusting its operating parameters until a desirable training output is achieved. The determination of whether a training output is desirable may be accomplished either manually or automatically by comparing the training output to the known characteristics of the training data. A learning machine is considered to be trained when its training output is within a predetermined error threshold from the known characteristics of the training data.

At step 103, test data is input into the trained SVM. Test data may be optionally collected in preparation for testing the trained learning machine. Test data may be collected from one or more local and/or remote sources. In practice, test data and training data may be collected from the same source(s) at the same time. Thus, test data and training data sets can be divided out of a common data set and stored in a local storage medium for use as different input data sets for a learning machine. Then, at step 104, the learning machine is tested using the test data. At step 105, the output results of test data from the learning machine is examined to determine if the results are desirable, reliable, accurate, or whatever criteria is established for the results. Optionally, at step 106, the output results may be verified or confirmed by in vivo or in vitro tests to determine if the enhancer sequences identified function as enhancer sequences in one or more tissues at the same or different times during differentiation, growth, cell death, or other cellular life timepoints.

An SVM implements a specialized algorithm for providing generalization when estimating a multi-dimensional function from a limited collection of data. An SVM may be particularly useful in solving dependency estimation problems. More specifically, an SVM may be used accurately in estimating indicator functions (e.g. pattern recognition problems) and real-valued functions (e.g. function approximation problems, regression estimation problems, density estimation problems, and solving inverse problems). The concepts underlying the SVM are explained in detail in a book by Vladimir N. Vapnikv, entitled Statistical Learning Theory (John Wiley & Sons, Inc. 1998), which is herein incorporated by reference in its entirety. Accordingly, a familiarity with SVMs and the terminology used therewith are presumed throughout this specification.

Support vector machines were introduced in 1992 and the “kernel trick” was described. See Boser, B, et al., in Fifth Annal Workship on Computational Learning Theory, p 144-152, Pittsburgh, ACM which is herein incorporated in its entirety. A training algorithm that maximizes the margin between the training patterns and the decision boundary is provided herein. The techniques may be applicable to a wide variety of classification functions, including Perceptrons, polynomials, and Radial Basis Functions. The effective number of parameters may be adjusted automatically to match the complexity of the problem. The solution may be expressed as a linear combination of supporting patterns. These are the subset of training patterns that are closest to the decision boundary. Bounds on the generalization performance based on the leave-one-out method and the VC-dimension are given herein. A memory-based decision system with optimum margin may be designed wherein weights and prototypes of training patterns of a memory-based decision function are determined such that the corresponding decision function satisfies the criterion of margin optimality. Methods of the present invention comprise use of one or more SVM to identify regulatory sequences, such as enhancer sequences from native DNA or DNA genomes. Data input or output from the one or more SVMs may be pre- or post-processed by methods known to those skilled in the art.

Enhancers can be Accurately Predicted from DNA Sequence

Methods and systems of the present invention comprise identifying which sequence features are specific to enhancers and investigating the degree to which functional enhancer regions in a mammalian genome using only DNA sequence features in these regions can be identified. Recent genome-wide experiments that identified EP300 binding sites by ChIP-seq (Visel et al. 2009) in three different tissues (forebrain, midbrain, and limb) at embryonic day 11.5 in mice were used. Cross-linking in dissected tissue at a particular time point during development can identify tissue-specific enhancers, even when the developmental regulators that mediate EP300 binding are unknown. While EP300 ChIP may not detect all the enhancers active under these conditions, this data set was used to identify sequence features responsible for EP300 binding in these tissues.

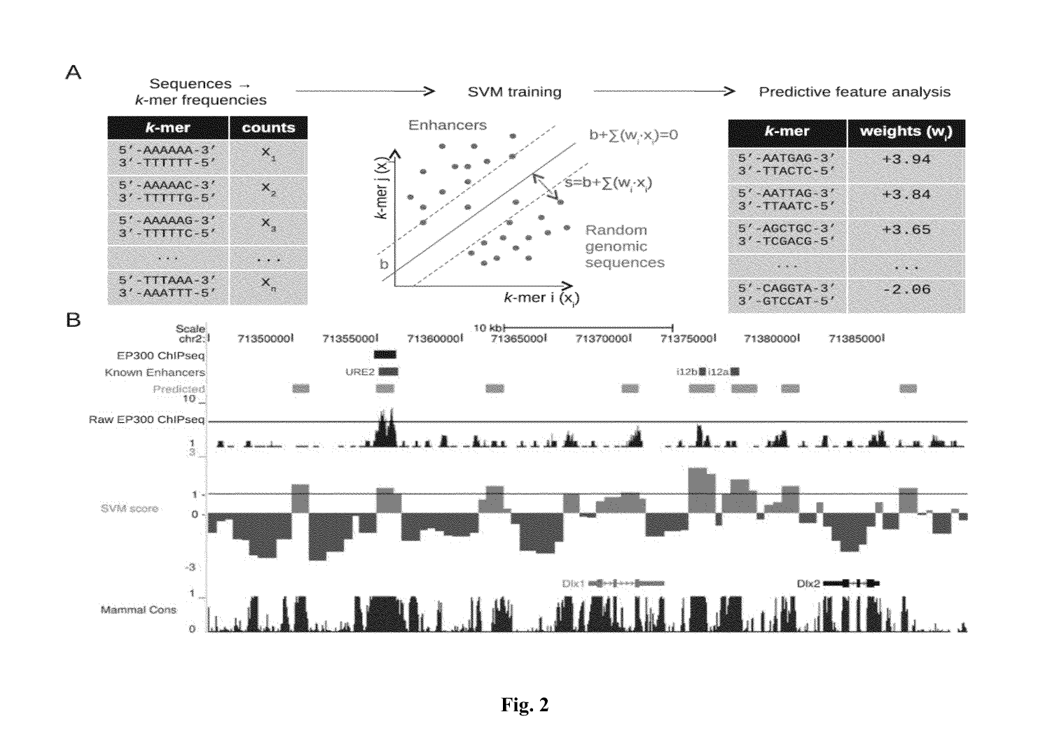

To model DNA sequence features, a support vector machine framework was used. In brief, an SVM finds a decision boundary that maximally distinguishes two sets of data, here a positive (enhancer) and negative (random genomic) sequence set. The basic approach is outlined in FIG. 2A, and full details are disclosed herein. Weights, wi, determined the contribution of each feature to this boundary. Once the set of sequence features, xi, was specified, the weights were optimized to maximize the separation between the two classes. Sequence features used were the full set of k-mers of varying length (3-10 bp). While other authors have successfully used databases of experimentally characterized TFBSs as sequence features (Gotea et al. 2010), because the binding specificity of many transcription factors (TFs) has yet to be determined, in the present invention, k-mers (oligomers of length k) were used as sequence features because they are an unbiased, general, and complete set of sequence features. An advantage of this framework is that the SVM can be subsequently used to scan the genome for novel enhancers not in the original training set. The results of scanning a well-studied region near Dlx1/2 is shown in FIG. 2B and detects novel and experimentally confirmed enhancers, as discussed in detail below.

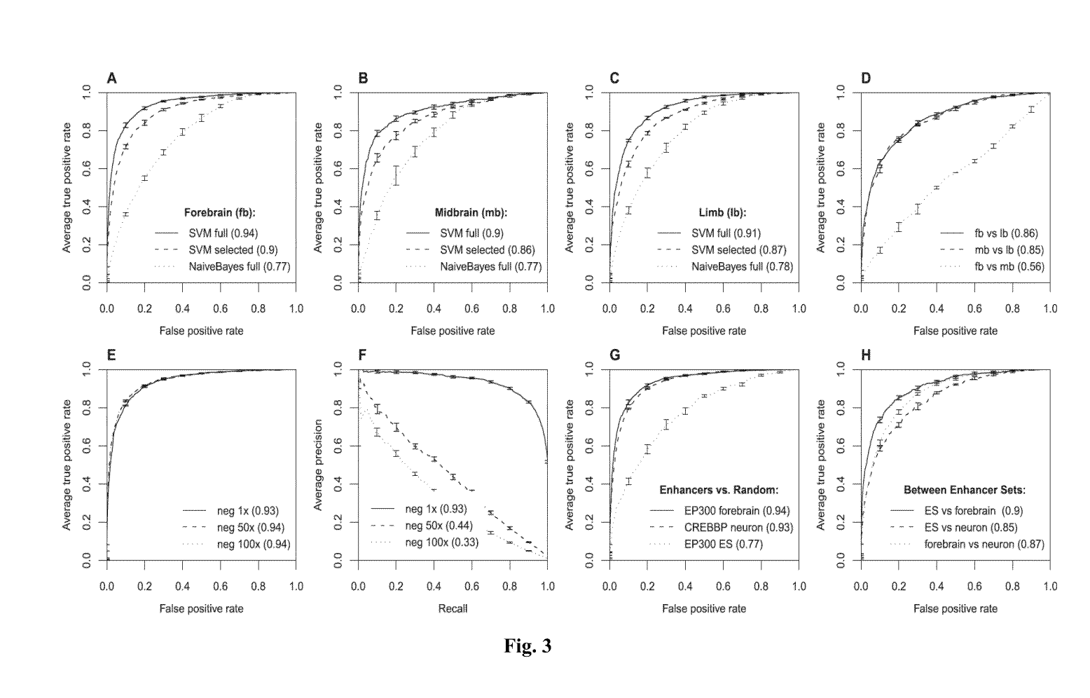

To evaluate classification performance, a fivefold cross validation method was used. Initially, the data set to be classified was randomly partitioned into five subsets. One subset was then reserved as a test data set, and the SVM weights were trained on sequences in the remaining four subsets. The SVM was then used to predict the reserved test data set to assess its accuracy. This process was repeated five times so that every sequence element is classified in one test set. Because there is a trade-off between specificity (the accuracy of positively classified enhancers) and sensitivity (the fraction of positive enhancers detected), the quality of the classifier was measured by calculating the area under the ROC curve (auROC), as shown for several cases in FIG. 3. The five test set auROCs were averaged to give a summary statistic of the SVM performance; these five test sets generate the error bars in FIG. 3.

To test sensitivity to various assumptions in the SVM construction, the cross-validation experiments were repeated on each tissue-specific enhancer set using SVM classifiers with different types of kernels: spectrum kernels (Leslie et al. 2002), mismatch spectrum kernels (Leslie et al. 2004), and Gaussian kernels. The Gaussian kernel and spectrum kernel vary the functional form by which features contribute to the overall decision boundary, while the mismatch spectrum kernel retains the linear contribution of the features but uses a different set of features by allowing a certain number of base pair mismatches to a given k-mer (see Methods). In addition, a commonly used alternative approach was tested, the Naive Bayes classifier, which learns the parameters for each feature independently (the SVM learns parameters for all features at the same time). Despite this assumption of independence, the Naive Bayes classifier has performed very well on a broad range of machine learning applications.

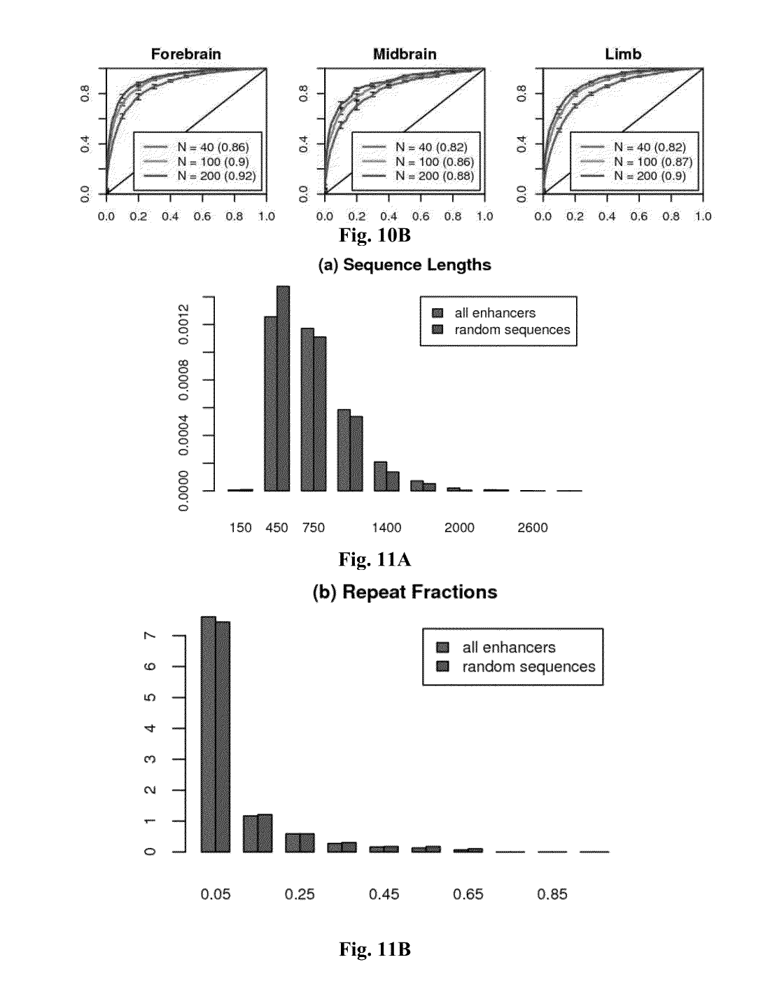

Many SVMs can successfully distinguish enhancers from random genomic sequences with auROC>0.9, regardless of: the types of kernels, the types of tissues, or the length of the k-mers (FIG. 3; FIG. 10A). In general, larger k-mers achieved superior performance (FIG. 10A), but predictive power began to decrease when k was greater than six because of overfitting (the feature vector becomes sparse). On the other hand, Naive Bayes classifiers were significantly less accurate in discriminating enhancers from random genomic sequences (auROC<0.79), indicating that the assumption of conditional independence between k-mers in the Naive Bayes model impaired its performance. FIG. 3A-C shows summaries of comparison between ROC curves of SVM (solid) and Naive Bayes (dotted). Because of its robust performance (auROC=0.94) and ease of interpretation, the 6-mer spectrum kernel was chosen as the standard model for the results shown herein.

Methods of the present invention comprise distinguishing individual enhancer sets from random genomic sequences, and distinguishing between enhancers in different tissues (forebrain, midbrain, limb). Since some enhancers are active in two or more tissues, an aspect comprises removing overlapping regions from both sets before analysis. With the full set of 6 mers, forebrain and midbrain enhancers can be discriminated from limb enhancers with a reasonable auROC of ˜0.84-0.86. However, the SVM failed to successfully discriminate forebrain and midbrain enhancers (FIG. 3D). This indicates that the compositions of TFBSs enriched in forebrain and midbrain enhancers may be similar to each other but are sufficiently different from those in limb-specific enhancers to permit classification. Significant overlap between the forebrain and midbrain enhancer sets in the original data set supported this interpretation (48.7% of midbrain enhancers are also in the forebrain set).

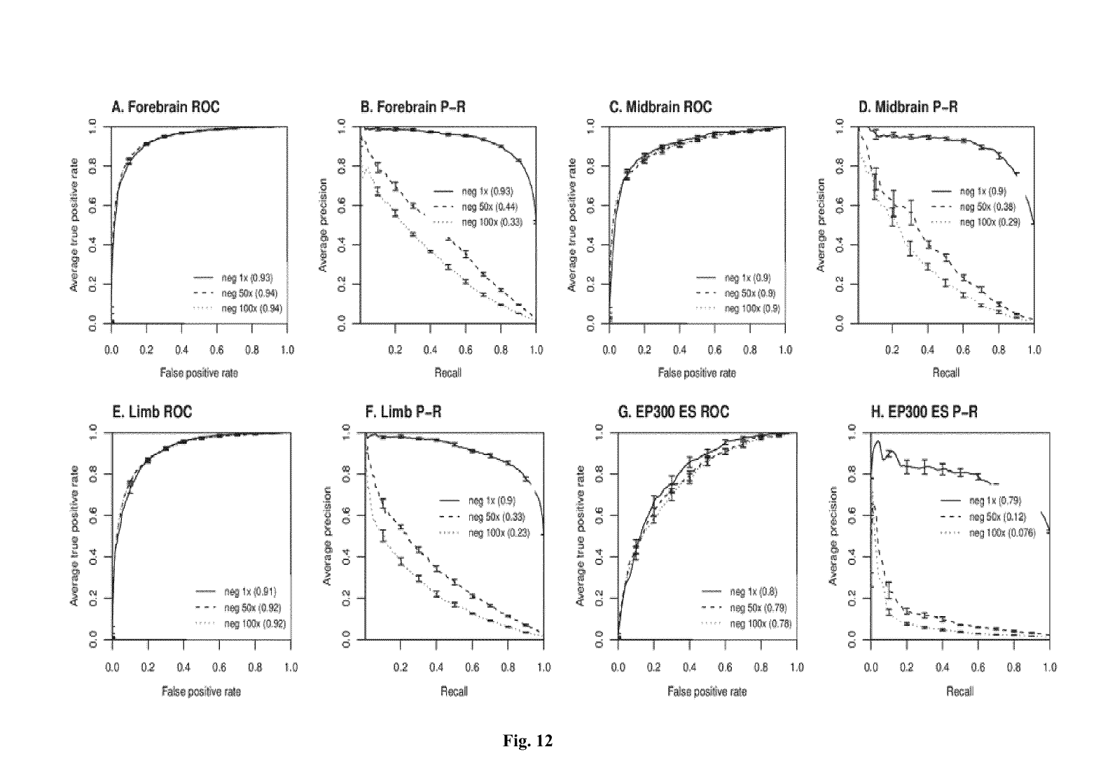

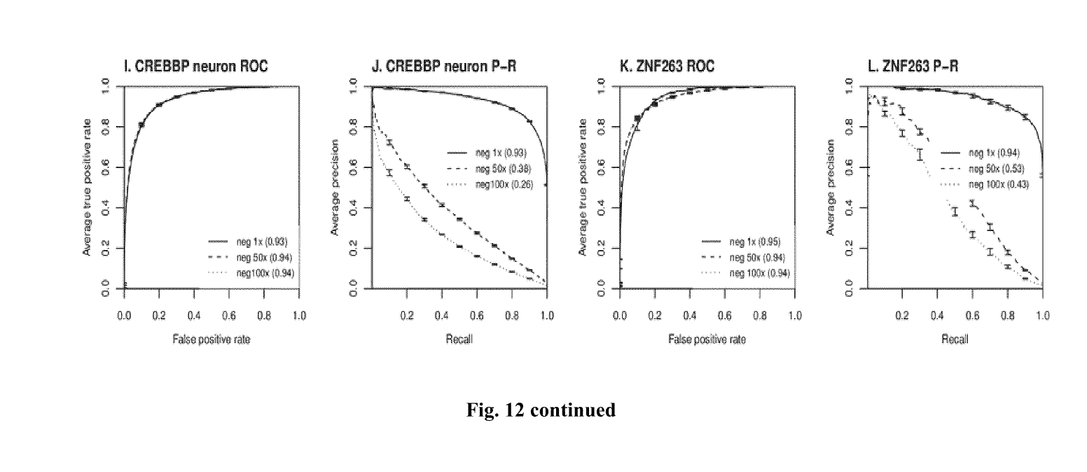

When comparing against random genomic sequence, the size of the negative sequence set may be chosen. The genomic ratio of enhancers to nonenhancer sequence is very large (it is estimated that enhancers comprise 1%-2% of the genome in a given cell-type), and ideally alternative prediction methods would be compared using a very large negative set. However, some computational methods can not handle such large amounts of sequence due to memory constraints. To compare between data sets, the same ratio between positives and negatives was used. To test the scaling with negative set size, three negative sets (roughly balanced, 1×, 50× larger, and 100× larger than the positive enhancer set) were used. Although auROC is a standard metric, when the positive and negative sets were unbalanced, the precision-recall (P-R) curve was a more reliable measure of performance than the ROC curve. Precision was the ratio of true positives to predicted positives, and recall was identical to the true positive rate in the ROC curve. The P-R curves can be quantified by the area under the precision-recall curve (auPRC), or average precision. For the classification of EP300 forebrain (fb), limb (lb), and midbrain (mb) enhancers from genomic sequence, auROC was unaffected by the size of the negative set (FIG. 3E), but auPRC dropped (FIG. 3F) as n became large and the high-scoring tail of the negative sequences became competitive with the true positive sequences. However, the trends of auROC and auPRC were usually consistent. Comparison of auROC and auPRC for the negative set size scaling for all positive data sets is shown in FIG. 12.

### Most Predictive Sequence Elements are Known Transcription Factor Binding Sites

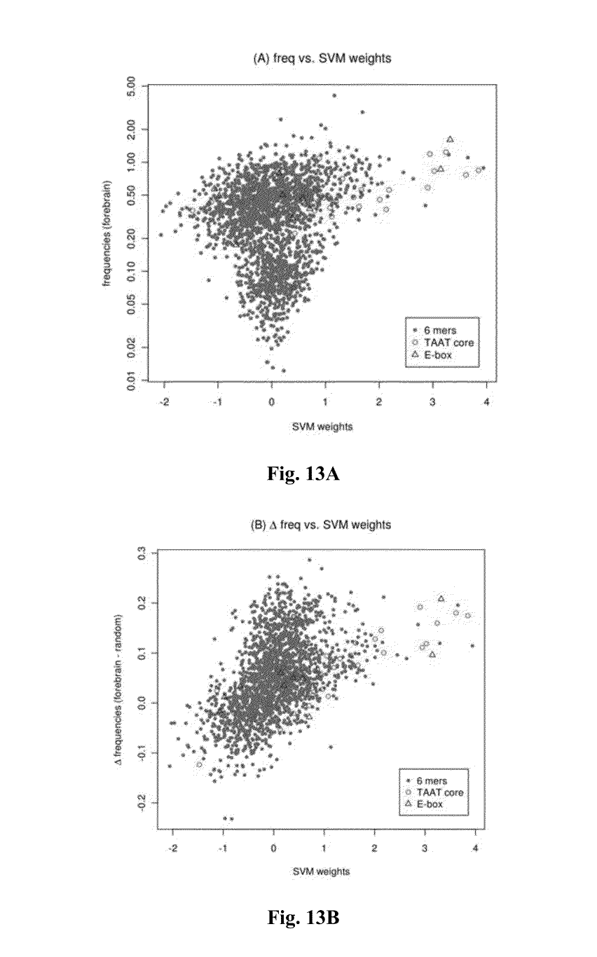

Methods of the present invention comprise identifying which subsets of sequence features allowed the SVM to successfully discriminate enhancers from random sequence. The SVM discriminant function was defined as the sum of weighted frequencies of k-mers in the case of the k-spectrum kernel, and the classification was determined by the sign of the discriminant function (see Methods). Therefore, k-mers with large positive and negative SVM weights indicate predictive sequence features: k mers with large positive weights are sequence features specific to enhancer sequences, and k mers with large negative weights are sequences that are present in random genomic sequence but depleted in enhancers. The SVM classification was conducted again, using only the subset of k-mers with largest positive and negative SVM weights (FIG. 10). The SVM using fifty 6-mers with the largest positive weights and another fifty 6-mers with the largest negative weights achieved auROC of 0.90 for the forebrain enhancer data set. This demonstrated that the largest weight k-mers predict enhancers with similar accuracy, although the auROC did decrease somewhat compared to the result with all k-mers (FIG. 3A-C). Interestingly, the most frequently observed k-mers did not always have the largest SVM weights or vice versa. Only a weak correlation between SVM weights and k-mer frequencies was found (FIG. 13). The most predictive single k-mer (auROC=0.65) was AGCTGC, which was present in 60% of the true positive forebrain enhancers, but it was also present in 34% of the negative genomic regions. By combining many k-mers, the full SVM and the SVM with the 100 top k-mers achieved greater accuracy than single k-mers. The SVM's outperformance of the Naive Bayes classifier, which assumed feature independence, indicated that these features contribute cooperatively.

Many of the most predictive k-mers, (those with the largest positive weights) were recognizable as binding sites for TFs known to be involved in embryonic nervous system development. Each of the predictive k-mers were scored with PWMs for known motifs available in public databases [JASPAR (Bryne et al. 2008), TRANSFAC (Matys et al. 2003), and UniPROBE (Newburger and Bulyk 2009)] using the TOMTOM package (Gupta et al. 2007). Because the databases contain many PWMs from families of TFs with similar specificity, many PWMs often score highly for a given k-mer, so for each k-mer the family of matched TFs with q value <0.1 was reported (Storey and Tibshirani 2003), and representative high scoring TFs within that family were listed. This mapped known TFBS to 85% of the most predictive k-mers, while only 24% of all k-mers match a known TFBS (Binomial test P-value=1.5×10 8). Table 1A shows the fifteen 6-mers with the largest positive SVM weights. The full lists of SVM weights used in the analysis herein are provided herein. The elements that positively contribute to EP300 binding include many k-mers with TAAT or ATTA cores, which are bound by the homeodomain family (Berger et al. 2008). Several homeodomain protein genes have restricted expression in the embryonic mouse forebrain and are required for proper forebrain development, such as Otx and Dlx (Bulfone et al. 1993; Matsuo et al. 1995; Zerucha et al. 2000). Other predictive factors include the members of the basic helix-loop-helix (bHLH) family, which bind variations of E-box elements (CANNTG). Some bHLH factors are known to be crucial regulators of neural and cortical development (Lee 1997; Bertrand et al. 2002; Ross et al. 2003) and are also known to interact with the coactivator EP300/CREBBP (Chan and La Thangue 2001).

The methods and systems of the present invention comprise identifying binding sites that are significantly absent or depleted in EP300 enhancers. The presence of k-mers with large negative weights in a sequence significantly decreases the likelihood that that sequence will be classified as an enhancer. Biologically, the presence of these binding sites would interfere with the operation of the enhancer in a specific tissue. ZEB1-related k-mers have the largest negative weights in forebrain enhancers (Table 1B). For example, the ZEB1 binding k-mer CAGGTA is present in 29% of the negative sequences but only 18% of the forebrain enhancer sequences. Also known as AREB6, ZEB1 (zinc finger E box binding homeobox 1) is a member of the ZEB family of transcription factors, which play crucial roles in epithelial-mesenchymal transitions (EMT) in development and in tumor metastasis by repressing transcription of several epithelial genes including E-cadherin (Vandewalle et al. 2008). Although ZEB family members can work as both activators and repressors, their depletion in EP300-bound regions implies that ZEB1 binding can disrupt EP300 activation.

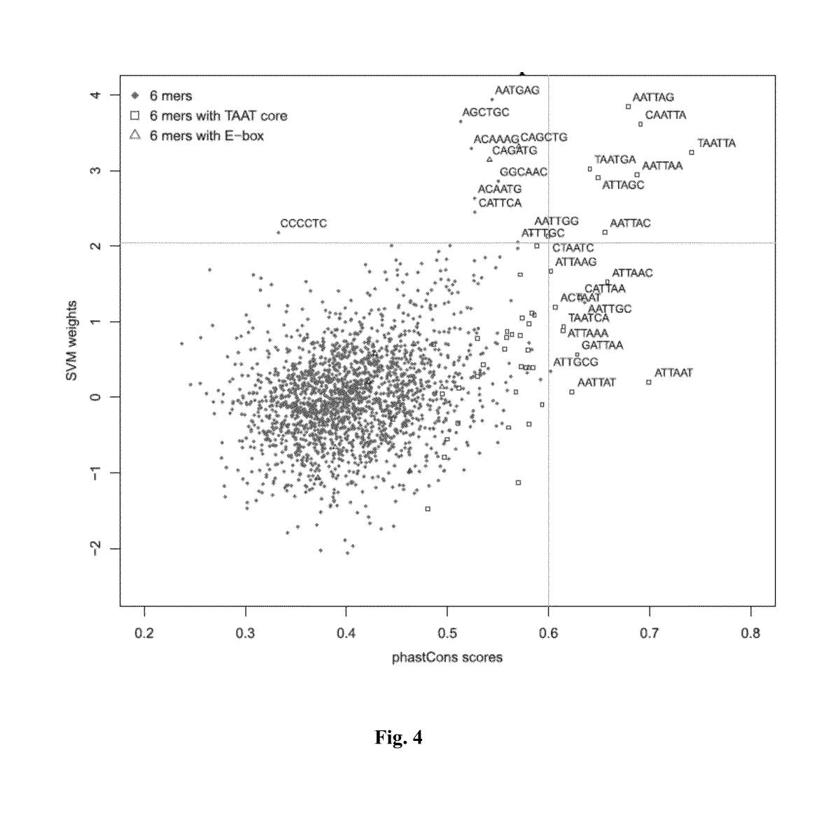

Although some negative weight k-mers are predictive (e.g., ZEB1), on average the positive weights in Table 1A are more predictive than the negative weights (Table 1B) for all data sets. The absolute values of most negative weight k-mers are significantly less than those of the positive weight k-mers, as shown in FIG. 4 (discussed below), where each k-mer weight is plotted along the vertical axis. The asymmetry in SVM weights indicates that the predictive features are primarily identifying k-mers that are enriched in the enhancers rather than k-mers that are enriched in random genomic sequence (or equivalently, depleted in enhancers).

Predictive Sequence Elements are Evolutionarily Conserved and Positionally Constrained within Enhancers

In their previous analysis, Visel et al. showed that most EP300-bound regions are enriched in evolutionarily constrained noncoding regions (Visel et al. 2009). However, not all sequences in the EP300-bound regions (average length 750-800 bp) are conserved; rather, several more localized peaks of conservation (10-100 bp) within the EP300-bound regions are observed in most cases. These peaks of localized conservation probably identify the smaller functional regions within a more extended enhancer. Though not wishing to be bound by any particular theory, it was thought that if the predictive k-mers reflect actual TFBSs, they would tend to be preferentially located within these evolutionarily conserved localized regions. To test this systematically, the degree to which individual k-mers were present in conserved regions was measured by averaging the phastCons conservation score (Siepel et al. 2005) over each instance of the k-mer (see Methods), and examined its correlation with SVM weight. FIG. 4 shows that k-mers with large positive SVM weights are significantly more conserved than average. All but one (CCCCTC) of the 6-mers with large positive SVM weights (three or more standard deviations above the mean) have large conservation scores (at least one and a half standard deviation above the mean conservation score). While the most predictive k-mers were significantly more conserved, moderate correlation between the phastCons conservation scores and the SVM weights for all k-mers was also observed (Pearson correlation coefficient=0.35). This evidence supports the idea that the predictive sequence features are more evolutionarily conserved than the less predictive regions within the enhancers.

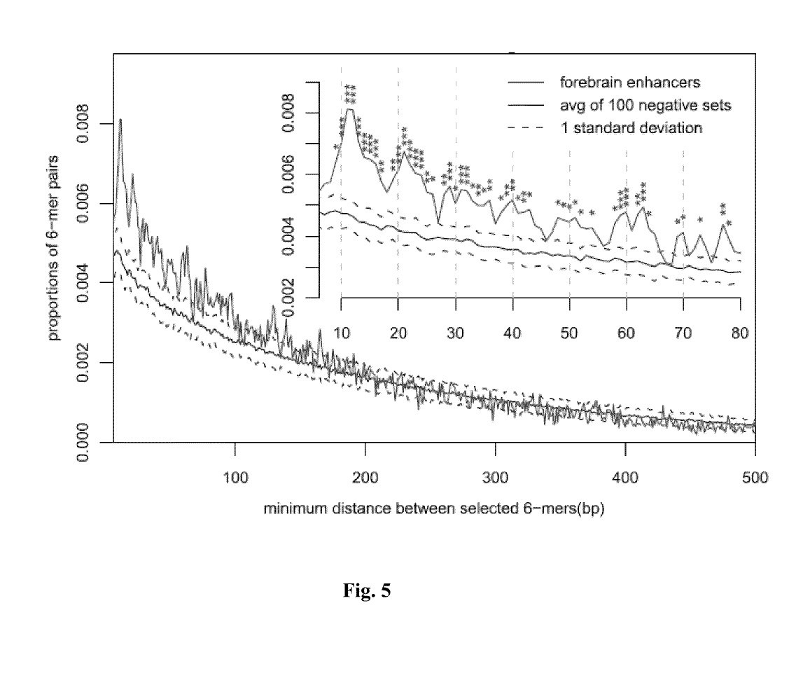

Since conservation was found in narrow peaks within the enhancers, it follows that there might be additional positional constraints between the predictive elements. Mechanistically, these constraints are most likely indicative of a cooperative mechanism, either involving TF-TF interactions or spatially constrained activity of individual factors. Spatial constraints between TFBSs have been observed frequently in yeast (Beer and Tavazoie 2004). In FIG. 5, the distribution of minimum pairwise distances between the ten most predictive sequence elements in the forebrain enhancers (6-mers with the largest positive weights) was compared to their distribution in the null sequences. The forebrain pairwise distance distribution was shifted to lower distances (they are closer to each other) compared to null sequences. To measure the statistical significance of this difference the pairwise distance distribution for these 6-mers in 100 different negative sets was calculated. The standard deviations of these 100 negative sets are shown as dashed lines in FIG. 5, and the forebrain distribution often deviates from the null distribution by several standard deviations, especially for small spacing. The difference between the forebrain and null pairwise distance distributions can be measured by the two-sample Kolmogorov-Smirnov test, (P-value <2.2×10-16), which further demonstrated the significant clustering of predictive sequence elements. Looking at the small spacing end of this distribution (inset in FIG. 5), periodic enrichments with characteristic spacing of 10-11 bp was observed. The highest peak was around 11 bp, almost two times higher than the null distribution. These positional correlations suggest cooperative binding interactions in phase with the 10.5 bp DNA helix periodicity, consistent with previous observations (Erives and Levine 2004; Hallikas et al. 2006), and local physical interactions between the factors that bind these DNA sequence elements.

### Genome-Wide SVM Predictions Identify Novel Enhancers

Methods of the present invention comprise predicting additional functional regions that were not determined to be EP300-bound from the ChIP-seq data by scanning the entire genome systematically with the trained SVM. The mouse genome sequence was segmented into 1-kb regions with 0.5 k-bp overlap, resulting in about 5.2 million overlapping sequence regions. To compare with the 2453 forebrain region “EP300 training set”, the centromeric regions, telomeric regions, and regions containing at least 70% repeats were removed, (however, this filter had minimal impact on the predictions). All of these 1-kb regions were scored using the SVM with the k=6 spectrum kernel for forebrain enhancers. An example of the continuous SVM score along the Dlx1/2 locus is shown in FIG. 2B (“Raw SVM Score”). Dlx1 and 2 are expressed in the mouse forebrain (Bulfone et al. 1993; Ghanem et al. 2003; Wigle and Eisenstat 2008). Besides the sole EP300 training set element in this region (URE2) (labeled “EP300 ChiPseq” in FIG. 1B), two other enhancers within this locus have been experimentally validated (“Known Enhancers”) (labeled il2a and il2b) (Ghanem et al. 2003). These enhancers (il2a and il2b) were detected by the trained SVM but were not in the EP300 training set because their raw sequence read density was not above the stringent threshold used in Visel et al. (2009). Comparing the “Raw EP300ChIPseq” track to the “Raw SVM score” in FIG. 2B shows correlation: Most of the predicted high scoring SVM regions have raw EP300 ChIP-seq signal significantly above background but did not have sufficient read density to be included in the EP300 training set. To support this anecdotal evidence, the genome wide correlation between these SVM predicted regions and EP300 read density was evaluated. In Supplemental FIG. S5, the EP300 ChIP-seq read density was plotted as a function of distance from the center of each of the top 1% SVM scoring regions. Enrichment of EP300 ChIP-seq signal around the SVM predicted regions was found, indicating that many of these predicted loci are, indeed, bound to some extent by EP300 but fall somewhat below the read threshold used to determine the EP300 training set. Supplemental FIG. S6 shows the correlation between SVM score and EP300 reads in all genomic 1-kb regions, showing again that there is a significant population of high scoring SVM regions enriched in EP300 signal but not in the EP300 training set.

To define a high confidence set of enhancer predictions, an appropriate cutoff for the SVM score was chosen using more realistic large negative training set sizes (50× and 100× negative sequences), covering ˜6%-12% of the nonrepetitive genome. The false discovery rate (the expected fraction of predicted positives which are false positives, FP/(FP+TP), from the P-R curves was estimated in FIG. 3F. The precision is weakly dependent on negative set size when n is large, due to the fact that the positive and negative histograms of SVM scores have a similar shape for larger negative set sizes, as shown in Supplemental FIG. S7. To trade off precision and recall, a cutoff that corresponds to 50% recall was chosen, which at 1× is an SVM score of 1.0. For the large negative sets, precision is ˜50% when recall is 50%, and it was estimated that the false discovery rate was ˜50%. In other words, at this cutoff (SVM>1.0) on the training set, 50% of the EP300 training set regions and an equal number of negative regions were captured.

Disclosed herein are comparisons of the properties of the SVM predicted enhancer regions (SVM>1.0), the EP300 training set regions, and nonenhancer genomic regions (SVM<1.0). These three sets are all distinct, i.e., each genomic 1-kb region can only belong in one class. Any 1-kb region which overlaps a training set region by as little as 1 bp is excluded from the SVM sets and included in the EP300 training set. The EP300 training set and SVM predicted regions have similar properties, much different than the nonenhancer regions.

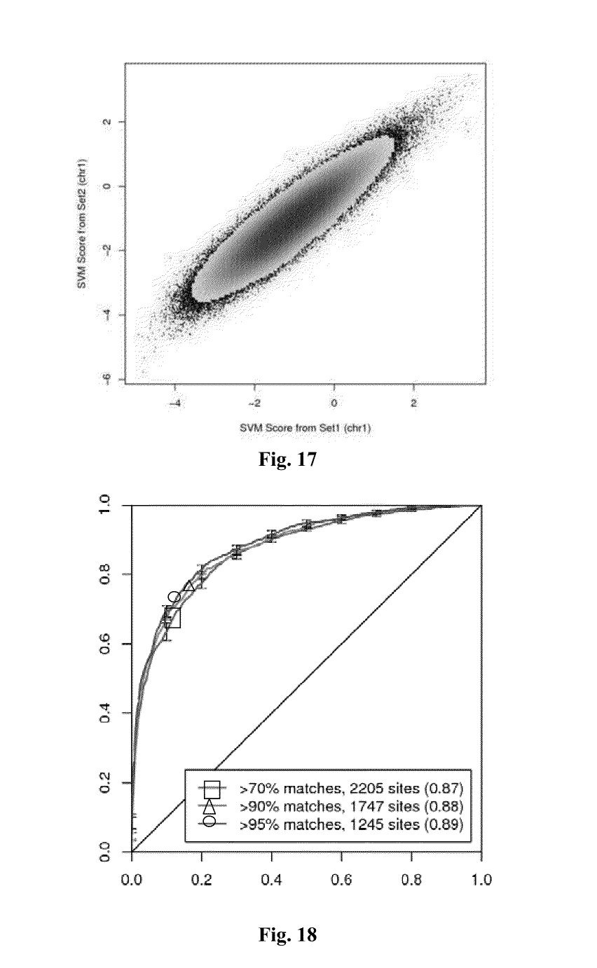

At an SVM score threshold of 1.0, 33,232 1-kb regions in the genome (outside of the EP300 training set) were predicted, or 26,920 enhancers after merging overlapping regions, and it was expected about 13,460 of these to be true enhancers. This threshold appeared to be a good tradeoff between detecting many biologically significant enhancers with an acceptable false discovery rate. The full lists of SVM scores for these regions are included as Supplementary Material. The robustness of these top SVM scoring regions was established by training separate SVMs with independent random null sequence sets as the negative class. There was extensive overlap between the top scoring regions using these different SVMs (Table 5), and the correlation of individual SVM scores between two different SVMs is high (Pearson correlation coefficient=91.5%), as shown in FIG. 17. That the SVM classifier identified many more sequence regions than the EP300 training set may be due to several factors: (1) As discussed above, these predicted regions may be false positive enhancers; (2) they may be true positive enhancers that were undetected in the ChIP experiments because of an overly stringent cutoff for defining the EP300 training set; (3) they may be true positive enhancers that are not EP300-bound in this tissue at the developmental stage of the experiment but may be EP300 bound in other tissues or times; or (4) they may be true positive enhancers that operate independently of EP300 but share some similar sequence features. All, but the first possibility, are potentially biologically interesting.

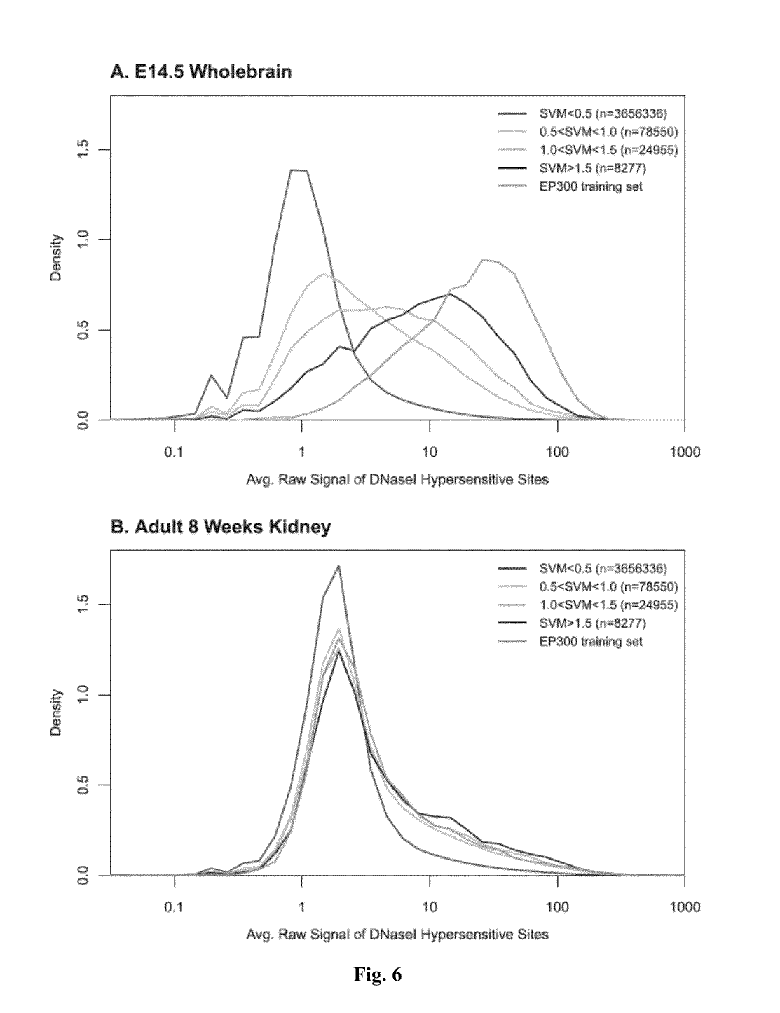

Methods and systems of the present invention comprise in vivo or in vitro assays or experiments to confirm the output results of test data from a trained SVM. To assess the validity of these genome-wide predictions with independent experimentation, the DNase I hypersensitivity of the high scoring forebrain SVM regions was quantified with experiments in embryonic mouse whole brain provided by the mouse ENCODE project (data available from http://genome.ucsc.edu/ENCODE/; J. Stamatoyannopoulos, in prep), using methods described in John et al. (2011). DNase I hypersensitivity measurements detect open or accessible chromatin, including promoters and enhancers, independent of EP300 binding. Although these DNase I experiments are not strictly specific to forebrain and were 3 d later in development, enrichment in brain hypersensitivity strongly corroborates the predictions as tissue-specific enhancers. In FIG. 6, the predicted 1-kb regions from the EP300 fb trained SVM were split into four classes (SVM<0.5, red; 0.5<SVM<1.0, gray; 1.0<SVM<1.5, cyan; and SVM>1.5, blue) and one EP300 training set class (EP300-bound regions, green). The distributions of average intensity of DNase I hypersensitivity of the different SVM scoring classes were plotted in FIG. 6A, which shows a dramatic increase in DNase I signal in E14.5 brain only for high scoring SVM regions.

There is no enrichment of DNase I signal for the same regions in other tissues; for example adult kidney is shown in FIG. 6B as a negative control. Because the DNase I hypersensitive regions include promoters and other open regions, the converse is not true, i.e., while almost all high-scoring SVM regions have a high DNase I signal, not all high-signal DNase I regions have a high SVM score (data not shown). With this understanding, the precision and specificity with which the SVM detects DNase I sensitive enhancers was evaluated. Because the SVM score and DNase I signals are continuous, DNase I signal >10 to was considered to be positive (open chromatin), and DNase I<2 was considered to be negative (not open) for purposes of quantification, consistent with the distributions in FIG. 6A,B. Then, regions with DNase I>10 and SVM>1.0 are true positive predictions, and DNase I<2 and SVM>1.0 regions are false positive predictions. Table 2 shows the number of 1-kb genomic regions in each class. The precision is TP/(TP+FP), or the accuracy of the predicted positives. The sensitivity is 1-FPR (false positive rate), or the fraction of negatives that were predicted to be positive. As shown in Table 2, SVM>1.0 predictions have a 56.3% precision, and more stringent SVM>1.5 predictions have a 74.5% precision. These results are consistent with the above estimate that 50% of these novel predictions are true enhancers functioning in mouse brain.

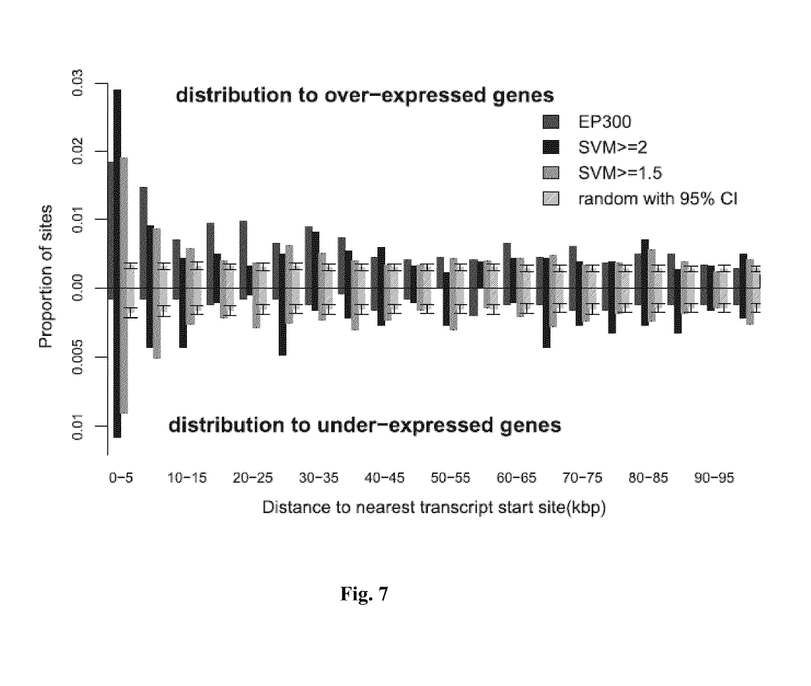

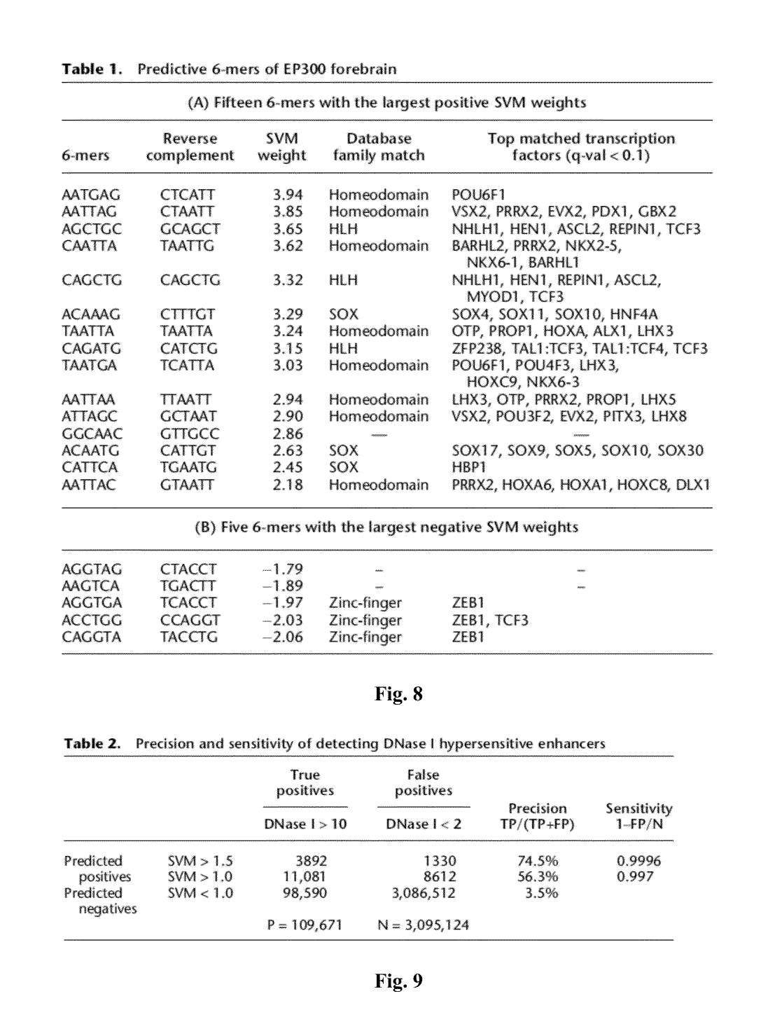

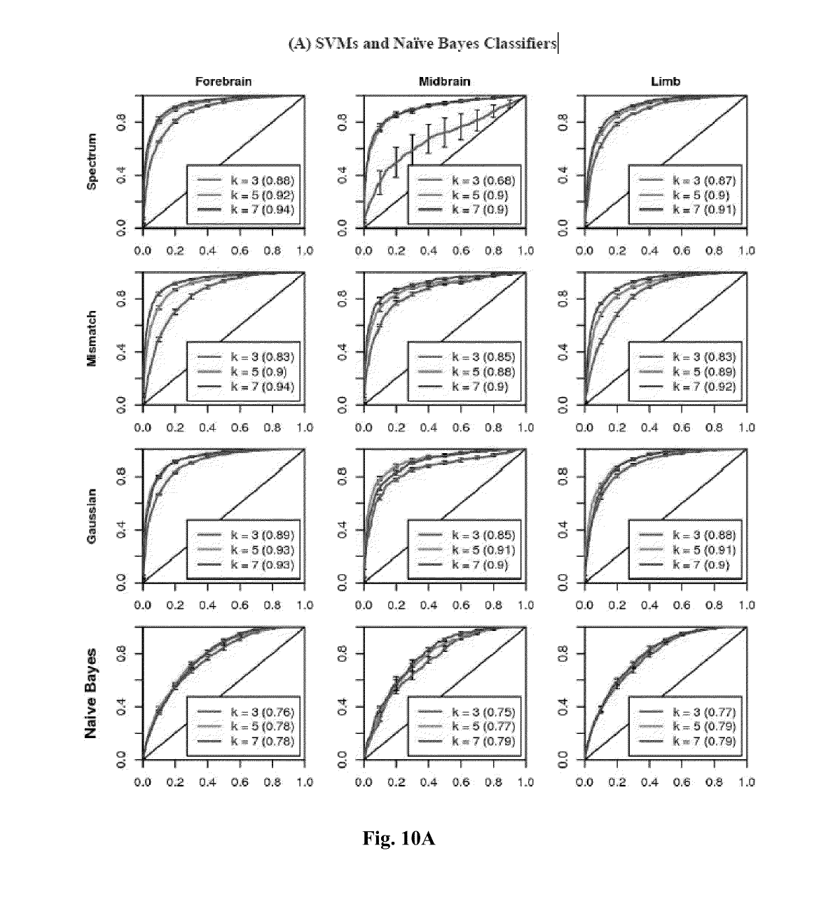

To further support the biological significance of these novel SVM-predicted enhancers, their proximity to forebrain-expressed genes was examined. Microarray experiments (Visel et al. 2009) identified 885 (495) genes overexpressed (underexpressed) in the forebrain at E11.5. The intergenic distance between the EP300 training set regions and the transcription start site (TSS) of the nearest overexpressed genes were examined, along with the distance between the SVM-predicted enhancer regions and the overexpressed genes. All regions overlapping a training set region were omitted from the set of predictions. As shown in FIG. 7, both the EP300 training set and the predicted enhancer regions are significantly enriched near (within 10 kb of) the TSS of a forebrain overexpressed gene. Notably, the SVM predicted regions with the more stringent SVM cutoff score (SVM>2.0) are even more enriched within 10 kb of the overexpressed genes than the EP300 training set, further evidence that the SVM is capturing functional regions with spatial and temporal specificity. In comparison, randomly chosen genomic regions show no such enrichment. While the EP300 training set is not enriched near forebrain underexpressed genes, the SVM predicted regions are significantly enriched within 10 kb of forebrain underexpressed genes (FIG. 7). Though not wishing to be bound by any particular theory, it is hypothesized that because the EP300 bound regions are not enriched near the underexpressed genes, it is unlikely that EP300 is acting as a transcriptional repressor here. It seems more likely that the SVM is predicting enhancers that are bound by EP300 in other tissues or at other times in development. These enhancers could activate the neighboring genes relative to their expression level at E11.5 in the forebrain, which would appear indistinguishable from forebrain repression. This hypothesis is supported by the fact that several of the underexpressed genes with nearby SVM-predicted enhancers play roles in nervous system development, including many HOX genes known to function in A-P axis patterning.

### SVM Also Predicts Human Enhancers

The present invention comprises use of a SVM, trained with a data set disclosed herein or the 6-mers data set disclosed herein, or a data set from a species other than humans, comprising wither homologous or nonhomologous sequences, to predict human enhancers. An aspect of the invention comprises use of training data comprising enhancer sequences from one species to train a SVM, wherein test data comprising sequences from a second unrelated species are used in the trained SVM to predict enhancer sequences in the second species. Such sequences used in the training data and the test data may be homologous or nonhomologous. For example, human orthologous regions (hg18) of the mouse EP300 training set with the liftOver utility from the UCSC genome browser (Karolchik et al. 2008) were found. With 70% or greater identity, 2205 of the 2453 forebrain enhancers were successfully mapped onto the human genome. 13 mapped sequences longer than 3 kb were discarded. SVMs were trained to discriminate this positive human training set from an equal number of human random sequences generated by these null model and achieved reasonably high auROC=0.87 (FIG. 18). More stringent orthology cutoffs (requiring 90% and 95% identity instead of 70%) were tested and it was found that the overall performance was very similar (FIG. 18). Thus, an SVM trained on human sequence homologous to the mouse EP300 training set sequences is able to predict test set enhancers with only slightly reduced accuracy relative to mouse.

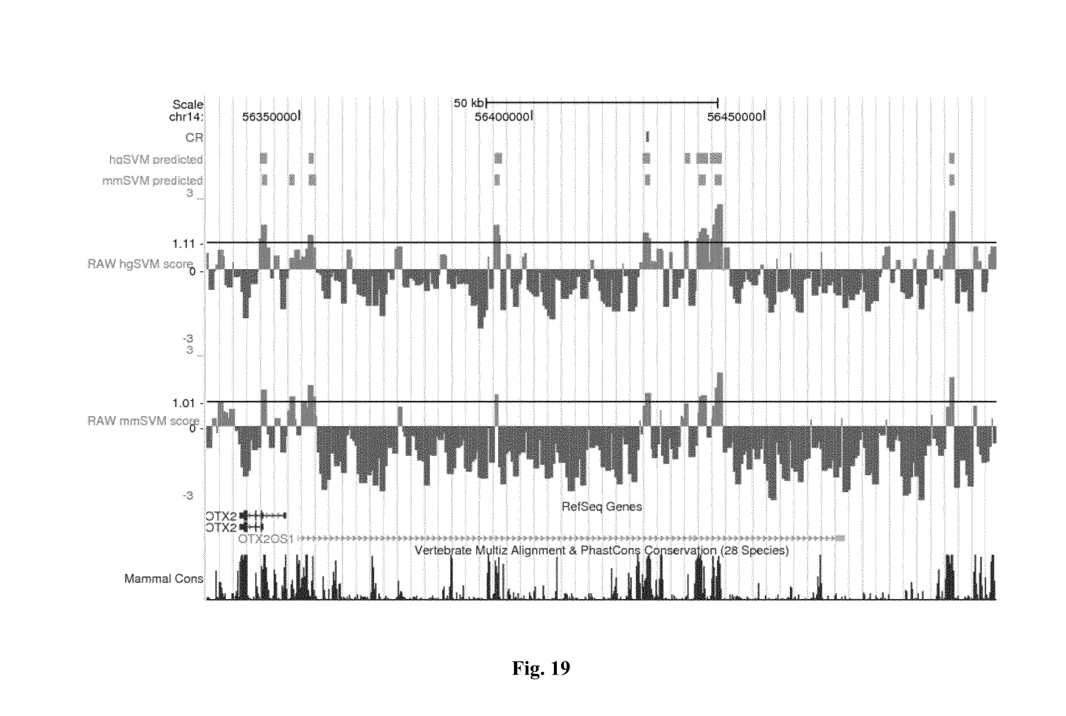

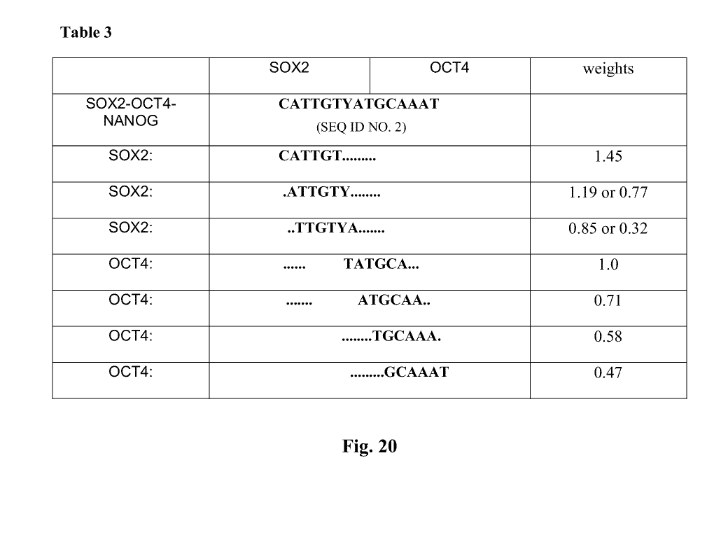

Human enhancer regions with a SVM trained on the mouse data set was predicted, which does not require sequence alignment to identify orthologous regions. This approach is useful in situations where it is difficult or impossible to obtain similar data sets in each species. It also provides further information about the conservation of predictive k-mers between the two species. Two raw SVM scores (one trained on the human homologous set, the other on the mouse data set) on the human genome around Otx2 were compared, and very similar SVM score patterns were observed. Moreover, an experimentally verified enhancer (Kurokawa et al. 2004) was captured by both SVMs (FIG. 19). The entire genome was analyzed to assess how many top SVM-scoring regions overlap each other (Table 6). Although the overlaps were not as significant as scores using only different negative sets (Table 5), a large fraction of top SVM-scoring regions were still shared between the two SVMs, so to a large degree, an SVM trained on mouse can be used to successfully predict human enhancers. This result is in general agreement with in vivo experimental results (Wilson et al. 2008) where human DNA transplanted into mice was shown to bind mouse TFs (HNF1A, HNF4A, HNF6) in a pattern virtually indistinguishable from their binding patterns in human, indicating that variations in genomic TF binding between human and mouse are due to local DNA sequence differences, not due to evolutionary divergence of individual TF binding specificities between the two species.

### Comparison Between Different EP300/CREBBP ChIP-Seq Data Sets Reveals Sequence Elements Important for Pluripotency

Methods and systems of the present invention comprise in vivo or in vitro assays or experiments to confirm the output results of test data from a trained SVM. The success of the SVMs in predicting EP300 binding in mouse embryonic brain and limb motivated a comparison with other EP300/CREBBP ChIP-seq data sets. The overlap between Visel's in vivo data set (EP300 forebrain, midbrain, and limb) and two other data sets were examined: CREBBP-bound regions in activated cultured mouse cortical neurons (Kim et al. 2010), and EP300 bound regions in cultured mouse embryonic stem cells (Chen et al. 2008), herein referred to as “CREBBP neuron” and “EP300 ES”. These data sets share similar ChIP-seq methodology, and it would address the overlap between activation mediated by the close homologs EP300 and CREBBP, and to address differences in EP300 binding in different tissues and cell populations. CREBBP neuron enhancers only overlap significantly with EP300 forebrain enhancers (not midbrain or limb) (Table 7). EP300 ES enhancers do not significantly overlap with any other set (fb, mb, lb, or CREBBP neuron) (Table 7). This indicates that EP300-mediated embryonic neuronal development is linked to CREBBP-mediated neural activity dependent transcription via extensively shared common regulatory regions. It was observed that several predictive k-mers with large positive weights, such as homeodomain binding sites (TAAT core) and bHLH domain binding sites (E box, CANNTG), were shared between the two data sets (Table 1A; Table 8), which further indicated common modes of regulation.

FIG. 3G shows ROC curves discriminating CREBBP neurons (auROC=0.93) and EP300 ES (auROC=0.77) from random genomic sequences. The lower EP300 ES auROC is partly due to the relatively smaller number of regions bound in the EP300 ES positive set. Also, the EP300 ES data set contains a larger fraction of repeat sequences, indicating that this data set may be less specific for functional EP300 binding. Nonetheless, SVMs still can extract informative k-mers from this data set and can largely discriminate the EP300 ES set from random genomic sequences. Alternatively, instead of comparing to random genomic sequence, these sets (EP300 forebrain, CREBBP neuron, EP300 ES) were successfully classified against each other, as shown in FIG. 3H. It is interesting to note that EP300 forebrain can be discriminated from CREBBP neuron with high auROC, even though they share many regions and have some common predictive k-mers (homeodomain, SOX, bHLH) when classified against random sequence (Table 1A; Table 8). However, when classified against each other, it was observed that the predictive k-mers specific for EP300 forebrain remain homeodomain, SOX, and bHLH, but the k-mers predictive for CREBBP neurons become nuclear factor I (NFI), activator protein 1 (AP1), and cyclic AMP-responsive element-binding protein (CREB) binding sites (Table 10). Therefore, homeodomain, SOX, and bHLH binding sites may play more prominent roles in neural developmental processes than in neural activity dependent transcription.

The biological significance of the predictive k-mers in these new data sets was assessed. Most of the predictive k-mers can be related to known TFBSs (Tables 8, 9), and that many of the identified TFBSs were involved in signaling pathways known to function in the relevant experimental conditions. For the CREBBP neuron data set, AP1 related 6-mers, GACTCA and TGACTC, the first and third largest weights respectively (Table 8), were the target of heterodimers of the regulators Fos and Jun, which play critical roles in neural activity dependent transcription regulation (Flavell and Greenberg 2008). CREB, which directly interacts with CREBBP, was also essential for the activation of several genes in response to neural stimulation, and its binding site is ranked fourth in Table 8 (Flavell and Greenberg 2008; Kim et al. 2010). Kim et al. noted that two other transcription factors, neuronal PAS domain containing protein 4 (NPAS4) and serum response factor (SRF) as well as CREB, strongly colocalize with CREBBP binding regions. NPAS4 contains a bHLH domain, and its canonical binding sites, E-box elements, are ranked at second and sixth in Table 8. The SRF binding site is also known as a CArG box, whose consensus sequence is CCWTATAWGG (SEQ ID NO:1) (Bryne et al. 2008). A specific k-mer instance of the CArG box is ATATGG, ranked at 17th with w=3.00, just below the top fifteen in Table 8. Therefore, all well-characterized TFBSs known to play a role in neuronal activation were successfully captured by this SVM. Two additional transcription factor families also scored highly in the CREBBP neuron data set: homeodomain and NFI. These families have been discussed little in this context, although it is known that both NFI and homeodomain transcription factors are key regulators of central nervous system development (Wilson and Koopman 2002; Mason et al. 2008). One relevant example of neural activity-dependent expression of a homeobox protein was found, LMX1B (Demarque and Spitzer 2010). There may be still unknown mechanisms involving NFI and homeodomain proteins in the context of neural activity-dependent transcriptional regulation, but broadly speaking, the results indicate significant pleiotropy between neuronal developmental pathways and neural activity-dependent signaling pathways.

Comparison of the EP300 ES data to CREBBP neuron and EP300 forebrain can address which binding sites and factors are responsible for maintaining a differentiated or pluripotent state. For the EP300 ES data set, a method disclosed herein identified factors known to be crucial for maintaining ES identity: high scoring binding sites for NANOG-POU5F1 (also known as OCT4)-SOX2 SOX-family factors (Table 9) were found, essentially the same binding sites found in previous studies (Pavesi et al. 2001; Chen et al. 2008). A uniform approach was used to map k-mers to TFBS in the databases, but there is substantial overlap in many TF specificities, and some reported matrices may score higher than the biologically relevant database entry. For instance, in Table 9, the high-scoring matrices (SOX17, POU2F1, and POU3F3) appear on the list instead of the relevant SOX2, POU5F1, and NANOG, which have nearly identical binding sites. SOX2, POU5F1, and NANOG bind a combination of the SOX2 (CATTGT) and POU5F1 (ATGCAAAT) consensus sites (Chen et al. 2008), and the 6-mer subsequences within the combined binding site (CATTGTYATGCAAAT (SEQ ID NO:2)) have high SVM weights. Table 3 shows how large weight k-mers tile across this extended known binding site. Positive weight binding sites for ESRRB and STAT3 were found, which are known to be frequently located nearby the NANOG-POU5F1-SOX2 clusters assessed by ChIP-seq analysis (Chen et al. 2008). Many of the positive weight EP300 ES k-mers (ESRRB, RORA1/2, PPARG) are among the largest negative weights in CREBBP neuron (Table 9), indicating that binding sites for factors responsible for maintaining pluripotency are significantly absent from neuronal enhancers (CREBBP neuron), as would be expected given the developmental maturity of neurons.

### SVM can Predict Other ChIP-Seq Data Sets

The present invention comprises SVM methods to classify and detect EP300/CREBBP-bound enhancers, or any data set which may be framed as a sequence classification: e.g., ChIP-seq, ChIP-chip, or DNase I hypersensitivity data sets. In these situations, the SVM can be used to identify primary binding sites in regions identified by transcription factor ChIP experiments and may also identify binding sites for secondary factors colocalized with the ChIPed TF or binding sites significantly depleted in the functionally occupied regions. Current de novo motif-finding methods such as AlignACE (Hughes et al. 2000) or MEME (Bailey and Elkan 1994) have limited success when applied to data sets of this size. When run on the forebrain enhancer data set, AlignACE (when it converged) failed to report any meaningful motifs. While Chen et al. (2008) did successfully identify SOX2, POU5F1 (OCT4), and NANOG binding sites in the EP300 ES data with Weeder (Pavesi et al. 2001), the EP300 ES data set was the smallest and least diverse of the data sets analyzed.

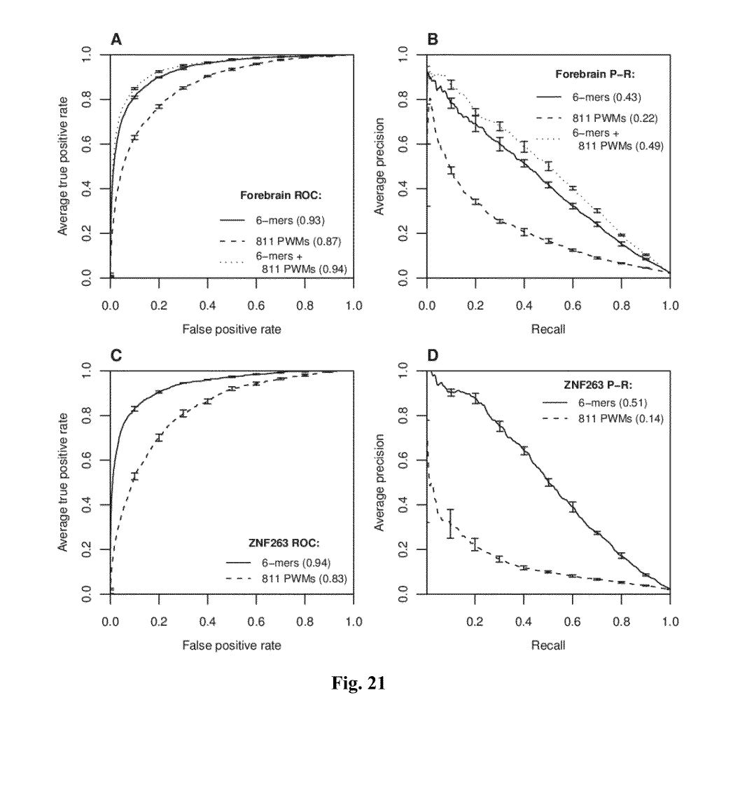

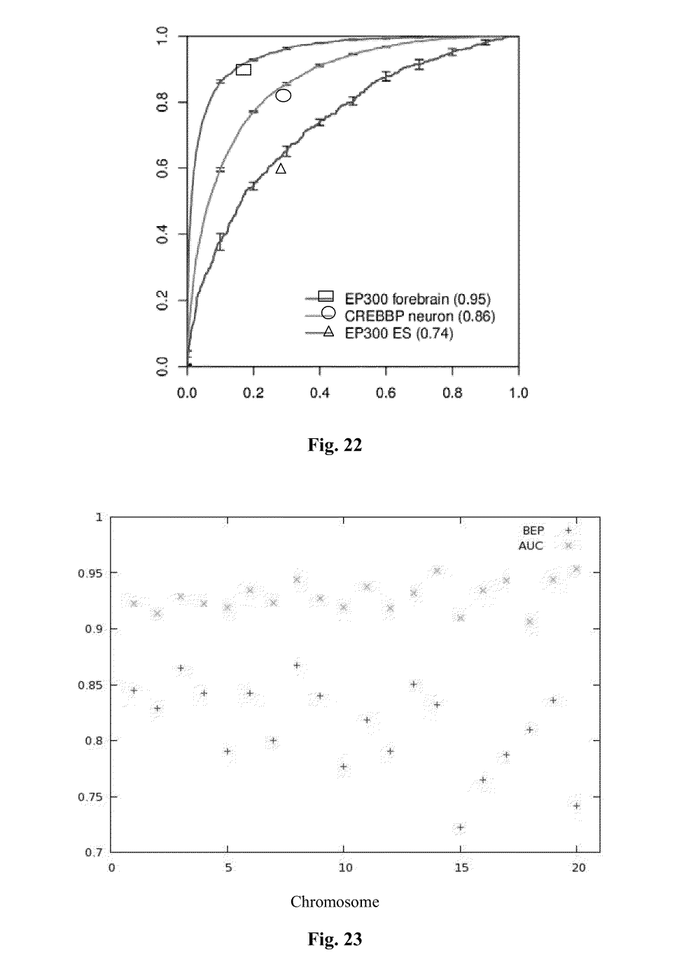

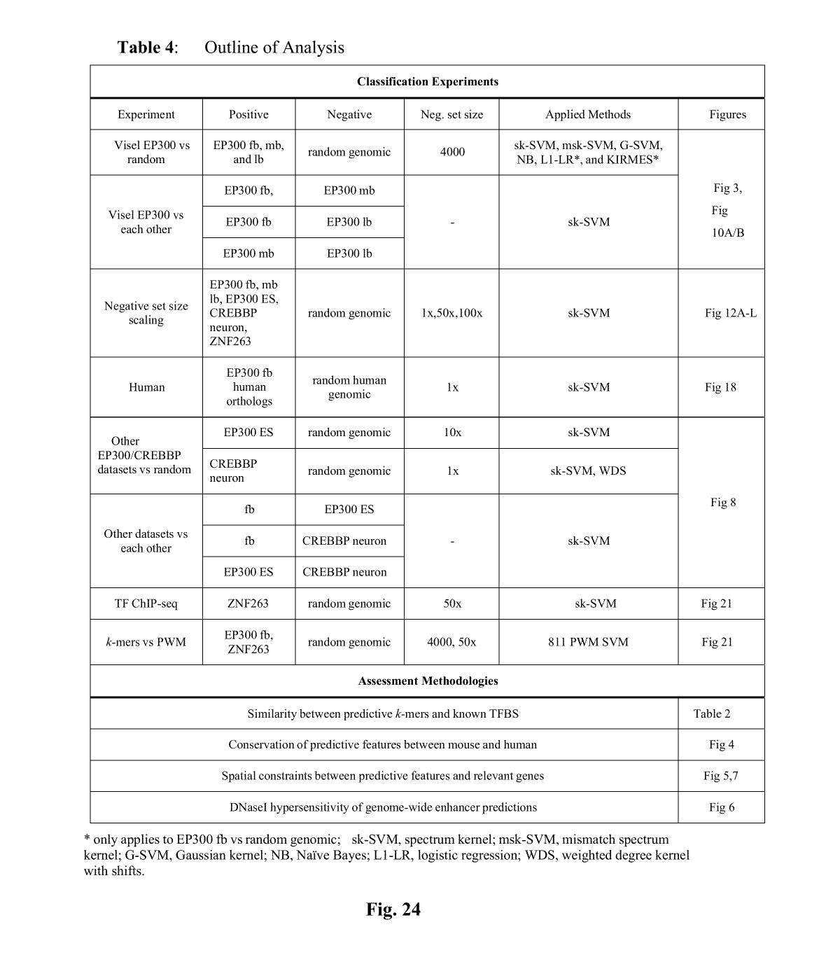

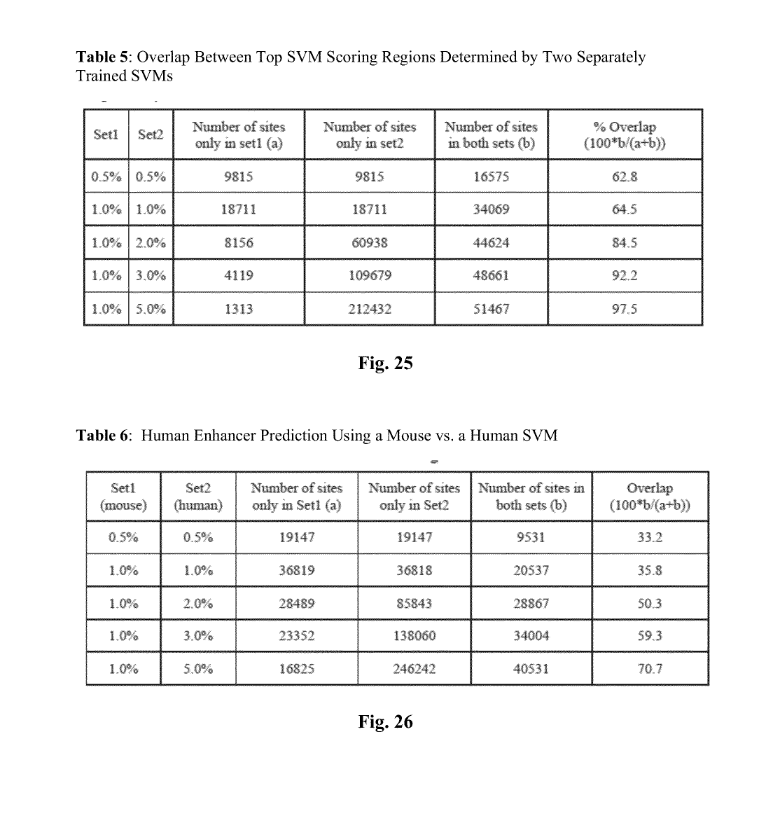

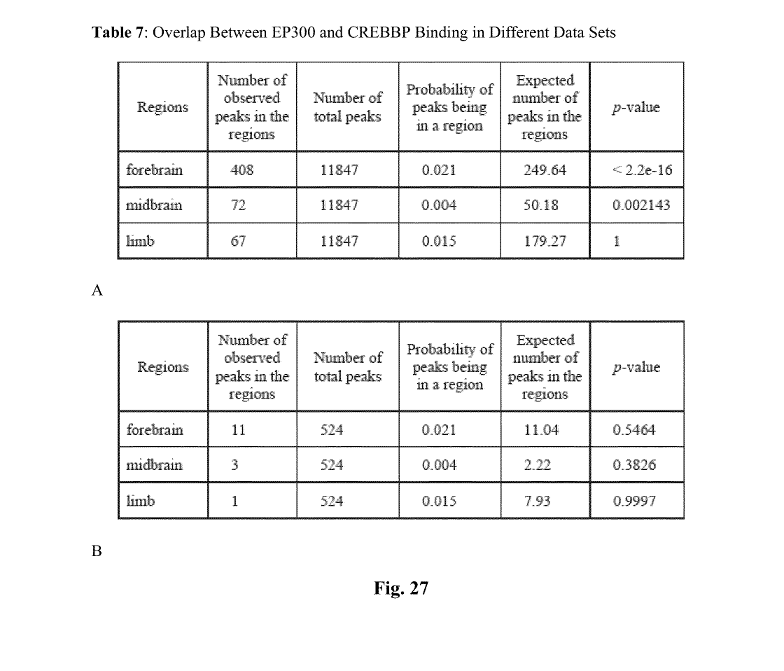

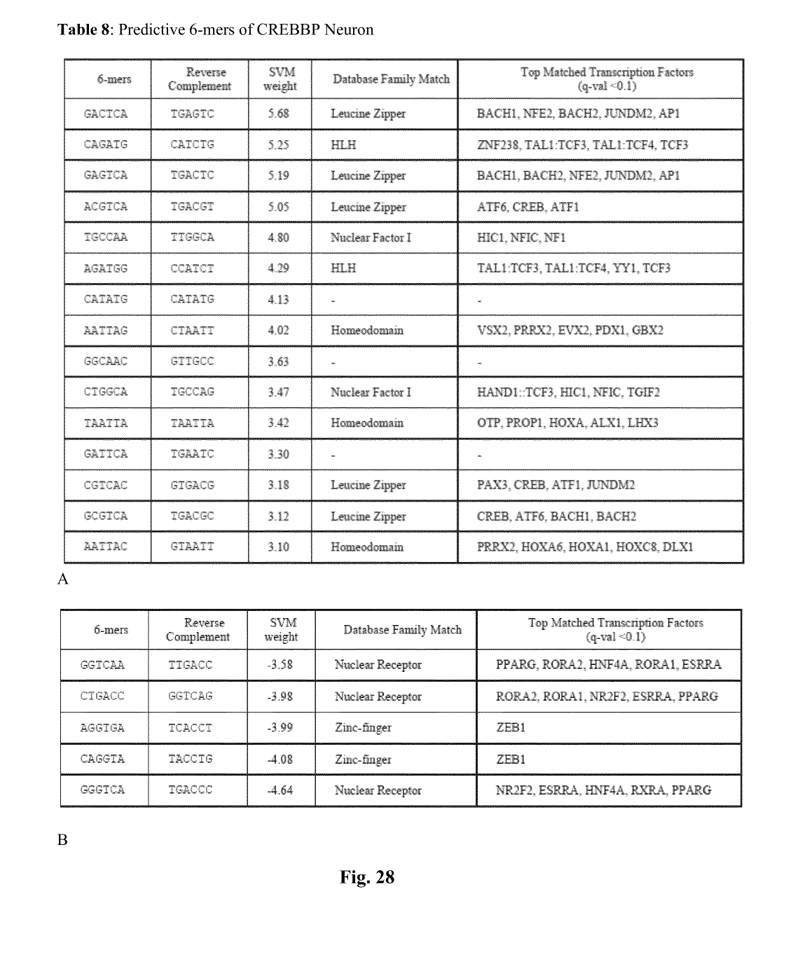

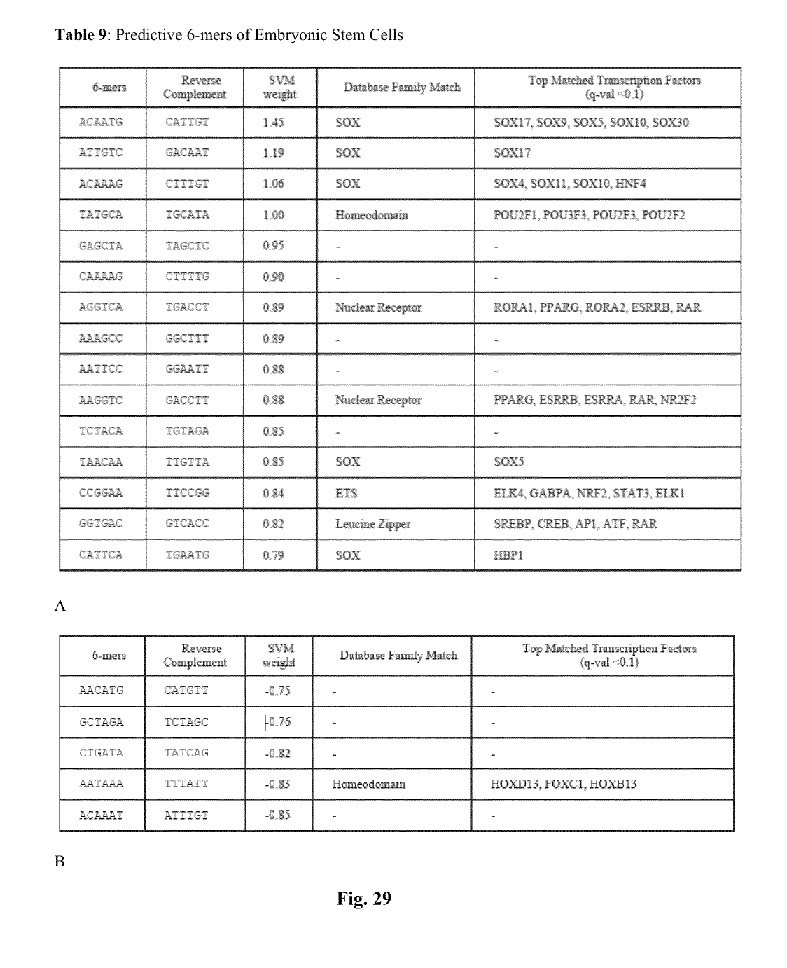

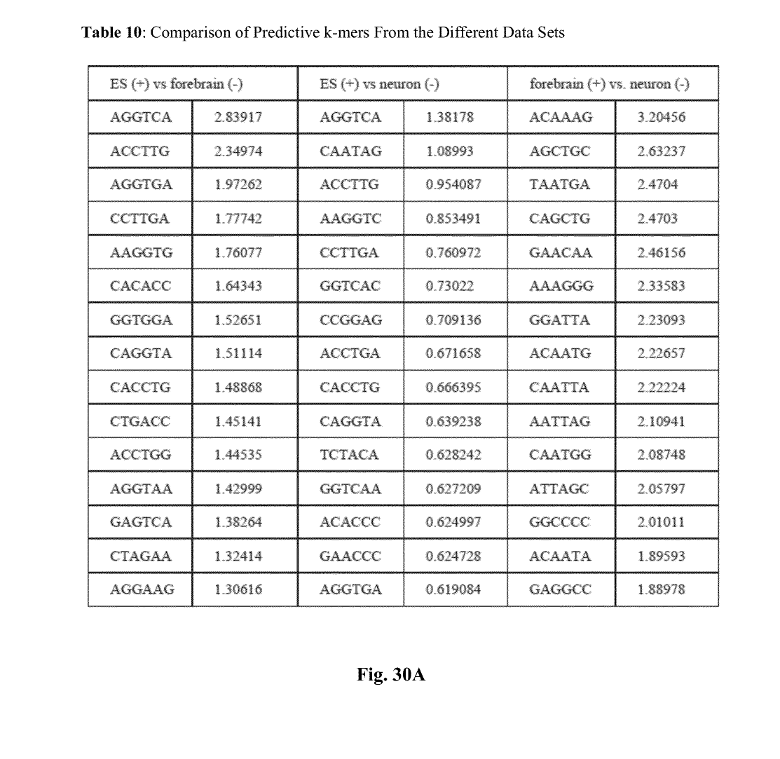

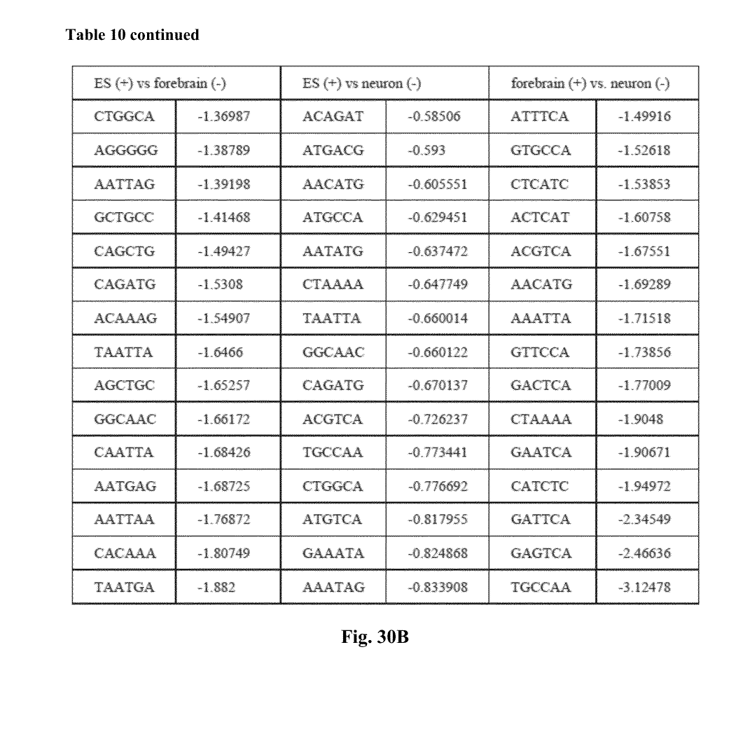

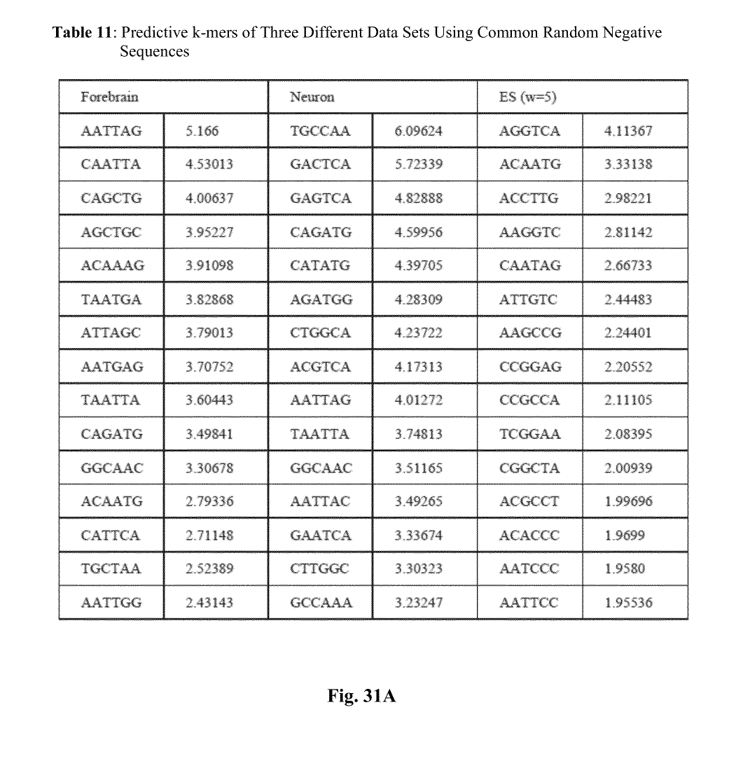

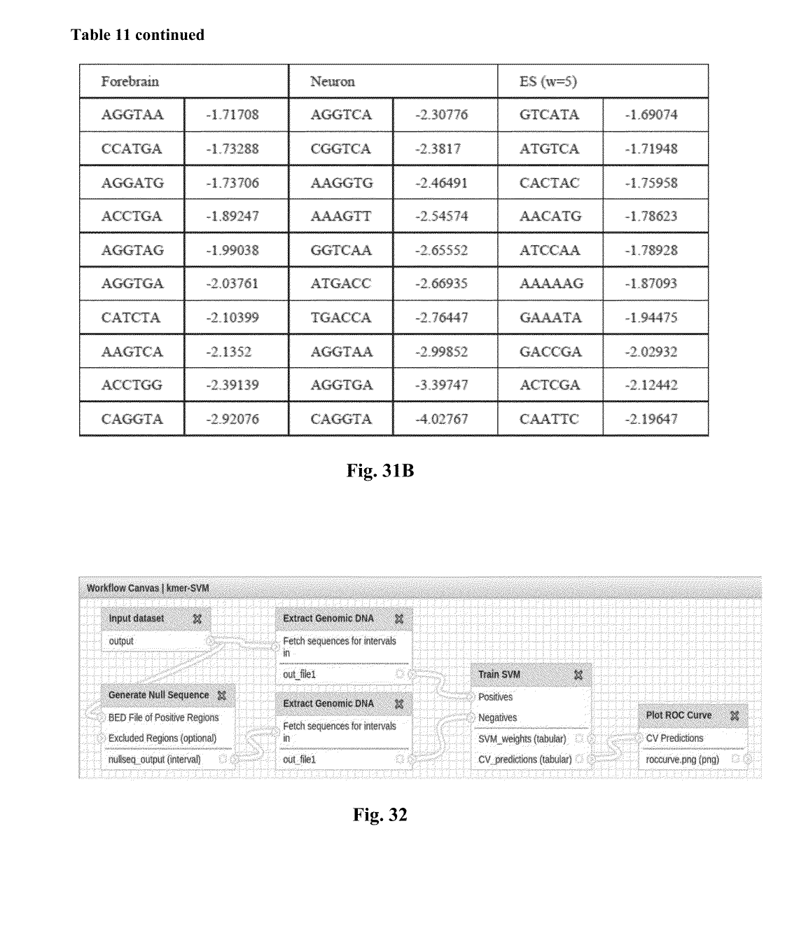

To directly assess the ability of a trained SVM to predict binding of individual transcription factors, ChIP-seq results on the TF ZNF263 were analyzed. ZNF263, a 9-finger C2H2 zinc finger which is predicted to have a binding site of ˜24 bp, was chosen to assess how well k-mers can represent extended degenerate binding sites. ChIP-seq data on ZNF263 in a K562b cell line (Frietze et al. 2010) was used which identified 1418 strongly bound regions. Predicting against a 503 random negative set yielded auROC=0.938 and auPRC=0.51 (FIG. 21B, D). Many of the largest weight k-mers are subsequences within the large PWM found by de novo motif-finding tools applied to this data set (Frietze et al. 2010), and the SVM is combining k-mers which tile across the binding site to achieve high predictive accuracy. The k-mer GAGCAC also received a large weight. This indicates that the present invention should have significant predictive value for a wide range of binding data.

### Comparison to Alternative Approaches

As an alternative to k-mers, known PWMs were used as features in an SVM. 811 PWMs from existing databases of known TF specificities [JASPAR (Bryne et al. 2008), TRANSFAC (Matys et al. 2003), and UniPROBE (Newburger and Bulyk 2009)] were used. When using these features, the highest PWM scores in each sequence for each matrix was used as the feature vector. This 811-PWM SVM was able to achieve auROC=0.87 for forebrain enhancers (compared to auROC=0.93 for k-mers), somewhat less predictive than the k-mer approach (FIG. 21A), against a 503 random negative set. However, this translates into a significantly lower auPRC=0.22 (compared to auPRC=0.43 for k-mers) (FIG. 21B). The optimal combined weighting of the known PWMs and 6-mers features (2080+811 total features) gives marginal improvement (auROC=0.93 and auPRC=0.49) over 6-mers alone. The 811-PWM SVM was applied to the ZNF263 data set, which achieved auROC=0.83 (compared to auROC=0.94 for k-mers), reflecting the fact that accurate PWMs for ZNF263 were absent from the databases (FIG. 21B,D). The seemingly small change in auROC corresponded to a large drop in auPRC=0.14, compared to auPRC=0.51 for k-mers. This demonstrates that using sequence features from an unbiased and complete set can be more valuable than using an incomplete set of more accurate features (PWMs). Using the set of known TF PWMs is less predictive than the k-mer SVM, but a more complete set of PWMs might perform better. Combining the predictive k-mers into a more general PWM via a method similar to positional oligomer importance matrices (POIMs) (Sonnenburg et al. 2008) might allow clearer identification of informative sequence features from within the k-mer SVM but would not affect predictive performance.

Alternative kernel methods were compared. The weighted degree kernel with shifts (WDS) (Rätsch et al. 2005) was applied to the CREBBP neuron data set (as WDS requires input sequences of equal length) and found auROC=0.83, compared to auROC=0.93 for the k-mer trained SVM. A notable SVM based approach which incorporates positional information between general k-mer features (KIRMES) has been recently described (Schultheiss et al. 2009; Schultheiss 2010). This package was to the forebrain EP300 data set and found auROC=0.90. In the current implementation of KIRMES, k-mers are selected by their relative frequency in the positive set, and it is likely that further optimization would make this approach comparable to the k-mer SVM result. Additionally, the periodic spatial distribution in FIG. 5 suggests that a model based on difference in angle (similar to Hallikas et al. 2006) would be more appropriate than the Gaussian spatial dependence used in KIRMES. Another approach to predict promoters (Megraw et al. 2009) used PWMs and 11-logistic regression. Little difference was found between logistic regression and SVM: Using the k-mer feature vectors in 11-logistic regression yielded auROC=0.92 on the EP300 forebrain data set, using publicly available software (Koh et al. 2007).

Disclosed herein are methods and systems comprising a support vector machine to accurately identify regulatory sequences without any prior knowledge about transcription factor binding sites, using only general genomic sequence information. While the ROC and P-R curves demonstrate that the trained k-mer SVM was able to identify enhancers based on their sequence features, the biological relevance of the predicted enhancers is further supported by the following: (1) Most of the predictive sequence features identified by these methods are binding sites of previously characterized TFBSs known to play a role in the relevant context; (2) the enriched predictive sequence features are much more evolutionarily conserved within the enhancers than the less predictive sequence features, which suggests that the predictive features are under selection and comprise the functional subset of the larger enhancer regions; (3) these sequence features are significantly more spatially clustered in the enhancers than would be expected by chance, also a well-known characteristic of functional binding sites; (4) genomic regions with high forebrain SVM scores are strongly enriched in DNase I hypersensitivity signals in mouse brain but not in other tissues; (5) the predicted enhancers frequently overlap with regions of enhanced ChIP-seq signals but are somewhat below the signal cutoff necessary to be included in the original EP300 training set; and (6) these novel predicted enhancers are preferentially positioned near biologically relevant genes, and many have been experimentally verified in other studies, which further supports their biological relevance and functional roles.

When scanning the whole genome to predict putative enhancers, it was predicted that 50% of the 26,920 nonoverlapping enhancers with forebrain SVM scores above 1.0 are true positives. This is a conservative estimate of the ability of the methods and systems disclosed herein to detect novel enhancers, since, when scanning the genome, 1-kb arbitrarily delimited chunks of sequence were scored; more accurate predictions might be possible by varying the endpoints of the predicted regions. Nevertheless, this genome-wide scan discovers thousands of novel predicted enhancers that were not in the original experimental training set. Methods and systems of the present invention can predict human enhancers based on these mouse enhancer experiments by measuring the overlap between human enhancers predicted by an SVM trained on the mouse sequence and comparing these predictions to an SVM trained on human sequence orthologous to the mouse enhancer sequences. Finally, by comparing between other EP300/CREBBP ChIP-seq data sets, sequence features that are able to differentiate between enhancers that operate in different tissues or at different developmental stages were found. Some of these sequence features are enriched in enhancers in one specific tissue or state, but other predictive elements are notably depleted in some classes of enhancers.

It is perhaps surprising that such a simple description of sequence features (k-mer frequencies) is able to classify enhancers and ChIP-seq data so well. The SVM is apparently combining k-mer features in a sufficiently flexible way to reflect combinations of binding sites and/or sequence signals which modulate chromatin accessibility. Developing an optimal sequence feature vector remains an area for future work; however, these results showing that the SVM is more accurate than Naive Bayes suggests that successful prediction requires the ability to combine features without evaluating them independently.

Improvements to the methods and systems described herein, to make more accurate predictions, are theorized. Though not wishing to be bound by any particular theory, incorporating positional constraints between the features may improve the accuracy of the predictions, consistent with the observation of nonrandom spatial distributions between predictive features in the SVM. Kernel approaches have been developed which incorporate positional information, but most have been developed in the context of positional constraints relative to a single preferred genomic location or anchor point. In application to other problems, positional information relative to a transcription start site (Sonnenburg et al. 2006b), to a splice site (Rätsch et al. 2005; Sonnenburg et al. 2007), or to a translational start site (Meinicke et al. 2004) has been implemented in SVM contexts. Positional preference relative to a mean anchor point has been incorporated in a de novo motif discovery method developed by Keilwagen et al. (2011). However, the aforementioned methods are not strictly appropriate to the biological problem of enhancer detection, because enhancers have no such preferred fixed location, and the relevant positional constraints are between sequence features within the enhancer. Many approaches have modeled clusters of known binding sites (for review, see Su et al. 2010) but have limited application to mammalian enhancer prediction.

Although evidence is provided that k-mer trained SVM-predicted regions are likely functional, the predicted enhancers may be based on sequence features which are tissue-specific. Alternatively, sequence features could be general to larger classes of enhancers. These common features could allow access, could stabilize, or could be recognized by generic components of the enhanceosome (Thanos and Maniatis 1995; Maniatis et al. 1998), whose activity could be modulated by tissue-specific factors, much as Pol II operates generally. Ultimately this should be determined by individual experiments. The methods and systems disclosed herein determined enhancers computationally by investigating overlaps between forebrain and limb-specific predicted regions, which were compared with the overlaps between EP300enriched regions in forebrain and limb. For this comparison, the EP300-enriched regions were determined from the raw data set using the same threshold criteria as the previous study (Visel et al. 2009) except that fixed-length 1-kb regions were used, rather than the ChIP-seq determined peak regions. With a 1% false discovery rate (FDR), 3390 EP300-enriched regions of forebrain and 2607 regions of limb were found. Visel's EP300-bound regions are highly tissue-specific; there are only 243 regions (7%-9%) shared by the two sets. For the SVM predictions, a significantly larger fraction of forebrain predicted regions (6104 out of 39,714, 15%) were found in 34% of the limb predicted regions (18,027). This suggests that the SVMs learn features that are generally enriched in enhancers, in addition to tissue-specific sequence features. As a result, two SVMs trained on entirely different data sets can predict common regions that have general enhancer function. Moreover, the 6104 regions predicted by both limb and forebrain SVMs overlap with small EP300 peaks that are somewhat below the conservative threshold (FDR<0.01); almost 50% have peak in at least one tissue. This observation further supports an hypothesis that SVM-predicted regions are likely to be functional. A further complication is that individual tissues consist of heterogeneous populations of cell types, and enhancers predicted in distinct tissues may only be active in subsets of cell types. A detailed analysis of which sequence features impart tissue specificity and which are general is suggested as a focus for future investigations.

### Methods Of Using the SVM

Once the determinative sequences are found by the learning machines of the present invention, methods and compositions for treatments of organisms can be employed. For example, therapeutic agents can be administered to antagonize or agonize, enhance or inhibit activities, presence, or synthesis of the gene products. Therapeutic agents include, but are not limited to, gene therapies such as sense or antisense polynucleotides, DNA or RNA analogs, pharmaceutical agents, biological molecules, small molecules, and derivatives, analogs and metabolic products of such agents.

This invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

All patents, patent applications, and references cited are herein expressly incorporated by reference.

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings

“Optional” or “optionally” means that the subsequently described event or circumstance may or may not occur, and that the description includes instances where said event or circumstance occurs and instances where it does not.

“Probes” are molecules capable of interacting with a target nucleic acid, typically in a sequence specific manner, for example through hybridization. The hybridization of nucleic acids is well understood in the art and discussed herein. Typically a probe can be made from any combination of nucleotides or nucleotide derivatives or analogs available in the art.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

It is understood that the disclosed nucleic acids and proteins can be represented as a sequence consisting of the nucleotides of amino acids. There are a variety of ways to display these sequences, for example the nucleotide guanosine can be represented by G or g. Likewise the amino acid valine can be represented by Val or V. Those of skill in the art understand how to display and express any nucleic acid or protein sequence in any of the variety of ways that exist, each of which is considered herein disclosed. Specifically contemplated herein is the display of these sequences on computer readable mediums, such as, commercially available floppy disks, tapes, chips, hard drives, compact disks, and video disks, or other computer readable mediums. Also disclosed are the binary code representations of the disclosed sequences. Those of skill in the art understand what computer readable mediums. Thus, computer readable mediums on which the nucleic acids or protein sequences are recorded, stored, or saved.

Disclosed are computer readable mediums comprising the sequences and information regarding the sequences set forth herein. Also disclosed are computer readable mediums comprising the sequences and information regarding the sequences set forth herein.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

It is understood that the disclosed method and compositions are not limited to the particular methodology, protocols, and reagents described as these may vary. It is also to be understood that the terminology used herein is for the purpose of describing particular embodiments only, and is not intended to limit the scope of the present invention which will be limited only by the appended claims.

Throughout the description and claims of this specification, the word “comprise” and variations of the word, such as “comprising” and “comprises,” means “including but not limited to,” and is not intended to exclude, for example, other additives, components, integers or steps.

Those skilled in the art will recognize, or be able to ascertain using no more than routine experimentation, many equivalents to the specific embodiments of the method and compositions described herein. Such equivalents are intended to be encompassed by the following claims.

### REFERENCES

1. Bailey T, Elkan C. 1994. Fitting a mixture model by expectation maximization to discover motifs in biopolymers. Proc Int Conf Intell Syst Mol Biol 2: 28-36.
2. Banerji J. 1981. Expression of a-globin gene is enhanced by remote SV40 DNA sequences. Cell 27: 299-308.
3. Beer M A, Tavazoie S. 2004. Predicting gene expression from sequence. Cell 117: 185-198.
4. Ben-Hur A, Ong C S, Sonnenburg S, Schölkopf B, Rätsch G. 2008. Support vector machines and kernels for computational biology. PLoS Comput Biol 4: e1000173. doi: 10.1371/journal.pcbi.1000173.
5. Berger M F, Badis G, Gehrke A R, Talukder S, Philippakis A A, Peña-Castillo L, Alleyne T M, Mnaimneh S, Botvinnik O B, Chan E T et al. 2008. Variation in homeodomain DNA binding revealed by high-resolution analysis of sequence preferences. Cell 133: 1266-1276.
6. Bertrand N, Castro D S, Guillemot F. 2002. Proneural genes and the specification of neural cell types. Nat Rev Neurosci 3: 517-530.
7. Blackwood E M, Kadonaga J T. 1998. Going the distance: A current view of enhancer action. Science 281: 60-63.
8. Boser B E, Guyon I M, Vapnik V N. 1992. A training algorithm for optimal margin classifiers. In Proceedings of the Fifth Annual Workshop on Computational Learning Theory. Association for Computing Machinery (ACM), New York.
9. Bryne J C, Valen E, Tang M E, Marstrand T, Winther O, da Piedade I, Krogh A, Lenhard B, Sandelin A. 2008. JASPAR, the open access database of transcription factor-binding profiles: New content and tools in the 2008 update. Nucleic Acids Res 36: D102-D106.
10. Bulfone A, Puelles L, Porteus M, Frohman M, Martin G, Rubenstein J. 1993. Spatially restricted expression of Dlx-1, Dlx-2 (Tes-1), Gbx-2, and Wnt-3 in the embryonic day 12.5 mouse forebrain defines potential transverse and longitudinal segmental boundaries. J Neurosci 13: 3155-3172.
11. Carter D, Chakalova L, Osborne C S, Dai Y, Fraser P. 2002. Long-range chromatin regulatory interactions in vivo. Nat Genet 32: 623-626.
12. Chan H M, La Thangue N B. 2001. P300/CBP proteins: HATs for transcriptional bridges and scaffolds. J Cell Sci 114: 2363-2373.
13. Chen X, Xu H, Yuan P, Fang F, Huss M, Vega V B, Wong E, Orlov Y L, Zhang W, Jiang J, et al. 2008. Integration of external signaling pathways with the core transcriptional network in embryonic stem cells. Cell 133: 1106-1117.
14. Demarque M, Spitzer N C. 2010. Activity-dependent expression of Lmx1b regulates specification of serotonergic neurons modulating swimming behavior. Neuron 67: 321-334.
15. EInitski L, Hardison R C, Li J, Yang S, Kolbe D, Eswara P, O'Connor M J, Schwartz S, Miller W, Chiaromonte F. 2003. Distinguishing regulatory DNA from neutral sites. Genome Res 13: 64-72.
16. ENCODE Project Consortium. 2007. Identification and analysis of functional elements in 1% of the human genome by the ENCODE pilot project. Nature 447: 799-816.
17. Erives A, Levine M. 2004. Coordinate enhancers share common organizational features in the Drosophila genome. Proc Natl Acad Sci 101: 3851-3856.
18. Fisher S, Orrice E A, Vinton R M, Bessling S L, McCallion A S. 2006. Conservation of RET regulatory function from human to zebrafish without sequence similarity. Science 312: 276-279.
19. Flavell S W, Greenberg M E. 2008. Signaling mechanisms linking neuronal activity to gene expression and plasticity of the nervous system. Annu Rev Neurosci 31: 563-590.
20. Frietze S, Lan X, Jin V X, Farnham P J. 2010. Genomic targets of the KRAB and SCAN domain-containing zinc finger protein 263. J Biol Chem 285: 1393-1403.
21. Furey T S, Cristianini N, Duffy N, Bednarski D W, Schummer M, Haussler D. 2000. Support vector machine classification and validation of cancer tissue samples using microarray expression data. Bioinformatics 16: 906-914.
22. Ghanem N, Jarinova O, Amores A, Long Q, Hatch G, Park B K, Rubenstein J L R, Ekker M. 2003. Regulatory roles of conserved intergenic domains in vertebrate Dlx bigene clusters. Genome Res 13: 533-543.
23. Gotea V, Visel A, Westlund J M, Nobrega M A, Pennacchio L A, Ovcharenko I. 2010. Homotypic clusters of transcription factor binding sites are a key component of human promoters and enhancers. Genome Res 20: 565-577.
24. Gupta S, Stamatoyannopoulos J A, Bailey T L, Noble W. 2007. Quantifying similarity between motifs. Genome Biol 8: R24. doi: 10.1186/gb-2007-8-2-r24.
25. Hallikas O, Palin K, Sinjushina N, Rautiainen R, Partanen J, Ukkonen E, Taipale J. 2006. Genome-wide prediction of mammalian enhancers based on analysis of transcription-factor binding affinity. Cell 124: 47-59.
26. Heintzman N D, Stuart R K, Hon G, Fu Y, Ching C W, Hawkins R D, Barrera L O, Van Calcar S, Qu C, Ching K A, et al. 2007. Distinct and predictive chromatin signatures of transcriptional promoters and enhancers in the human genome. Nat Genet 39: 311-318.
27. Heintzman N D, Hon G C, Hawkins R D, Kheradpour P, Stark A, Harp L F, Ye Z, Lee L K, Stuart R K, Ching C W, et al. 2009. Histone modifications at human enhancers reflect global cell-type-specific gene expression. Nature 459: 108-112.
28. Hughes J D, Estep P W, Tavazoie S, Church G M. 2000. Computational identification of Cis-regulatory elements associated with groups of functionally related genes in Saccharomyces cerevisiae. J Mol Biol 296: 1205-1214.
29. Joachims T. 1999. Making large-scale support vector machine learning practical. In Advances in kernal methods, pp. 169-184. MIT Press, Cambridge, Mass.
30. John S, Sabo P J, Thurman R E, Sung M-H, Biddie S C, Johnson T A, Hager G L, Stamatoyannopoulos J A. 2011. Chromatin accessibility pre-determines glucocorticoid receptor binding patterns. Nat Genet 43: 264-268.
31. Johnson D S, Mortazavi A, Myers R M, Wold B. 2007. Genome-wide mapping of in vivo protein-DNA interactions. Science 316: 1497-1502.
32. Kadonaga J T. 2004. Regulation of RNA polymerase II transcription by sequence-specific DNA binding factors. Cell 116: 247-257.
33. Karchin R, Karplus K, Haussler D. 2002. Classifying G-protein coupled receptors with support vector machines. Bioinformatics 18: 147-159.
34. Karolchik D, Kuhn R M, Baertsch R, Barber G P, Clawson H, Diekhans M, Giardine B, Harte R A, Hinrichs A S, Hsu F, et al. 2008. The UCSC Genome Browser Database: 2008 update. Nucleic Acids Res 36: D773-D779.
35. Keilwagen J, Grau J, Paponov I A, Posch S, Strickert M, Grosse I. 2011. De-novo discovery of differentially abundant transcription factor binding sites including their positional preference. PLoS Comput Biol 7: e 1001070. doi: 10.1371/journal.pcbi.1001070.
36. Kim T, Hemberg M, Gray J M, Costa A M, Bear D M, Wu J, Harmin D A, Laptewicz M, Barbara-Haley K, Kuersten S, et al. 2010. Widespread transcription at neuronal activity-regulated enhancers. Nature 465: 182-187.
37. King D C, Taylor J, EInitski L, Chiaromonte F, Miller W, Hardison R C. 2005. Evaluation of regulatory potential and conservation scores for detecting cis-regulatory modules in aligned mammalian genome sequences. Genome Res 15: 1051-1060.
38. Koh K, Kim S-J, Boyd S. 2007. An interior-point method for large-scale 11-regularized logistic regression. J Mach Learn Res 8: 1519-1555.
39. Kurokawa D, Kiyonari H, Nakayama R, Kimura-Yoshida C, Matsuo I, Aizawa S. 2004. Regulation of Otx2 expression and its functions in mouse forebrain and midbrain. Development 131: 3319-3331.
40. Lee, et al., Genome Res. 2011. 21: 2167-2180, and supplemental material are at http://www.genome.org/cgi/doi/10.1101/gr.121905.111, each of which is herein incorporated in its entirety.
41. Lee J E. 1997. Basic helix-loop-helix genes in neural development. Curr Opin Neurobiol 7: 13-20.
42. Leslie C, Eskin E, Noble W S. 2002. The spectrum kernel: A string kernel for SVM protein classification. Pac Symp Biocomput 7: 564-575.
43. Leslie C, Eskin E, Cohen A, Weston J, Noble W S. 2004. Mismatch string kernels for discriminative protein classification. Bioinformatics 20: 467-476.
44. Leung G, Eisen M B. 2009. Identifying cis-regulatory sequences by word profile similarity. PLoS ONE 4: e6901. doi: 10.1371/journal.pone.0006901.
45. Lin, H.T., Lin, C.J. and Weng, R.C. 2003. A note on Platt's probabilistic outputs for support vector machines machine learning. Mach. Learn. 68: 267-276.
46. Maniatis T, Falvo J V, Kim T H, Kim T K, Lin C H, Parekh B S, Wathelet M G. 1998. Structure and function of the interferon-enhanceosome. Cold Spring Harb Symp Quant Biol 63: 609-620.
47. Mason S, Piper M, Gronostajski R M, Richards L J. 2008. Nuclear factor one transcription factors in CNS development. Mol Neurobiol 39: 10-23.
48. Matsuo I, Kuratani S, Kimura C, Takeda N, Aizawa S. 1995. Mouse Otx2 functions in the formation and patterning of rostral head. Genes Dev 9: 2646-2658.
49. Matys V, Fricke E, Geffers R, Gossling E, Haubrock M, Hehl R, Hornischer K, Karas D, Kel A E, Kel-Margoulis O V, et al. 2003. TRANSFAC(R): Transcriptional regulation, from patterns to profiles. Nucleic Acids Res 31: 374-378.
50. McGaughey D M, Vinton R M, Huynh J, Al-Saif A, Beer M A, McCallion A S. 2008. Metrics of sequence constraint overlook regulatory sequences in an exhaustive analysis at phox2b. Genome Res 18: 252-260.
51. Megraw M, Pereira F, Jensen S T, Ohler U, Hatzigeorgiou A G. 2009. A transcription factor affinity-based code for mammalian transcription initiation. Genome Res 19: 644-656.
52. Meinicke P, Tech M, Morgenstern B, Merkl R. 2004. Oligo kernels for datamining on biological sequences: A case study on prokaryotic translation initiation sites. BMC Bioinformatics 5: 169. doi: 10.1186/1471-2105-5-169.
53. Narlikar L, Sakabe N J, Blanski A A, Arimura F E, Westlund J M, Nobrega M A, Ovcharenko I. 2010. Genome-wide discovery of human heart enhancers. Genome Res 20: 381-392.
54. Newburger D E, Bulyk M L. 2009. UniPROBE: An online database of protein binding microarray data on protein-DNA interactions. Nucleic Acids Res 37: D77-D82.
54. Noonan J P, McCallion A S. 2010. Genomics of long-range regulatory elements Annu Rev Genomics Hum Genet 11: 1-23.
55. Patel, M., Simon, J., Iglesia, M., Wu, S. B., McFadden, A., Lieb, J. D. and Davis, I. J. 2012. Tumor-specific retargeting of an oncogenic transcription factor chimera results in dysregulation of chromatic and transcription. Genome Res 22: 259-270.
56. Pavesi G, Mauri G, Pesole G. 2001. An algorithm for finding signals of unknown length in DNA sequences. Bioinformatics 17 (Suppl 1): S207-S214.
57. Peckham H E, Thurman R E, Fu Y, Stamatoyannopoulos J A, Noble W S, Struhl K, Weng Z. 2007. Nucleosome positioning signals in genomic DNA. Genome Res 17: 1170-1177.
58. Pennacchio L A, Ahituv N, Moses A M, Prabhakar S, Nobrega M A, Shoukry M, Minovitsky S, Dubchak I, Holt A, Lewis K D, et al. 2006. In vivo enhancer analysis of human conserved noncoding sequences. Nature 444: 499-502.
59. Platt, J. C. 1999. Probablistic outputs for support vector machines and comparisons to regularized likelihood methods. In: Smola, A., Bartlett, P., Scholkopf, B. and Schuurmans, D. (eds). Advances in Large Margin Classifers. MIT Press, Cambridge, Mass.: 67-74.
60. Rätsch G, Sonnenburg S, Schölkopf B. 2005. RASE: Recognition of alternatively spliced exons in C. elegans. Bioinformatics 21 (Suppl 1): i369-i377.
61. Robertson G, Hirst M, Bainbridge M, Bilenky M, Zhao Y, Zeng T, Euskirchen G, Bernier B, Varhol R, Delaney A, et al. 2007. Genome-wide profiles of STAT1 DNA association using chromatin immunoprecipitation and massively parallel sequencing. Nat Methods 4: 651-657.
62. Ross S E, Greenberg M E, Stiles C D. 2003. Basic helix-loop-helix factors in cortical development. Neuron 39: 13-25.
63. Schölkopf B, Tsuda K, Vert J P. 2004. Kernel methods in computational biology. MIT Press, Cambridge, Mass.
64. Schultheiss S J. 2010. Kernel-based identification of regulatory modules. In Computational biology of transcription factor binding (ed. Ladunga I.), Vol. 674, pp. 213-223. Humana Press, Totowa, N.J.
65. Schultheiss S J, Busch W, Lohmann J U, Kohlbacher O, Rätsch G. 2009. KIRMES: Kernel-based identification of regulatory modules in euchromatic sequences. Bioinformatics 25: 2126-2133.
66. Siepel A, Bejerano G, Pedersen J S, Hinrichs A S, Hou M, Rosenbloom K, Clawson H, Spieth J, Hillier L W, Richards S, et al. 2005. Evolutionarily conserved elements in vertebrate, insect, worm, and yeast genomes. Genome Res 15: 1034-1050.
67. Sonnenburg S, Rätsch G, Schäfer C, Schölkopf B. 2006a. Large scale multiple kernel learning. J Mach Learn Res 7: 1531-1565.
68. Sonnenburg S, Zien A, Ratsch G. 2006b. ARTS: Accurate recognition of transcription starts in human. Bioinformatics 22: e472-e480.
69. Sonnenburg S, Schweikert G, Philips P, Behr J, Ratsch G. 2007. Accurate splice site prediction using support vector machines. BMC Bioinformatics 8: S7. doi: 10.1186/1471-2105-8-S10-S7.
68. Sonnenburg S, Zien A, Philips P, Ratsch G. 2008. POIMs: positional oligomer importance matrices-understanding support vector machine-based signal detectors. Bioinformatics 24: i6-i14.
69. Storey J D, Tibshirani R. 2003. Statistical significance for genomewide studies. Proc Natl Acad Sci 100: 9440-9445.
70. Su J, Teichmann S A, Down T A. 2010. Assessing computational methods of cis-regulatory module prediction. PLoS Comput Biol 6: e 1001020. doi: 10.1371/journal.pcbi.1001020.
71. Thanos D, Maniatis T. 1995. Virus induction of human IFN gene expression requires the assembly of an enhanceosome. Cell 83: 1091-1100.
72. Vandewalle C, Roy F, Berx G. 2008. The role of the ZEB family of transcription factors in development and disease. Cell Mol Life Sci 66: 773-787.
73. Vapnik V N. 1995. The nature of statistical learning theory. Springer, New York.
74. Visel A, Prabhakar S, Akiyama J A, Shoukry M, Lewis K D, Holt A, Plajzer-Frick I, Afzal V, Rubin E M, Pennacchio L A. 2008. Ultraconservation identifies a small subset of extremely constrained developmental enhancers. Nat Genet 40: 158-160.
75. Visel A, Blow M J, Zhang T, Akiyama J A, Holt A, Plajzer-Frick I, Shoukry M, Wright C, Chen F, Afzal V, et al. 2009. ChIP-seq accurately predicts tissue-specific activity of enhancers. Nature 457: 854-858.
76. Wigle J T, Eisenstat D D. 2008. Homeobox genes in vertebrate forebrain development and disease. Clin Genet 73: 212-226.
77. Wilson M, Koopman P. 2002. Matching SOX: Partner proteins and cofactors of the SOX family of transcriptional regulators. Curr Opin Genet Dev 12: 441-446.
78. Wilson M D, Barbosa-Morais N L, Schmidt D, Conboy C M, Vanes L, Tybulewicz V L J, Fisher E M C, Tavare S, Odom D T. 2008. Species-specific transcription in mice carrying human chromosome 21. Science 322: 434-438.
79. Woolfe A, Goodson M, Goode D K, Snell P, McEwen G K, Vavouri T, Smith S F, North P, Callaway H, Kelly K, et al. 2004. Highly conserved noncoding sequences are associated with vertebrate development. PLoS Biol 3: e7. doi: 10.1371/journal.pbio.0.0030007.
80. Zerucha T, Stühmer T, Hatch G, Park B K, Long Q, Yu G, Gambarotta A, Schultz J R, Rubenstein J L R, Ekker M. 2000. A highly conserved enhancer in the Dlx5/Dlx6 intergenic region is the site of cross-regulatory interactions between Dlx genes in the embryonic forebrain. J Neurosci 20: 709-721.
81. Fletz-Brant, Christopher, et al., kmer-SVM: a web server for identifying predictive regulatory sequence features in genomic data sets, Nucleic Acids Res. 2013, Vol. 41, doe: 10.1093/nar/gkt519.
82. Gorkin, et al., Genome Res. 2012, 22:2290-2301, Integration of ChIP-eq and machine learning reveals enhancers and a predictive regulatory sequence vocabulary in melanocytes.
83. Ghandi, et al., Robust k-mer frequency estimation using gapped k-mers, J. Math. Biol. DO! 10.1007/s00285-013-0705-3.

### EXAMPLES

### Example 1

### Methods Data Sets

As positive data sets, initially the genome-wide in vivo EP300 binding sites identified by ChIP-seq (Visel et al. 2009) were used, composed of three different sets of tissue-specific enhancers (forebrain, midbrain, and limb) of embryonic day 11.5 mouse embryos. There were 2453, 561, and 2105 sites reported, respectively, and the entire sequences were directly used without modification. Two other data sets were analyzed (Chen et al. 2008; Kim et al. 2010). Chen et al. reported 524 EP300 binding sites in mouse embryonic stem cells, and Kim et al. reported ˜12,000 neural activity-dependent CREBBP binding sites in stimulated cultured mouse cortical neurons. Since both CREBBP data sets report only peaks of the ChIP-seq signals, to obtain sequences for further analysis, an extension of 100 bp (FIG. 3G) or 400 bp (FIG. 3H) in both directions from these peaks was made.

Negative sequence sets were generated to match the distribution of sequence length and repeat element fraction of the corresponding positive sets (FIG. 11). Repeat fractions were calculated using the repeat masked sequence data from the UCSC genome browser (Karolchik et al. 2008). random genomic sequences were selected from the mouse genome according to the following rejection sampling algorithm:
1. Sample a length l from the enhancer length distribution.
2. Sample a sequence of the length l, randomly from the genome.
3. Let x be the repeat fraction of the sampled sequence. Sample Y˜Bernoulli(α(x)lq(x)), where p(x) is the probability that x occurs in the enhancers, q(x) is the probability that x occurs in the genomic sequence, α is the constant so that the maximum of p(x)lq(x) equals 1.
4. Accept the sequence if Y=1; reject otherwise.
5. Repeat 1-4 until the desired number of sequences are sampled.

All positive and negative sequence data sets used for this analysis are available at http://www.beerlab.org/p300enhancer. The following negative set sizes were used—EP300 f b: n=4000, 2453 (1×), 122,650 (50×), 245,300 (100×); EP300 mb: n=4000, 561 (1×), 28,050 (50×), 56,100 (100×); EP3001b: n=4000, 2105 (1×), 105,250 (50×), 210,500 (100×); EP300 fb human: n=2192 (1×); EP300 ES: n=524 (1×), 5240 (10×), 26,200 (50×), 52,400 (100×); CREBBP neuron: n=11,847 (1×), 592,350 (50×), 1,184,700 (100×); ZNF263: n=1418 (1×), 70,900 (50×), 141,800 (100×).

### Support Vector Machine

An SVM (Boser et al. 1992; Vapnik 1995) finds a decision boundary that separates the positive and negative training data. This decision boundary is a hyperplane which maximizes the margin between the two sets in the feature vector space. Used were N labeled vectors, (xᵢ,γᵢ)), i=1, . . . , N, where xⱼεRⁿ and γᵢε{+1, −1} is the class label. For the linear case, the decision boundary is found by minimizing ∥w∥² such that γᵢ (xᵢ·w+b)≧1, i=1, . . . , N. In practice, the optimal solution was found by maximizing the dual form: Σᵢ₌₁^{N}αᵢ−½Σᵢ₌₁^{N}Σⱼ₌₁^{N}γᵢ αᵢ γᵢ αᵢ (xᵢ·xⱼ) over αⱼ with the constraints, αᵢ≧0, and Σᵢ₌₁^{N} αᵢγᵢ=0 (Joachims 1999; Sonnenburg et al. 2006a). The SVM weight vector w was constructed from the αᵢ, using w=σΣᵢ₌₁^{N}γᵢαⱼxᵢ. The SVM discriminant function, or “SVM score,” fₛᵥₘ(x)=w·x+b=Σᵢ₌₁^{N}γᵢαᵢ(xᵢ·x)+b, represented the distance of any vector x from the decision boundary, and determines the predicted label of the vector x.

The inner product (xᵢ·xⱼ) was a measure of the similarity of any two data points i and j in the feature space. The generality of the SVM arose from the fact that this term may be replaced by a more general measure of similarity, a kernel function K(xᵢ, xⱼ). Different kernels refer to different methods of measuring similarity. A general measure of sequence similarity is the k-spectrum kernel (Leslie et al. 2002), which describes the similarity of k-mer frequencies of two sequences. This kernel produced the best results in the present method, was easy to interpret, and can easily represent a combination of TF binding sites. To implement the k-spectrum kernel, a k-mer count vector was generated for the full set of distinct k-mers for each sequence. Then the count vector was normalized so that ∥x∥=1 to reduce the effect of the variable length of different enhancers. This normed vector is referred to as the “k-mer frequency vector.” The kernel function was then the inner product between two normalized frequency vectors. To reflect the fact that TFs bind double stranded DNA, the spectrum kernel function was slightly modified to account for both orientations. Instead of counting only an exact k-mer, its reverse complement was also counted, and then redundant k-mers were removed. For example, only one of AATGCT and AGCATT appears on the list of distinct k-mers. For 6-mers, there are 2080 distinct features after removing reverse complements; for 7-mers, there are 8192. This modification was applied to all kernel functions. The only difference between the k-spectrum kernel and the (k,m)-mismatch kernel is that the mismatch kernel allowed m mismatches when counting k-mers (Leslie et al. 2004), reflecting the fact that some TFs bind degenerate sites. The Gaussian kernel used the same feature vectors as the k-spectrum kernel but used a nonlinear similarity measure via the kernel function K(xᵢ, xⱼ)=exp(−∥xᵢ−xⱼ∥²/2σ²). The method utilizes the Shogun machine learning toolbox (Sonnenburg et al. 2006a) and SVM light (Joachims 1999).

### Example 2

### Details of Auxiliary Modules

### Score Sequences of Interest

Once the SVM is trained, in addition to classifying the CV test sets, a trained SVM can be used to score any sequence of interest. Although the rank of the SVM scores is significant, the scale of the SVM scores is generally not. Therefore, this SVM score may converted into a probability that the element is positive, by reporting the posterior probability that each sequence is in the positive class, using the algorithm described in (45,59). For example, input may be a set of sequences in FASTA format and the outputs were the SVM score and posterior probability. Parameters to produce this posterior probability may be included in the weight table output of the trained SVM. Genome-wide predictions may also be made using the SVM methods disclosed herein by splitting a genome into chunks of a length c by that overlap each other by v bp. The results may then be used as input for determining sequences of interest.

### Sequence Profiles

As discussed earlier in the text, the sequence profiles, or distributions of length, GC content and repeat fraction content in the positive and negative sequences were matched. It may be useful to compare the sequence profiles of other sets of genomic intervals by calculating and reporings the sequence profile of the regions specified by these coordinates.

### Kmer to MEME

This step takes the output file of weights created by training a kmer-SVM and generates PWMs for kmers with the largest and smallest (most positive and most negative) weights. The user specifies how many kmers to be returned, with a maximum of 50. The output of this program is a MEME-formatted list of PWMs.

### Tomtom

To enable a user to visualize the kmers identified as predictive by kmer-SVM, a local instance of the Tomtom (15) program was implemented. Briefly, Tomtom searches databases of TF motifs for matches with input motifs by using column-wise similarity measures between PWMs. Users can create PWMs by converting Kmer output to MEME and using this as input for Tomtom. For measures of similarity, the Euclidean distance may be used, which can be thought of as the length of the straight line between two PWMs, the Pearson correlation coefficient, which measures the similarity between two PWMs, and the Sandelin-Wasserman function, which sums the column-wise differences between PWMs. Also the choice of E-value or q-value as scoring criteria may be used. The E-value controls the expected number of false positives and can be any number, whereas the q-value controls the false discovery rate and is a number between 0 and 1. Running Tomtom in the default configuration of the Pearson correlation coefficient as distance metric and the q-value as criteria is an optional step of disclosed methods.

### Example 3

Regulatory control of gene expression in epidermal melanocytes, the pigment-producing cells that generate skin and hair color, was investigated. These cells also play a central role in several pathological phenotypes, including melanoma, albinism, and vitiligo (for review, see Lin and Fisher 2007). These qualities, along with extensive knowledge about the key TFs and developmental origins of melanocytes (Silver et al. 2006; Hou and Pavan 2008; Thomas and Erickson 2008), make this lineage an attractive model system for the study of enhancers. ChIP-seq for EP300 and H3K4me1 were employed to identify melanocyte enhancers genome-wide. A novel set of criteria was used that takes into account both EP300 and H3K4me1 to define a single set of putative enhancers, and validate these enhancers through a series of in silico, in vitro, and in vivo analyses. Having validated the identified enhancers, they were used as a training set for a machine learning algorithm, developing a comprehensive vocabulary of 6-mers predictive of melanocyte enhancer function with power to predict additional melanocyte enhancers in the mouse and human genomes. Our data established an extensive body of knowledge about regulatory control in melanocytes, which is relevant to phenotypic variation and disease. Moreover, a comprehensive approach was demonstrated that integrates ChIP-seq and machine learning to discover lineage-dependent enhancers and reveal the sequence vocabulary underlying their function.

### Results

### Previously Characterized Melanocyte Enhancers are Bound by EP300 and Flanked by H3K4Me1

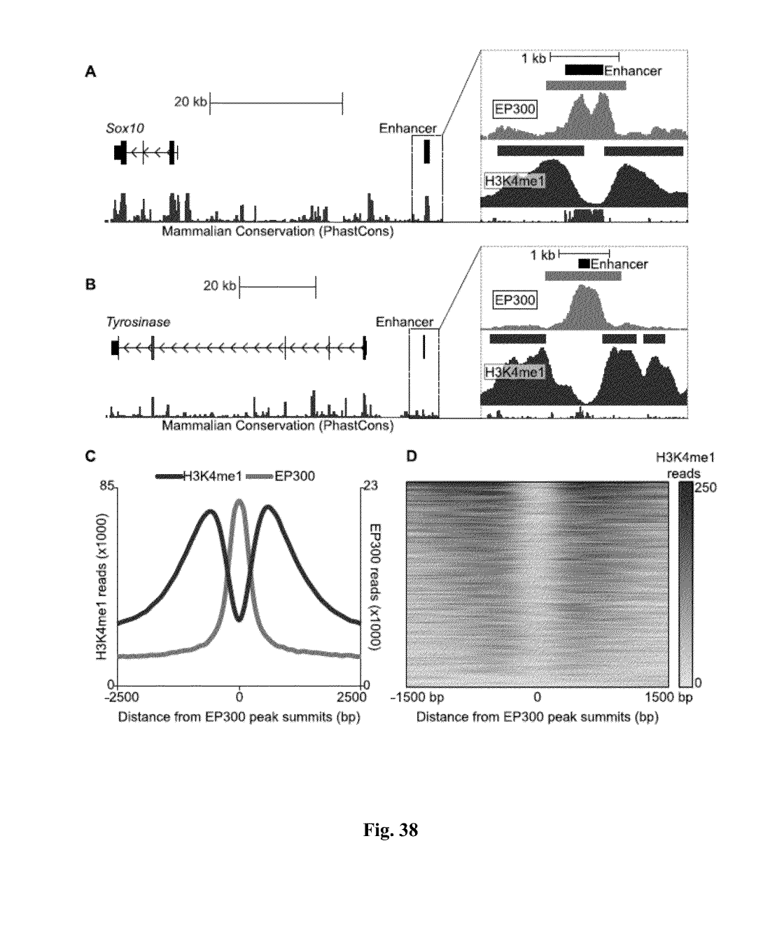

Sought to be identified was a large set of putative melanocyte enhancers from which a predicative sequence vocabulary could be derived. The enhancer identification was initiated by performing ChIP-seq for both EP300 and H3K4me1 in a line of immortalized melanocytes (melan-a) derived from Ink4a-Arf-null mice on a C57BL/6J back-ground (Bennett et al. 1987; Sviderskaya et al. 2002). 3622 and 59,965 ChIP-seq peaks for EP300 and H3K4me1 were identified, respectively. Expected was a priori that both EP300 and H3K4me1 would be enriched at melanocyte enhancers loci, based on similar findings in other cell types (Barski et al. 2007; Heintzman et al. 2009; Visel et al. 2009a; Wang et al. 2009). Consistent with these observations, the presence of enrichment for these factors at previously characterized melanocyte enhancers was confirmed (FIG. 38A,B; Table 4). More specifically, it was observed that a central EP300 peak overlaps these enhancers and that this peak is flanked on both sides by strong H3K4me1 enrichment. To further assess the relationship between EP300 and H3K4me1 in melanocytes, the distribution of H3K4me1 ChIP-seq reads relative EP300 peaks genome-wide were examined. It was found that H3K4me1 enrichment flanking EP300 peaks is a striking genome-wide trend (FIG. 38C, D), similar to observations made in other cell types (Heintzman et al. 2007, 2009; Ghisletti et al. 2010).

### A Specific EP300/H3K4Me1 ChIP-Seq Signature Identifies Melanocyte Enhancers Genome-Wide

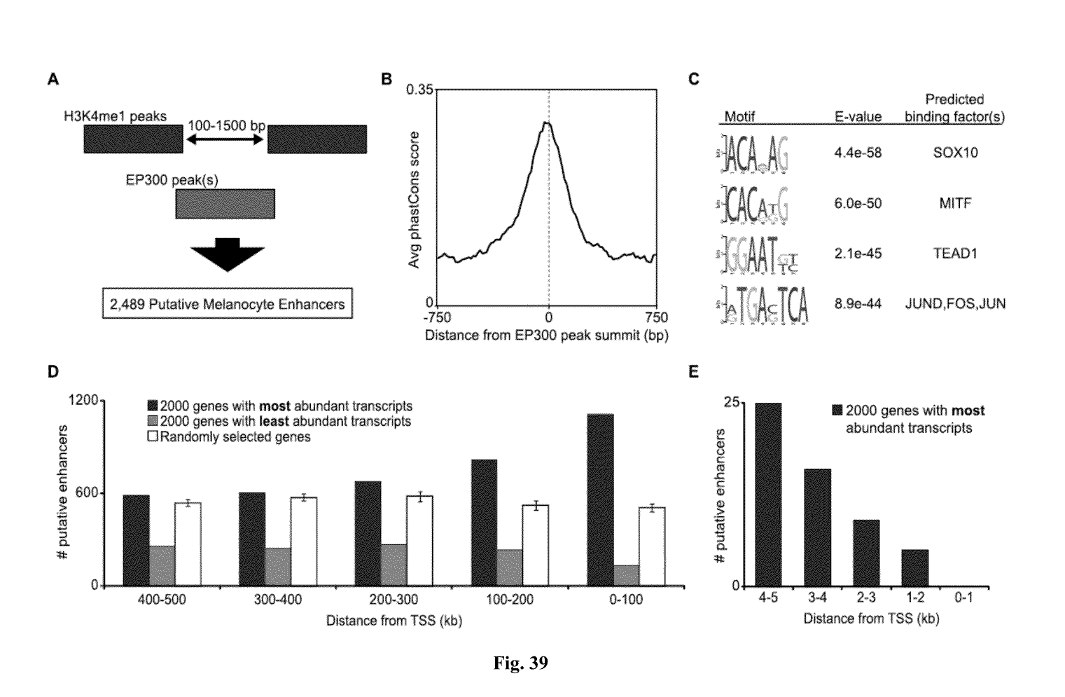

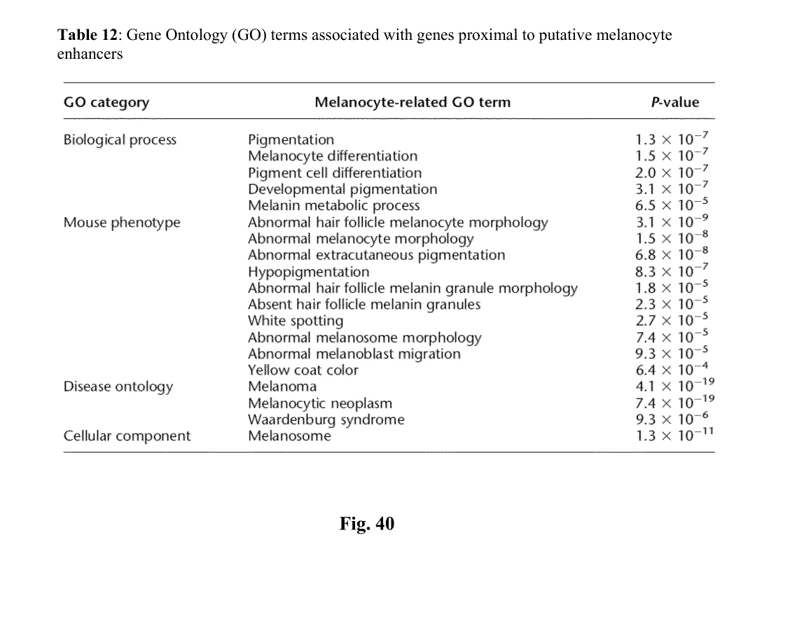

To identify a finite set of putative enhancers, a genome-wide search was performed for loci bearing the signature observed at previously characterized melanocyte enhancers, i.e., at which an EP300 peak is flanked by H3K4me1 enrichment. First, a set of H3K4me1-flanked regions at which adjacent H3K4me1 peaks are separated by between 100 and 1500 bp (n=21,189) were identified. This distance of 100-1500 bp was chosen based on the range of intervals between adjacent H3K4me1 peaks at known melanocyte enhancers (FIG. 10). Next, all EP300 peaks that overlap an H3K4me1-flanked region were identified. This approach, represented schematically in FIG. 39A, yields 2489 loci at which an EP300 peak falls in a region flanked by H3K4me1 peaks. Hereafter, these 2489 loci were referred to as “putative melanocyte enhancers” (Tables 7-10). These putative melanocyte enhancers included previously reported enhancers at Tyr and Sox10 (Murisier et al. 2007; Antonellis et al. 2008), as well as novel enhancers at a number of other genes central to melanocyte biology, including Mitf, Tyrp1, Kit, and Mc1r (FIG. 11). For downstream analysis, the summit of the EP300 peak were used as a surrogate for the center of a given enhancer, and where necessary, the boundaries of the EP300 peak were used as surrogates for the enhancer's boundaries.

Several additional lines of evidence supported the imputed function of these 2489 putative melanocyte enhancers. First, the putative melanocyte enhancers showed evolutionary sequence constraint (FIG. 39B), providing independent evidence of their functional significance. Second, these putative melanocyte enhancers were enriched for sequence motifs predicted to bind key melanocyte TFs, including SOX10 and MITF, as detected by DREME (FIG. 39C; Bailey 2011). Mutations in SOX10 and MITF in humans cause Waardenburg syndrome (WS), a pleiotropic neural crest disorder with characteristic pigmentary defects (SOX10 mutations cause WS type 2E OMIM:611584 and 4C OMIM:613266; MITF mutations cause WS type 2A OMIM:193510) (McKusick 1998; http://omim.org/), and both TFs are involved in the pathogenesis of melanoma (Cronin et al. 2009; Harris et al. 2010). Third, analysis with GREAT (McLean et al. 2010) reveals that genes proximal to the putative melanocyte enhancers (within; 50 kb; see GREAT methods) are significantly associated with Gene Ontology (GO) terms relevant to melanocyte biology, including melanoma, melanosome, pigmentation, and melanocyte differentiation (Table 1). Furthermore, using previously reported gene expression data for the melan-a line (Buac et al. 2009), it was found that putative melanocyte enhancers are enriched near the most highly expressed genes and depleted near genes that are not expressed at appreciable levels (39. 2D), reflecting the expected distribution of active melanocyte enhancers.

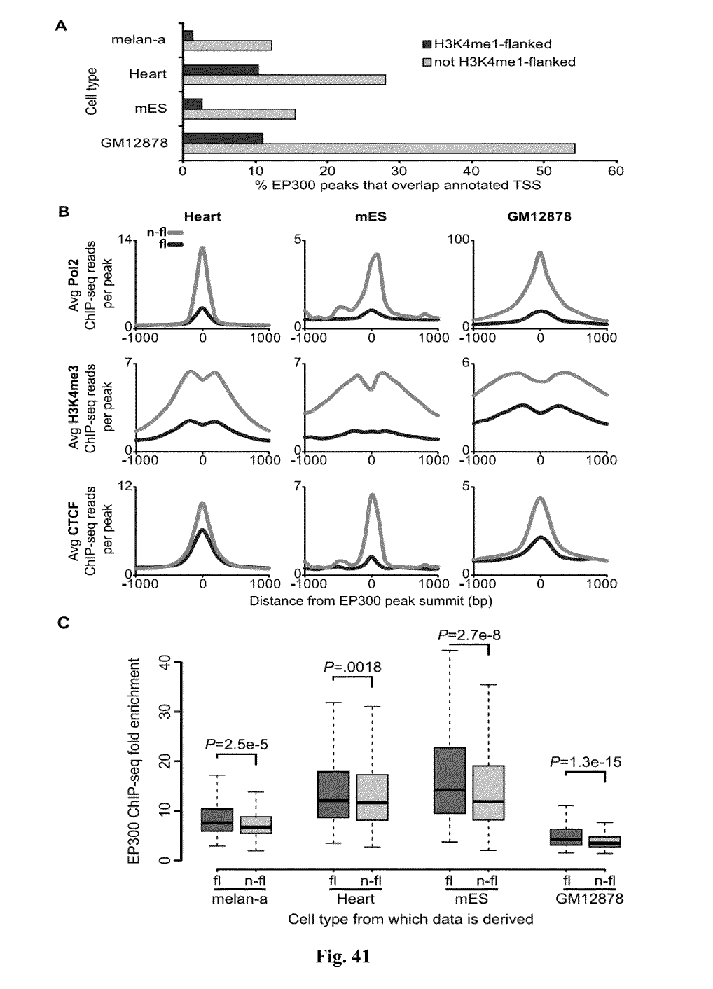

Although the 2489 putative melanocyte enhancers were enriched within 100 kb of highly expressed genes, they were not enriched in a 1-kb window immediately adjacent to the transcription start site (TSS) of these genes (39. 2E). This suggested that the enhancers identified were truly distal-acting and included very few, if any, proximal promoter elements. In contrast, EP300 peaks that were not flanked by H3K4me1 are far more likely to overlap annotated TSSs (FIG. 41A). This trend was also true for additional cell types in which data are available from the ENCODE and modENCODE Project consortia (The ENCODE Project Consortium 2007; The modENCODE Project Consortium 2009). Furthermore, in these cell types the non-H3K4me1-flanked EP300 peaks show markedly higher levels of ChIP-seq enrichment for RNA polymerase II and the promoter-associated modification H3K4me3 (FIG. 41B). Consistent with these observations, several melan-a EP300 peaks were noted at the promoters of melanocyte-related genes that have H3K4me1 enrichment on one side (upstream of the TSS) but are not flanked (FIG. 12). Somewhat surprisingly, EP300 peaks that were not flanked by H3K4me1 also showed higher levels of binding for CTCF in the ENCODE cell types examined (FIG. 41B). CTCF plays a central role in the function of insulator elements (Bell et al. 1999) and in physical organization of chromatin (Phillips and Corces 2009). In further comparing H3K4me1-flanked and non-H3K4me1-flanked EP300 peaks, it was found that H3K4me1-flanked peaks have higher levels of EP300 enrichment than non-H3K4me1-flanked peaks (P=2.5×10−5) (FIG. 41C).

Collectively, these data showed that the set of 2489 candidate loci was highly enriched for bona fide melanocyte enhancers. By selecting only those EP300 peaks that overlap H3K4me1-flanked regions, a set of putative melanocyte enhancers with stronger EP300 binding that includes fewer regions containing sequence features of nonenhancer regulatory elements such as promoters and insulators were obtained. Importantly, these characteristics of this approach are particularly well suited to the creation of a training set from which key sequence features of enhancers can be extracted. Furthermore, these results add to a growing body of evidence linking EP300 and H3K4me1 to enhancer function and suggest the existence of functionally distinct subsets of EP300 peaks that can be distinguished to some extent by proximal histone modifications. Identified melanocyte enhancers direct reporter expression in melanocytes in vitro and in vivo

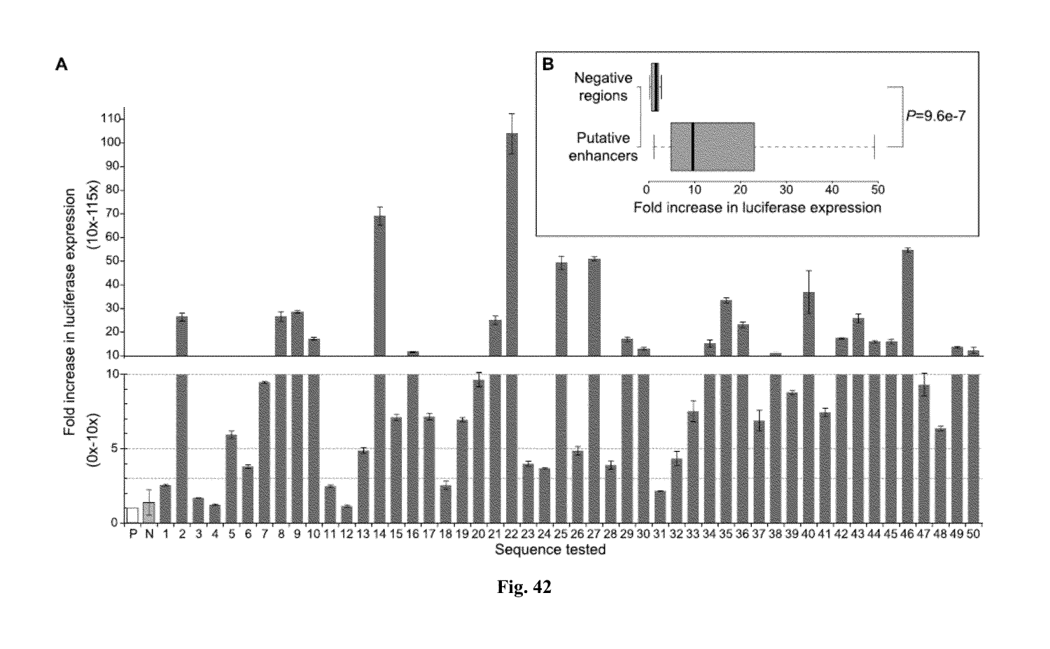

Given the evidence already supporting the role of the identified putative melanocyte enhancers in melanocyte regulatory control, next it was sought to validate their biological activity in reporter assays. To this end, 50 putative enhancers were first selected at random from the full set of 2489 and each was analyzed its ability to direct expression of a luciferase reporter gene in the melan-a line. It was found that 86% (43/50) of enhancers tested increased reporter expression greater than threefold relative to the minimal promoter alone (FIG. 42A; Table 5). Moreover, 72% (36/50) of enhancers tested increased reporter expression more than fivefold, and 48% (24/50) increased expression more than 10-fold relative to the minimal promoter alone. As there was considerable variation in the activity of melanocyte enhancers in this assay, an additional 10 regions were tested as negative controls. These regions were matched to the putative enhancers in average size and GC content but did not have significant EP300 or H3K4me1 ChIP-seq enrichment. None of these negative control regions increased reporter expression more than threefold relative to promoter alone (FIG. 13A). As expected, the difference in reporter expression between putative enhancers and negative control regions was highly significant (P=9.6×10−7 by two-tailed t-test) (FIG. 42B).

Three previously characterized melanocyte enhancers were also assayed for reference, which directed expression at levels 11-fold, 42-fold, and 51-fold higher than the minimal promoter alone, respectively (FIG. 13B). However, it should be noted that these three enhancers are not directly comparable to these test sequences because the critical regions of these enhancers have been refined in previous studies. In this assay, a given enhancer will show highest activity when the amplified region contains the motifs critical for enhancer function with as little additional sequence as possible.

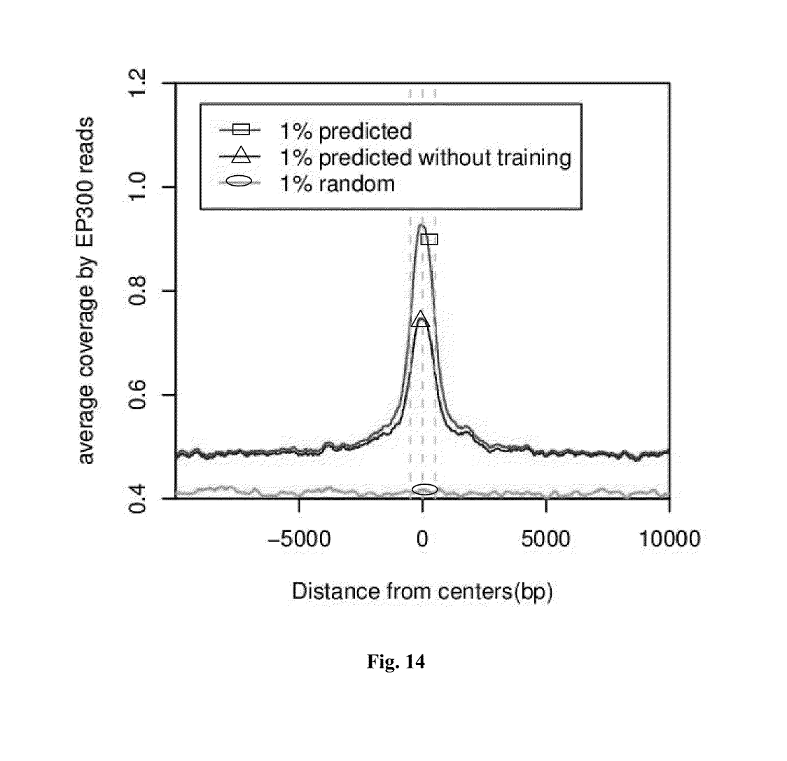

To further validate the biological activity of the putative enhancers, the ability of a subset (n=10) to appropriately direct melanocyte expression of a GFP reporter in vivo in transgenic zebrafish was tested. An established pipeline was used for analyzing putative enhancers n zebrafish (Fisher et al. 2006a, b; McGaughey et al. 2008; Prasad et al. 2011), which has previously been used to analyze melanocyte regulatory elements at Sox10 (Antonellis et al. 2008) and GPNMB (Loftus et al. 2009). The 10 putative enhancers tested were chosen at random from the 50 analyzed in vitro as described above. It was found that 70% (7/10) of enhancers tested directed GFP expression in the melanocytes of mosaic transgenic zebrafish (Table 6). The observed reporter expression was consistent with what has been seen previously when assaying melanocyte enhancers (Loftus et al. 2009) and was highly specific to melanocytes (FIG. 14). Consistent expression was not observed in other tissues with any of the seven positive constructs, with two exceptions that result from inherent artifacts of the assay: (1) Background GFP expression in the yolk (into which the construct is injected at day 0) is always observed; and (2) expression in skeletal muscle is often observed, which is likely caused by a cryptic regulatory sequence in the backbone of the reporter construct that was not located. One melanocyte-negative construct (putative enhancer 25) did drive consistent expression in ganglia of the peripheral nervous system (PNS). Interestingly, the PNS and melanocytes both arise from the neural crest during embryonic development.

The results of these functional assays demonstrate that the majority of putative melanocyte enhancers can direct gene expression in melanocytes both in vitro and in vivo, providing strong additional evidence that the identified loci function as melanocyte enhancers.

Machine Learning Reveals Sequence Features that Underlie Melanocyte Enhancer Function

To more thoroughly investigate the sequence composition of melanocyte enhancers, the putative enhancers identified by ChIP-seq were used as a training set for a supervised machine learning algorithm based on the statistical framework of a SVM (Lee et al. 2011). This approach as applied to embryonic mouse enhancers from other tissues is presented in detail by Lee et al. (2011). Briefly, the SVM finds an optimal decision boundary to distinguish the set of enhancers from random genomic regions using sequences of length k (k-mers) as features. Here, the putative melanocyte enhancers were used as positive sequences, a 50× larger set of random genomic regions as negative sequences, and the full set of 2080 distinct 6-mers as features. It was previously found that 6-mers and 7-mers are more informative in these analyses than are k-mers of other lengths, and 6-mers are preferred for robustness and ease of interpretation (Lee et al. 2011). SVM training assigned a weight, w, to each feature (6-mer), which determined its relative contribution to the decision boundary. The SVM discriminatory function, fSVM(x)=wx+b, represented the distance of a sequence x from the decision boundary and determined the predicted class, enhancer or nonenhancer, of the sequence x. This approach, which is called the kmer-SVM classifier, has three major advantages: (1) It identifies the specific sequences recognized by TFs active in melanocytes and provides independent support for these putative melanocyte enhancers based on previously known biology; (2) it allows the identification of additional melanocyte enhancers outside the original set of 2489 putative enhancers; and (3) it allows an indirect assessment of the quality of these putative enhancer set based on its sequence properties.

After training, the kmer-SVM classifier was assessed by its ability to accurately predict the class of reserved test sets via five-fold cross validation, as shown by the area under (au) the receiver operating characteristic curve (ROC) and precision-recall curves (PRCs). The kmer-SVM trained on putative melanocyte enhancers achieved auROC of 0.912 and auPRC of 0.297, providing independent verification of the quality of the experimental enhancer identification.

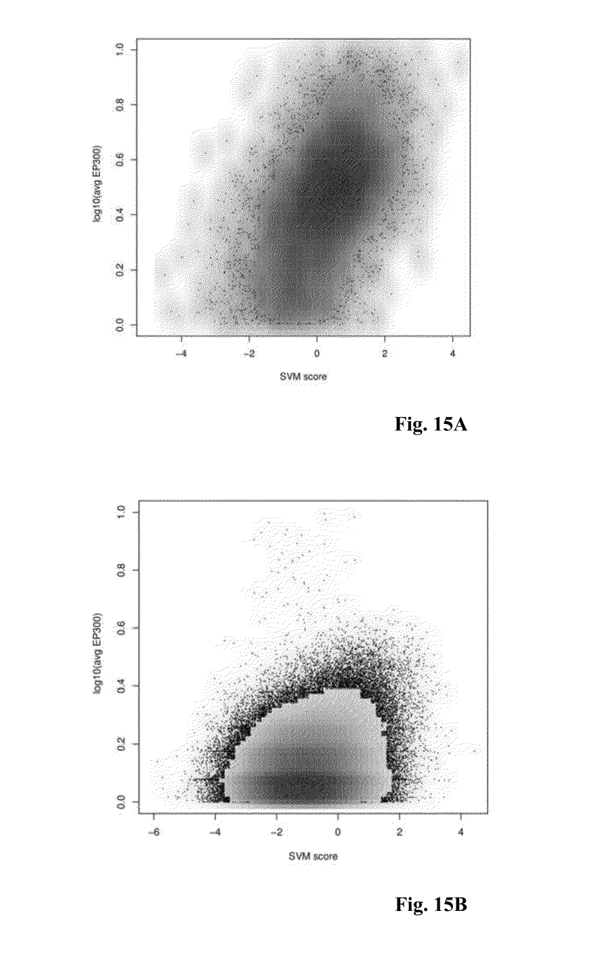

A feature of the kmer-SVM was that it produced a list of features, in this case all unique 6-mers (n=2080) and the corresponding weight assigned to each feature by the SVM. The SVM weight represents the relative contribution of a given 6-mer to the overall predictive power of the classifier. Collectively, the list of weighted 6-mers provides a sequence vocabulary that is useful in interpreting the primary sequence of melanocyte enhancers. Importantly, the most predictive 6-mers (i.e., those assigned the largest SVM weights) correspond to binding sites for TFs known to be directly involved in melanocyte biology, including MITF, SOX10, and FOS/JUN (FIG. 15). These 6-mers, and the 6-mer predicted to bind TEAD1, are in agreement with motifs found by DREME to be enriched in the training set (see FIG. 39C). It is also notable that one of the top ti-mers (ranked fourth) is predicted to bind PAX3, a key regulator of melanocyte differentiation (Lang et al. 2005) which can cause Waardenburg syndrome type 1 and type 3 when mutated (OMIM:193500 and OMIM:148820, respectively). In addition, CREB1, SOX5, and RUNX-family TFs (predicted to bind 6-mers ranked fifth, eighth, and ninth, respectively) have been shown to play roles in regulating gene expression in melanocytes (Tada et al. 2002; Raveh et al. 2005; Saha et al. 2006; Kingo et al. 2008; Stolt et al. 2008; Kanaykina et al. 2010; Mizutani et al. 2010).

### Sequenced-Based Predictions Identify Additional Enhancers in the Mouse and Human Genomes

Having trained the kmer-SVM classifier, it was next sought to determine whether it could be used to predict additional melanocyte enhancers genome-wide from primary sequence alone. Though these computational predictions are not likely to be as accurate as ChIP-seq, demonstrating that the kmer-SVM can predict bona fide enhancers is a powerful validation of the sequence vocabulary of weighted 6-mers on which the predictions are based. Furthermore, the ability to make enhancer predictions from sequence is particularly useful in genomes for which ChIP-seq data are not readily available. To make enhancer predictions genome-wide, first the mouse genome was segmented into 400-bp regions with 300 bp overlap and scored all regions with the kmer-SVM. The top 10,000 regions were chosen for further analysis, corresponding to an SVM cut-off score of 1.0 and yielding a precision of 0.74 and recall of 0.05 estimated from the PR curve. Any predicted regions overlapping the original training set were then eliminated (508 regions overlapping 348 enhancers from the original training set) and any overlapping regions were merged. None of the six previously characterized melanocyte enhancers in Table 4 overlap a kmer-SVM prediction, though it should be noted that four are included in the training set as they were bound by EP300 and flanked by H3K4me1 (Tyr DRE-15 kb, Sox10 MCS4, Sox10 MCS5, Sox10 MCS9).

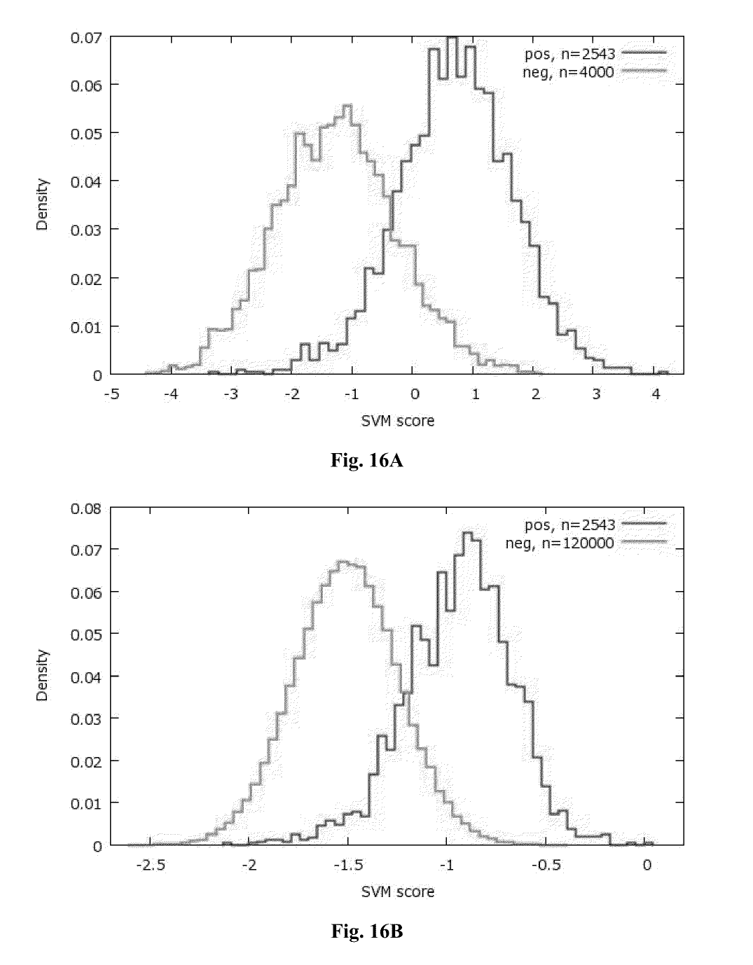

Ultimately, a set of 7361 predicted melanocyte enhancers (Table 11) were obtained. These predicted enhancers showed strong sequence constraint (FIG. 7A), albeit to a lesser extent than the original set of putative enhancers. In addition, the predicted enhancers also showed an EP300 and H3K4me1 ChIP-seq signature reminiscent of the original enhancer set (FIG. 7B). This suggests that the kmer-SVM predictions shared underlying biology with the original set of 2489 putative enhancers, though the ChIP-seq signal at these loci was much lower than at regions detected by peak calling (FIG. 16). Further analyzed was the ability of a subset of the kmer-SVM-predicted enhancers to direct expression of a luciferase reporter in vitro in melanocytes (n=11). It was found that majority of enhancers tested direct luciferase expression in vitro more than threefold higher than the minimal promoter alone (8/11; 73%), and several drove expression more than fivefold (6/11; 55%) and 10-fold higher (3/11; 27%) (FIG. 7C). Also tested was the enhancer activity of three predicted enhancers in vivo using the same assay described above for ChIP-identified enhancers, and it was found that two of the three sequences assayed directed expression of GFP in the melanocytes of transgenic zebrafish (Table 6). GFP expression was mostly specific to melanocytes, though one predicted enhancer (no. 1) also directed expression in the CNS and otic vesicle. It should be noted that the predicted enhancers assayed here were chosen from among the predictions with the highest SVM scores rather than at random.

To further demonstrate the power of this approach, genome-wide enhancer predictions in the human genome were made in the same way as described above for mouse. 7788 predicted melanocyte enhancers in the human genome were identified. Like the mouse predictions, the human predictions show strong sequence constraint (FIG. 7D), even though conservation was not taken into account when making predictions. The predicted human enhancers display elevated levels of DNase I hypersensitivity (HS) in human primary melanocytes (data generated by The ENCODE Project Consortium) (FIG. 7E), which is a feature of active enhancers (Song and Crawford 2010; Song et al. 2011). Moreover, the degree of overlap between the kmer-SVM predictions and DNase I HS peaks was markedly higher in primary melanocytes and melanoma cell lines than in unrelated cell types (FIG. 7F), suggesting that the activity of the predicted enhancers is largely specific to the melanocyte lineage.

The ability of the kmer-SVM classifier to make valid genome-wide predictions in the mouse and human genomes clearly demonstrates the high information content of the 6-mer vocabulary derived from the original training set. The kmer-SVM predictions also augment the catalog of putative melanocyte enhancers identified by adding an additional 7361 predicted enhancers in the mouse and 7788 in humans. Furthermore, the fact that a classifier trained on mouse sequences can make accurate predictions in the human genome clearly demonstrates the utility of this approach in identifying enhancers in genomes for which ChIP-seq data are not available, and provides direct proof of regulatory sequence vocabulary conserved between mouse and human.

### Discussion

In this study, an approach to the investigation of regulatory sequences that integrates ChIP-based enhancer discovery with computational interrogation of sequence composition was demonstrated. The comprehensive nature of this approach represents a significant step forward in the ability to decipher the sequence basis of regulatory control of gene expression. Importantly, this strategy can be applied to any cell type of interest for which ChIP-seq and functional validation are feasible. This study began by employing ChIP-seq for EP300 and H3K4me1 to discover a large set of previously unidentified putative melanocyte enhancers. In the melan-a ChIP-seq data, a striking relationship between EP300 and H3K4me1 was observed, similar to that observed in other cell types (The ENCODE Project Consortium 2007; Heintzman et al. 2007, 2009; Ghisletti et al. 2010). The bimodal pattern of H3K4me1 ChIP-seq signal around EP300 peaks likely reflects the tendency of enhancers to be nucleosome depleted (Boyle et al. 2008; Song et al. 2011), and thus the flanking H3K4me1 signal arises from positioned nucleosomes marked by H3K4me1 on either side of the enhancer. A similar phenomenon was elegantly demonstrated in the case of nucleosomes at androgen-responsive enhancers in pancreatic cancer cells by He et al. (2010).

Though other studies have employed ChIP-seq for EP300 alone to identify putative enhancers with notable success (Visel et al. 2009a; Blow et al. 2010), it was chosen to focus specifically on EP300 peaks flanked by H3K4me1 peaks as this approach minimized the inclusion of nonenhancer sequence features with the potential to obscure the sequence vocabulary underlying enhancer function. Though not the primary focus of this study, it was shown that there are significant differences between the subset of EP300 peaks that are flanked by H3K4me1 and those that are not and that these differences are consistent across unrelated cell types. These differences suggested that there is considerable value in using both EP300 and H3K4me1 data sets together for enhancer discovery, and that future studies to further unravel the relationship between EP300 and H3K4me1 are likely to yield important insights into enhancer biology.

The rates of functional validation observed (86% in vitro and 70% in vivo) were consistent with validation rates of ChIP-seq identified enhancers reported previously, though there is considerable variation between studies (Heintzman et al. 2009; Visel et al. 2009a; Blow et al. 2010; Ghisletti et al. 2010). There was general agreement in activity between the in vitro Putative enhancers direct reporter expression in melanocytes of transgenic zebrafish embryos. Representative images for all seven enhancers positive in this assay showed GFP-positive melanocytes in transgenic (mosaic) embryos at 3 dpf after treatment with epinephrine. Six of seven elements showing activity in vivo also showed activity in vitro (threefold threshold). In addition, the enhancer with the strongest activity in vitro clearly had the strongest activity in vivo as well, as judged by the level of fluorescence in GFP-expressing melanocytes, the number of positive embryos observed, and the number of positive melanocytes per positive embryo. However, putative enhancer 3 drove melanocyte expression in vivo even though its enhancer activity was not significant in vitro, and conversely, three enhancers that drove expression in vitro did not drive expression in vivo in mosaic transgenic zebrafish (nos. 20, 25, and 30). These discrepancies between the results of the in vitro and in vivo functional assays used here could be the result of differences among the model organisms (mouse and zebrafish, respectively), the minimal promoters in the reporter constructs (E1B and FOS, respectively), or other limitations of the respective reporter assays. These results demonstrated the importance of using multiple complimentary assays to assess the function of putative enhancers.

The orientation of the amplicon tested relative to the minimal promoter had a dramatic impact on the enhancer activity of sequences assayed in vitro. This was not likely to reflect an orientation dependence of the enhancer in its native genomic context. Rather, it was likely an artifact of the placement of the sequence in the synthetic context of a reporter construct. The orientation effect likely arose from the fact that the distance between an enhancer and minimal promoter in a reporter construct can strongly influence its functional output. This distance effect can be observed with as little 50 bp separating the two components (Nolis et al. 2009) and can manifest as orientation-dependent activity when testing an amplicon in which the critical sequence components (TF binding sites) are skewed to one side. In such a case, a given amplicon will show higher activity in the orientation that places its critical components closest to the minimal promoter, and lower (in some cases even undetectable) activity in the orientation that places its critical components furthest from the minimal promoter. Indeed, the strongest putative enhancer (no. 22), which mediates an increase of >100-fold reporter expression in the “forward” orientation and drives strong melanocyte expression in vivo, does not drive detectable expression in vitro in the “reverse” orientation (Table 5).

The similarity between the motifs identified by DREME (FIG. 39C) and the 6-mers identified by the kmer-SVM classifier was strong evidence that these sequences are binding motifs for TFs that play significant roles in melanocyte biology. The identification of motifs predicted to bind SOX10 and MITF is consistent with the well-characterized roles for these TFs in the melanocyte line-age. JUN and FOS are major effectors of the MAP kinase signaling cascade, which is critical to the proliferation of melanocyte cells in culture (Swope et al. 1995). In addition, constitutive activation of the MAP kinase pathway is a hallmark of melanoma (Dutton-Regester and Hayward 2012). The enrichment for a motif predicted to bind members of the TEAD family may reflect an as yet unappreciated role for TEAD TFs in melanocytes. It does not appear that any TEAD family member has been previously shown to play a specific biological role in melanocytes. However, TEAD2 has been shown to bind an enhancer active in neural crest, the developmental precursor to melanocytes (Degenhardt et al. 2010). This binding causes an increase in the expression of Pax3, itself a TF that is predicted to bind one of the most highly weighted 6-mers.

Motifs predicted to bind other TFs involved in melanocyte biology could have escaped detection due to high variation in consensus sequence, low enrichment relative to negative control sequences, or inherent biases in the algorithms used here for motif detection. Additionally, the EP300/H3K4me1-based approach likely identified only a subset of enhancers active in melanocytes. This particular subset of enhancers may be more highly enriched for some TF binding sites than for others. Mechanistically distinct subsets of enhancers have been reported in other cell types (He et al. 2011a). Though beyond the scope of this study, ChIP-seq for additional factors and in additional melanocyte-related cellular substrates would likely help to distinguish potential differences between subsets of enhancers.

Taken collectively, the melanocyte enhancers and corresponding sequence vocabulary described here greatly enhance understanding of the regulation of gene expression in melanocytes. Furthermore, they were relevant to human phenotypes and disease risk caused by variation in regulatory sequences. To date, at least 18 distinct genome-wide association studies (GWAS) have identified 52 SNPs associated with melanocyte-related phenotypes, including skin color, hair color, freckling, tanning response, number of cutaneous nevi, melanoma risk, and vitiligo (Hindorff et al. 2011). Many of these associations are likely to reflect causative variants that impact regulatory sequences (Hindorff et al. 2009; Visel et al. 2009b). This study, and others like it, promises to aid the identification of causative variants underlying genome-wide associations, as well as the molecular mechanisms by which they act.

### Methods

ChIP-Seq

Melan-a cells were propagated according to guidelines from Sviderskaya et al. (2002). ChIP was performed according to the method previously described (Lee et al. 2006). Alternative lysis buffers to those in the referenced protocol were used as follows: lysis buffer 1 (5 mM PIPES, 85 mM KCl, 0.5% NP-40, and 1× Roche Complete, EDTA-free protease inhibitor), lysis buffer 2 (50 mM Tris-HCl, 10 mM EDTA, 1% SDS, and 1× Roche Complete, EDTA-free protease inhibitor), and lysis buffer 3 (16.7 mM Tris-HCl, 1.2 mM EDTA, 167 mM NaCl, 0.01% SDS, 1.1% Triton X-100, and 1× Roche Complete, EDTA-free protease inhibitor). Sonication was performed using a Bioruptor (Diagenode) with the following settings: high output; 30-sec disruption; 30-sec cooling; total sonication time of 35 min with addition of fresh ice and cold water to water bath every 10 min. Four micrograms of ab8895 (Abcam) and 10 mg of antibody sc-585 (Santa Cruz Biotechnology) were used for H3K4me1 and EP300 ChIP, respectively. IP wash conditions were adjusted from the protocol referenced above as follows: Each immunoprecipitation (IP) was washed twice with low-salt wash buffer (0.1% SDS, 1% Triton X-100, 2 mM EDTA, 20 mM Tris-HCl, 150 mM NaCl), twice with high-salt wash buffer (0.1% SDS, 1% Triton X-100, 2 mM EDTA, 20 mM Tris-HCl, 500 mM NaCl), and twice with LiCl wash buffer (0.25 M LiCl, 1% IGEPAL CA630, 1% deoxycholic acid [sodium salt], 1 mM EDTA, 10 mM Tris-HCl) and rinsed once with PBS (pH 7.4). At least two biological replicates were performed for each antibody, with each replicate consisting of a ChIP sample and an input (pre-IP) sample. Each replicate was performed with ˜1×108 melan-a cells. ChIP libraries were submitted to NIH Intramural Sequencing Center, and each was sequenced on one lane of an Illumina GA2 yielding >20 million reads per sample, with the exception that each EP300 ChIP library was sequenced on two lanes for increased coverage depth.

### Analysis of ChIP-Seq Data: Peak Calling

EP300 peaks were called using the Model-based Analysis for ChIP-seq (MACS) algorithm (Zhang et al. 2008). Peaks were called for each replicate independently, and only those that were called in both replicates (n=3622) were selected for further analysis. Co-ordinates reported are from Replicate 1. H3K4me1 peaks were called using cisGenome (Ji et al. 2008) because it tends to call separate peaks corresponding to each apex of the bimodal distribution of H3K4me1 signal flanking enhancers, whereas MACS tends to call the entire bimodal distribution as a single peak. The Two Sample Peak Calling option in cisGenome was used, which allows both replicates to be entered simultaneously to produce a single set of output files. Default settings were used for both peak callers, except that ‘half window size W’ was set to 4 for cisGenome.

### Distribution of ChIP-Seq Reads Relative to Features of Interest

The total number of sequencing reads covering each base in a window of indicated size (x-axis) around the summit/center of the set of genome regions of interest (ChIP-seq peaks/kmer-SVM pre-dictions) was calculated with a custom script. The total number of reads covering each base in the window was then smoothed in 100 bp bins, and is represented as ‘reads’ (y-axis) in FIG. 38C. For FIG. 41B and FIG. 16, a subsequent calculation was performed in which the total reads in each bin was divided by the number of genome regions in the set of interest, to facilitate comparison between sets of different sizes. This normalized measure is represented as “Avg reads per peak” (y-axis) in FIG. 41B and FIG. 16. The heatmap in FIG. 39D was generated with the heatmap tool in the Cistrome Analysis Pipeline (Liu et al. 2011) using a bed file of 3622 EP300 peaks (300-bp regions centered the peak summits), and a wig file of H3K4me1 ChIP enrichment generated by MACS as standard output from peak calling.

### ENCODE Data

ENCODE data in FIG. 41 was processed as described above for melan-a data. Much of the data handling for these analyses was performed with Galaxy (Giardine et al. 2005; Blankenberg et al. 2010; Goecks et al. 2010).

### In Silico Analysis of Putative Enhancers:

Average phastCons Score

Average phastCons score plots (FIG. 39B) were generated with the Conservation Plot tool as part of the Cistrome Analysis Pipeline using an interval file of H3K4me1-flanked EP300 peaks (300-bp intervals around peak summits) (FIG. 39B) or kmer-SVM predicted enhancers.

### Motif Analysis

DREME (Bailey 2011) was used to identify enriched motifs (FIG. 2C). Sequences of 2489 putative melanocyte enhancers (centered on the EP300 ChIP-seq peak summit and extending ±150 bp) were used as input. Default settings for motif size (mink=3, maxk=7) were used. Motifs were submitted to TOMTOM (Gupta et al. 2007) as part of the MEME Suite (Bailey et al. 2009) to predict binding factors corresponding to each enriched motif, and the top vertebrate TF match was reported unless otherwise indicated in text. In the case of MITF and PAX3 (FIG. 39C; FIG. 15), match was made based on high similarity to published binding specificities (Bentley et al. 1994; Chalepakis and Gruss 1995; Yasumoto et al. 1995), as there is no position weight matrix (PWM) for either of these TFs in the databases queried by TOMTOM (JASPER and UniProbe).

### GO Analysis

GREAT (McLean et al. 2010) was used to identify GO terms enriched among genes proximal to putative enhancers. The association rule was set as follows: proximal, 50 kb upstream and 50 kb downstream (any gene in this interval relative to input regions is included); plus distal, up to 500 kb (if no gene is present in the proximal interval, the closest gene in this distal interval is included). For details, see McLean et al. (2010).

### Distribution of Enhancers Relative to Genes Expressed at Different Levels in Melan-a

Previously published melan-a microarray data were used (Buac et al. 2009). For analyses in FIG. 39, only genes represented on the array with a corresponding TSS in RefSeq (n=17,957) were used. These genes were ranked by raw expression level in melan-a (probes averaged, mean of three replicates). Custom scripts were used to calculate the number of putative enhancers within 500 kb (in bins of 100 kb) (FIG. 39D) and 5 kb (in bins of 1 kb) (FIG. 39E) of TSSs of the top 2000 and bottom 2000 genes on the ranked list, as well as for five sets of 2000 genes selected randomly from this list.

### Luciferase Assays

All tested sequences (putative enhancers, negative regions, kmer-SVM predictions, and previously characterized enhancers) were PCR amplified from mouse genomic DNA (Promega, no. G309A) and TA-cloned with the pCR8/GW/TOPO TA Cloning kit (Life Technologies). The luciferase reporter construct contains the firefly luciferase gene downstream from a minimal E1B promoter (Anto-nellis et al. 2006). Test sequences were inserted into a gateway cloning site upstream of the promoter with a directional LR reaction (Gateway cloning from Life Technologies). All sequences were tested in both orientations, and data from the orientation with the highest expression were used for downstream analysis to give the most accurate representation of the potential of each sequence to drive expression in melanocytes. For negative control regions, a set of 2000 regions was generated in which the regions were matched to the putative enhancers in size, GC %, and repeat fraction, but with a read count below for EP300 and H3K4me1. Ten regions were selected at random from this set for functional testing. For all luciferase assays, melan-a cells were plated in 24-well format (40,000 cells/well) and transfected next day with 400 ng of luciferase re-porter and 8 ng of pCMV-RL Renilla expression vector (Promega) using 2 mL Lipofectamine 2000 per well (Life Technologies). Cell lysate was collected at 48 h post-transfection and assayed with the Dual-Luciferase Reporter Assay System (Promega) using a Tecan GENiosPro Microplate Reader (Tecan Group). Three biological replicates were performed for each construct.

### Zebrafish Transgenesis

All tested sequences were PCR amplified and TA-cloned as de-scribed above (see Luciferase Assays). The GFP reporter construct, described previously (Fisher et al. 2006b), contains a gateway re-combination cassette (Life Technologies) upstream of a minimal (FOS) promoter and EGFP. The reporter used here was modified slightly by insertion of an eye-specific regulatory element from the zebrafish crybb1 locus (chr10:45,529,501-45,530,122; Zv9) downstream from EGFP to facilitate screening for successful transgenesis independent of the test sequence. Zebrafish trans-genesis was performed as previously described (Fisher et al. 2006b). Briefly, each construct was injected into >150 wild-type (AB) embryos at the one- to two-cell stage with Tol2 transposase mRNA to facilitate efficient and random integration of the reporter construct (flanked by to 12 recombination arms) into the zebrafish genome. Embryos were screened for GFP expression at 3 d post-fertilization (dpf), a timepoint at which melanocytes are well developed and the embryos are most amenable to comprehensive screening. Embryos were also screened at 2, 4, and 5 dpf, albeit less thoroughly, and no significant differences in expression from 3 dpf were observed. At least 10 positive embryos were imaged at 3 dpf for each positive construct. For high-magnification fluorescent images of melanocytes, zebrafish were treated with epinephrine 5-10 min prior to imaging (4 mg/mL) in order to contract pigment granules toward the center of the cell and thus facilitate visualization of GFP at the periphery. For full-body lateral images embryos were raised in 1-phenyl 2-thiourea (PTU) from 24 hpf until imaging to inhibit melanin synthesis. All Images were taken on a Nikon AZ100 Multizoom microscope with NIS-elements software. All zebrafish work was performed under an approved protocol (FI10M369), reviewed by the Johns Hopkins Institutional Animal Care and Use Committee.

### Kmer-SVM Classifier

To generate a high-confidence training set, a new set of 400-bp regions was defined that maximizes the overall EP300 ChIP-seq signal within each of the 2489 putative melanocyte enhancers after re-moving any enhancers which were >70% repeats. Repeat masked sequence data (mm9) was used from the UCSC Genome Browser to calculate repeat fractions. For negative sequences, a 50× larger set of random genomic 400-bp sequences were found by matching GC and repeat fraction of the positive set. Additionally, any potential EP300-bound regions with Poisson test P-value <0.1 (10 ChIP-seq reads) were excluded. At each sampling step, a region from the positive set was randomly selected, the GC content and the repeat fraction were calculated, a genomic sequence that matched these properties was sampled, and sampling was repeated until obtained 50× sequences were obtained. Standard fivefold cross validation was performed to assess the performance of this kmer-SVM classifier. The quality of the classifier was measured by calculating the auROC, which plots the true positive rate vs. the false-positive rate of the predictions. The PRC is a more reliable measure of performance than the ROC when positive and negative sets are un-balanced, as in this case. Precision is the ratio of true positives to predicted positives, and recall is identical to the true positive rate in the ROC. The PRCs can be quantified by the auPRC, or average precision. TFs predicted to bind top 6-mers were determined as described above for DREME motifs (see Motif Analysis). Predictions for functional validation (n=11) were chosen from the top of a list of regions ranked by SVM score. These are not the top 11 ranked predictions overall however, because the list they were chosen from was generated by an earlier version of the classifier trained on a slightly different input set. In the final set of predictions, the 11 regions tested are ranked by SVM score as 13, 15, 1, 9, 2, 44, 21, 108, 24, 273, and 203, respectively.

### Example 4

### Prediction of Estrogen-Related-Receptor Beta Bound Regions in Mouse ES Cells

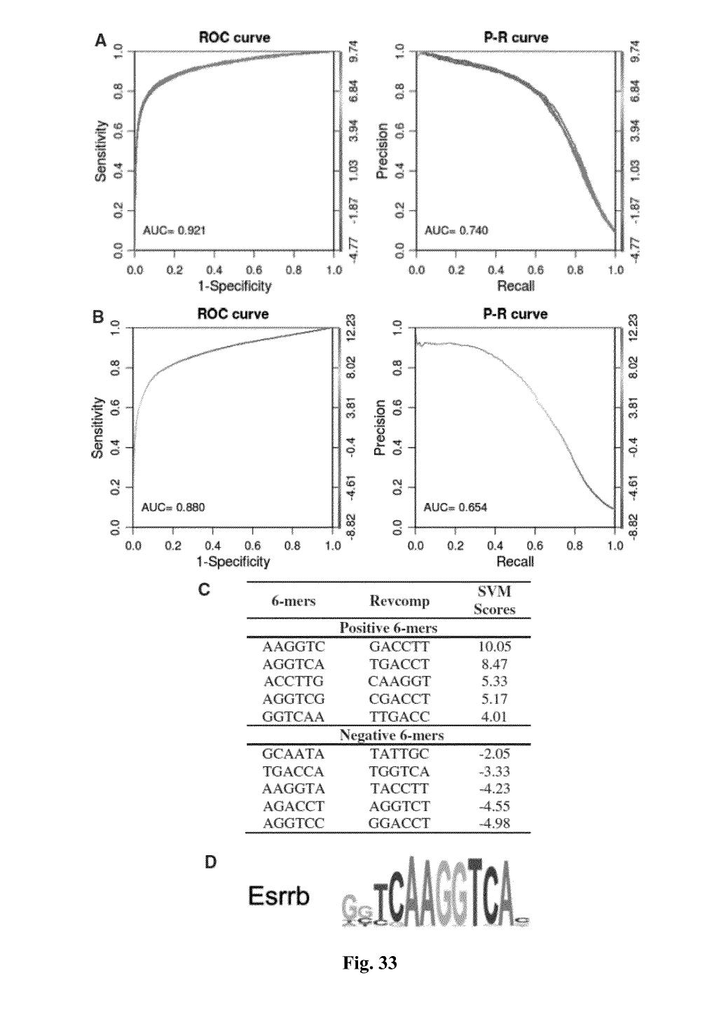

To take a specific example, the ChIP-seq data set of Chen et al. (2008), who identified binding loci of TFs in mouse embryonic stem (ES) cells was first considered. As an example, their ChIP-seq data was analyzed for estrogen-related-receptor beta (ESRRB) known to play a role in maintaining the pluripotency of ES cells. Because the ESRRB bound regions reported by Chen et al. (2008) were short (10-30 bp), we extended from the midpoint of these regions and used 100 bp elements as the positive sequence set. Following the workflow in FIG. 32, then a 10× negative set was used to train the SVM, then generated the ROC and PR curves for Chen's ESRRB data set as shown in FIG. 33A. These curves are typical of an accurate classifier, and summary statistics of AUROC=0.921 and AUPRC=0.74 for this data set were obtained. To directly compare the kmer-SVM prediction results with the PWM scores, the maximum log-odd score of the ESRRB PWM was calculated for each sequence and then plotted the ROC and PR curves as shown in FIG. 33B. Although the ESRRB PWM is regarded as an easy motif, its classification performance (AUROC=0.88 and AUPRC=0.654) is significantly lower than kmer-SVM.

The top five positive and negative kmers reported by ‘there trained SVM were shown in FIG. 33C. Also in FIG. 33C for comparison was the PWM for ESRRB found and reported in Chen et al. (2008). As expected, the top kmers span the core motif of the ESRRB-binding site, but interestingly, several SVM-predicted kmers contribute to the specificity of the ESRRB. For example, AAGGTC (first), AGGTCA (second), CAAGGT (third), AGGTC G (forth) and so forth have large positive weights, but A GGTCC and AGGTCT have large negative weights, showing that A or G is allowed in the binding site at the 11th position of the PWM, but that C and T are not. This subtlety is not reflected in the PWM found by Weeder, the motif discovery algorithm used in Chen et al. (2008).

### Prediction of Distinct Glucocorticoid Receptor Bound Regions in 3134 and AtT20 Cells

Next it was shown how a kmer-SVM can be applied to identify sequence features responsible for directing the binding of a single TF to different genomic locations in distinct tissues, developmental states or cell lines. As an example, John et al. (30) investigated the genomic binding of the Glucocorticoid Receptor (GR) TF in response to hormone stimulation in two divergent cell lines. Specifically, GR binding was profiled via ChIP-seq on a mouse mammary adenocarcinoma derived cell line (3134) and mouse pituitary (AtT20) cells. The binding of GR in these two cell lines were largely at non-overlapping genomic loci. John et al. (30) showed that the consensus GR-binding element (GRBE) was present in both 3134 and AtT20 bound regions, but that distinct sets of accessory sequence motifs were detected in the two cell lines, including binding sites for AP1, AML1, HNF3, TAL1 and NF1.

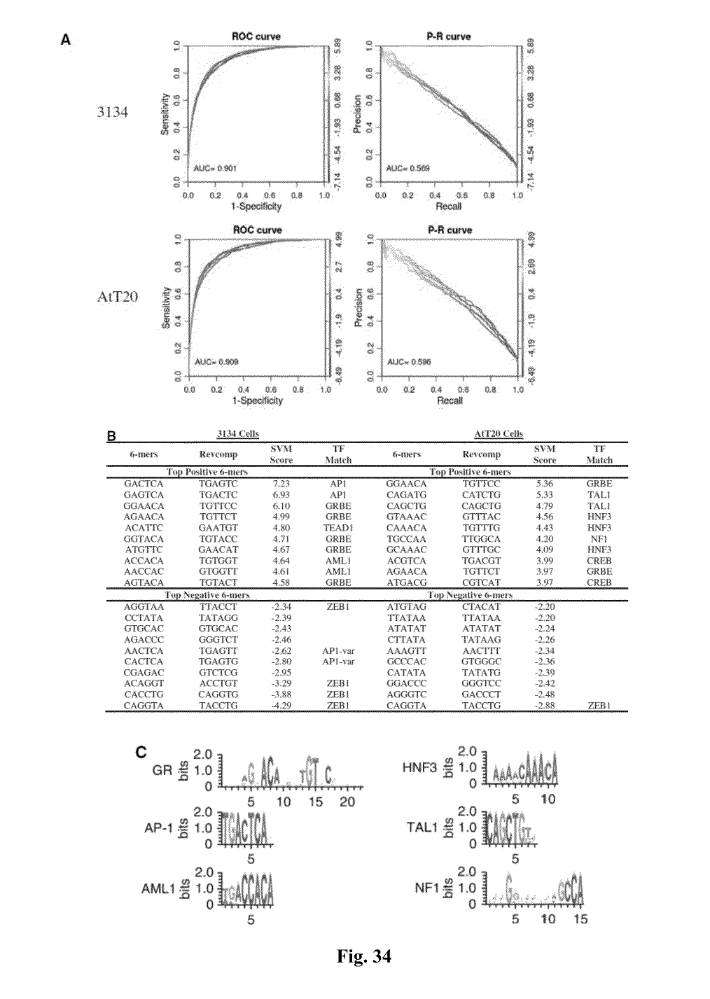

A method of the present invention was followed to train a kmer-SVM on the ChIP-seq GR bound loci in 3134 cells versus 10× random genomic sequence and separately on GR bound loci in AtT20 cells versus 10× random genomic sequence, using the coordinates in John et al. (30) as positive set input. This kmer-SVM classifier achieved an AUROC of 0.901 and AUPRC of 0.569 in 3134 cells, and AUROC of 0.909 and AUPRC of 0.596 in the AtT20 cell line (FIG. 34A), indicating that GR binding in both cell lines is predictable based on sequence. The top 10 positive and negative weight kmers for each cell line are shown in FIG. 34A, recovering kmers that span the GRBE and binding sites for accessory factors reported in John et al. (30). Although high scoring kmers matching the GRBE consensus were found in both cell lines, the accessory factors are specific to each cell line. In 3134 cells, the top two ranking kmers both match AP-1, and the eight and ninth highest kmers in 3134 cells matched AML1. The kmer-SVM also identified TEAD1 as the fifth most important kmer (ACATTC), a binding site not found in John et al. (30). In addition, four of the most negative kmers match the binding site for ZEB1 or Snail, a common negative sequence feature in the analysis, indicating that the absence of ACCT or AGGT is predictive for GR bound regions. Thus, it was hypothesized that either the presence of a ZEB 1-binding site would directly inhibit the binding of GR, presumably through the binding of ZEB1 or another factor that binds specifically to this site. In other cases, this binding site could otherwise disrupt the normal function of the enhancer elements and is thus required to be absent (3).

In the AtT20 cells, a separate set of accessory sites was found: the fourth, fifth and seventh most positive kmers match HNF3, whereas the second and third match TAL1. The sixth ranked kmer matched NF1. The eight and tenth ranked kmers match CREB, not reported in John et al. (30). In summary, this analysis uncovered most of the accessory factors described in John et al. (30), but also identifies novel positive and novel negative binding sites. Further, it is demonstrated that these features are predictive, in the sense that these features can be used to accurately classify the positive and negative regions, and were not simply over (or under) represented in one of the sets.

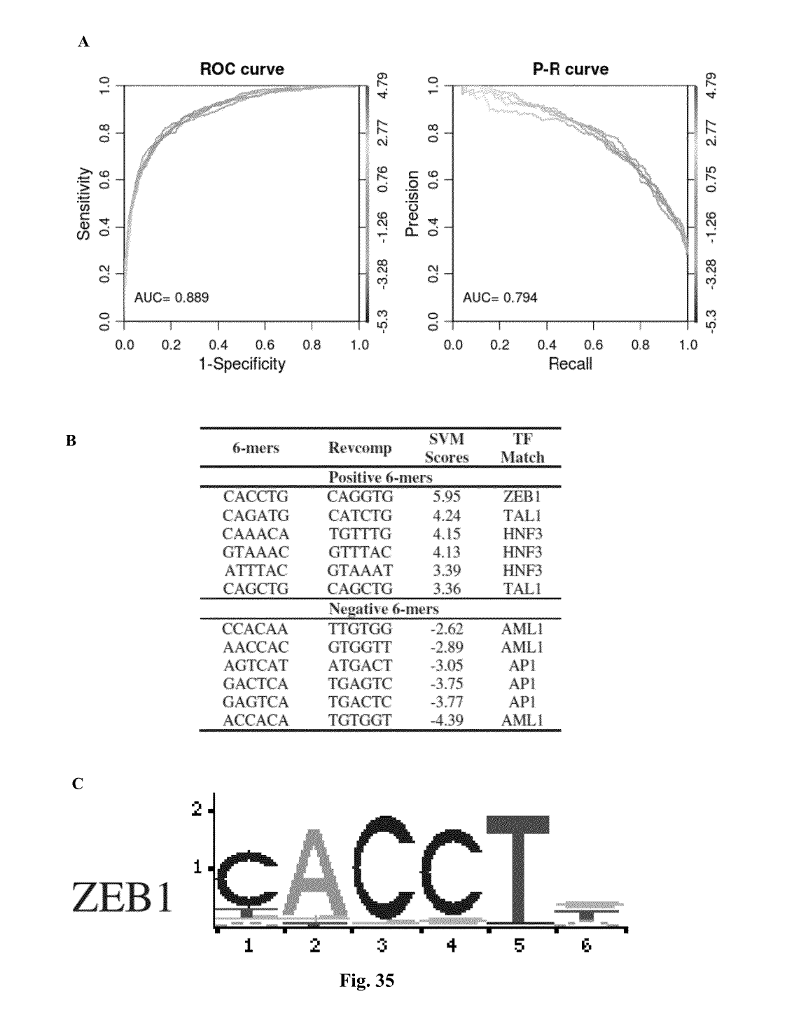

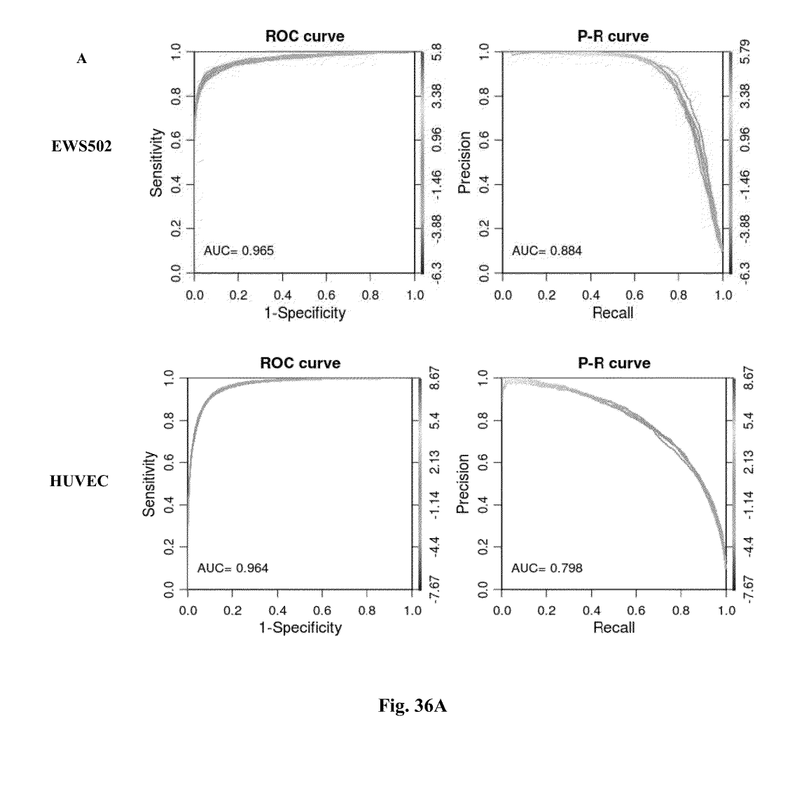

Next, it was demonstrated that the kmer-SVM is able to directly distinguish the GR bound regions in 3134 cells from the GR-bound regions in AtT20 cells from DNA sequence. In this case, random genomic sequence were not used as the negative set, but instead a kmer-SVM was trained using the AtT20 regions as the positive sequence set, and the 3134 regions as the negative sequence set. The ROC and PR curves are shown in FIG. 35A, yielding AUROC of 0.889 and AUPRC of 0.794. Thus, DNA sequence is sufficient to distinguish the cell specific binding of GR. Now, as both sets are bound by GR, the kmer weights shown in FIG. 35A do not include the GRBE, as it is present in both sets. The distinguishing features are now binding sites for the GR accessory factors. The kmer CAGGTG (ZEB1), which was negative for 3134 versus random is now the most positive kmer for AtT20 versus 3134. The other positive kmers match the AtT20-specific accessory factors TAL1 and HNF3. The negative weight kmers are the 3134 specific accessory factors AML1 and AP1. This demonstrates that these accessory sequence elements are predictive of the tissue-specific binding of GR because the sequence information in the accessory factor-binding sites is sufficient to distinguish GR binding in these two contexts. It is emphasized that this is a stronger statement than simply observing the enrichment of distinct sequence features in the two cases: A further hypothesis is proposed that these sequence features are sufficient to specify which GR-binding sites will be occupied in each tissue. This differential occupancy is determined by the presence of binding sites for accessory factors, which can be identified from the kmer weights.

### Example 5

### Prediction of Distinct EWS-FLI Bound Regions in EWS502 and HUVEC Cells

Although the previous example showed that binding of a sequence specific TF to different loci in different tissues was predictable from DNA sequence, now turn to an example where a wild-type and mutant TF were shown to bind distinct regions, and that this differential binding is also predictable from DNA sequence. Most Ewing-Sarcoma tumors harbor a mutation, which creates an oncogenic chimerical EWS-FLI TF by fusing the transactivation domain of EWS to the DNA-binding domain of FLI. Patel et al. (55) showed that this chimeric EWS-FLI TF targets different genomic regions in tumor cells and in non-tumor cells, and that additionally the wild-type protein FLI1 binds to largely the same regions as the fusion protein in non-tumor cells. Specifically, the authors assayed binding in the EWS502 cell line (derived from a Ewing Sarcoma tumor) and primary human endothelial cells (HUVEC). They reported a preferential binding for regions containing repeats of the tetranucleotide GGAA by EWS-FLI in both EWS502 and HUVEC cells (although the tumor cell line showed a greater enrichment). Additionally, binding of EWS-FLI in HUVEC cells was shown to be enriched in ETS, AP1 and GATA motifs, but that these accessory motifs were largely absent from the EWS-FLI bound regions in EWS502 cells.

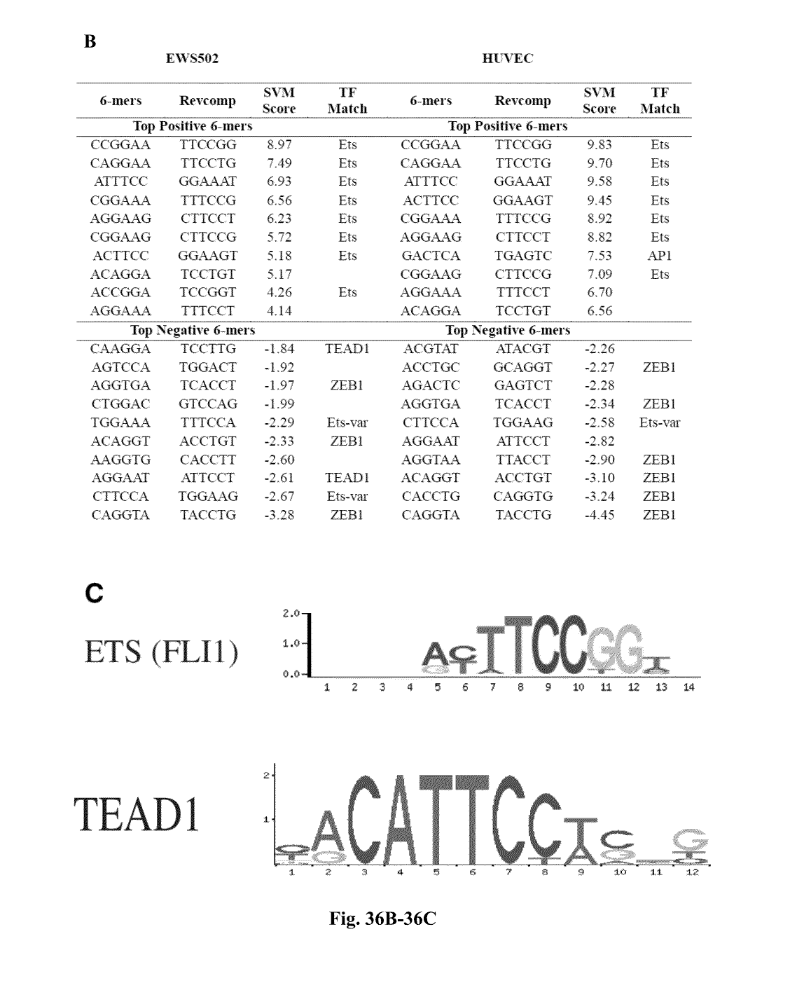

To analyze these data sets, used as positive sets were the ChIP-seq regions in Patel et al. (55) bound by EWS-FLI in EWS502 cells and HUVEC cells, and separate 10× negative sets were generated for each cell line. After training the kmer-SVM, in EWS502 cells, the AUROC was 0.965 and AUPRC was 0.884, and in HUVEC cells, the AUROC for this data set was 0.964 and AUPRC was 0.798 (FIG. 36A), again showing that the cell line specific binding of the EWS-FLI TF is predictable from primary DNA sequence features. In this case, the training data were optimized for length by the peak-calling algorithm ZINBA (28), which may account for the extremely high classification performance. Another possible factor is that the repeat fraction in these positive sets is relatively high.

Our method finds some motifs common to both cell lines. Positive sequence features reflect both the ETS motif recognized by FLI1 and the repetitive structure reported by Patel et al., with the ETS motif GGAA as part of the highest ranked kmers in both cell lines, as shown in FIG. 36B. Negative weight kmers are again found to be significant. Kmers that disrupt the repetitive GGAA structure (e.g. TGGAAG) score negatively in both cell lines, but more negatively in EWS502 cells. Notably, many of the most negative kmers for both cell lines contain AGGT, again emphasizing the importance of the absence of ZEB1 or Snail repressor family-binding sites for EWS-FLI binding or function.

Cell line-specific kmers recover the AP1 motif reported in Patel et al. (55), and a potentially novel role for TEAD1. The HUVEC specific accessory factor AP1 is found as a high scoring motif in HUVEC cells, but not EWS502 cells. Two highly negative kmers in EWS502 cells correspond to the binding site for TEAD 1. TEAD 1 has been implicated in tumor suppression and growth control and because the absence of TEAD1 binding sites is predictive of EWS-FLI binding in EWS502 cells, but not HUVEC cells, it is tempting to speculate that TEAD1-binding would disrupt EWS-FLI binding in EWS502 cells, but not in HUVEC cells.

### Example 6

### Kmer-SVM Versus PWM

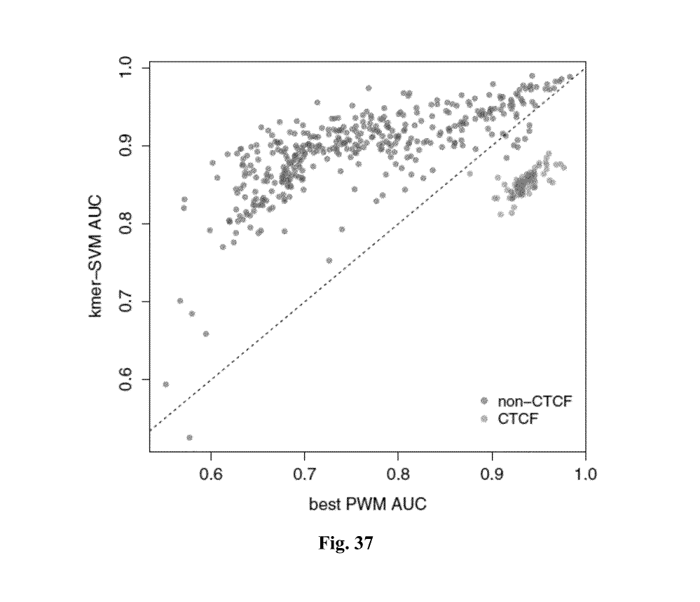

To systematically evaluate the kmer-SVM method on a more exhaustive collection of data, all ChIP-seq data sets generated as part of the ENCODE project (29,30) were analyzed. The 467 sets of peaks generated by ENCODE Uniform processing pipeline (29), after removing any data sets containing <500 peaks (27 sets were excluded by this criterion) were used. Then a kmer-SVM model was trained on each set versus an equal size (1×) set of corresponding random genomic regions and calculated the AUROC. As a comparison, the AUROC of each single PWM was independently calculated in a combined database of 890 PWMs, using as predictors the PWM score of the top hit in each region. FIG. 37 shows that the kmer-SVM prediction outperforms the best single PWM in almost all cases. The only notable exception is the CTCF PWM (red circles), which is predictive for ChIP on CTCF and members of the cohesin complex (RAD21, SMC3), which are known to co-localize with CTCF. CTCF is one of the longest and information rich PWMs and seems to operate in a non-combinatorial manner; therefore, it seemed to be relatively unique in that its genomic binding can be predicted with a single PWM. In addition, its long binding site was not handled optimally by the current kmer-SVM model.

### Discussion

It is shown that a kmer-SVM model as offered via a web server was able to find predictive sets of DNA sequence features in several different genomic data sets and can be used to assess and explore the genomic data and generate testable hypotheses for subsequent biological analysis. Using the existing sequence tools and pipeline flow of the Galaxy platform has greatly facilitated the ease of distribution. The examples, in addition to the previous results on mouse EP300 bound enhancers and melanocyte enhancers, emphasized several key benefits of the kmer-SVM analysis. Using a web server, users can find the essential sequence features, which distinguish a set of experimentally determined genomic regions from random sequence, and identify key accessory factors and repressive elements for biological interpretation and follow-up investigations. In addition, users can use the kmer-SVM to score alternative sequence sets or entire genomes to make predictions of the activity of these regions in the relevant context.

A web server may provide complementarity to existing PWM discovery and scoring tools, including XXmotif, MEME, SCOPE, RSAT, RegAnalyst and Amadeus. XXmotif operates by attempting to optimize the statistical significance of a given PWM. Specifically, XXmotif develops and then iteratively merges PWMs for motifs until P-values cannot be improved. The core of MEME is the use of mixture models, arrived at by means of expectation maximization, to identify motifs. SCOPE uses three different algorithms, separately directed toward identify short non-degenerate motifs, short degenerate motifs and long degenerate motifs, and uses a scoring method to integrate the output from each of these algorithms. SCOPE is a parameter-free program and requires no parameters to be provided by the user. RSAT is a more general toolbox for the analysis of sequence data and uses a tool for motif discovery, which compares the observed occurrence of motifs against the expected presence of that motif, given the distribution of nucleotide occurrence in an organism (37). RegAnalyst uses a series of thresholds applied to the counts of motifs observed in a set of sequences. Amadeus also compares the frequency of the presence of motifs against a background model. In contrast, the web server SVM method shown herein focused on finding combinations of sequence features, which are usually more predictive than single motifs, as show in FIG. 37.

As is currently known, there is only one web server available (http://galaxy.raetschlab.org/) that offers simple SVM functions including several string kernels as well as other common kernels, such as linear and Gaussian. It also provides means to evaluate prediction performance using ROC and PR curves. This server, however, is mainly intended for general use of SVMs by users with a certain level of computational experience. In contrast, the kmer-SVM web method disclosed herein was designed to allow biologists with no prior machine learning expertise to quickly and rigorously analyze regulatory sequence data sets. To do so, methods herein incorporated steps with functionality required for regulatory sequence analyses and took into account the specific properties of regulatory elements. First, the spectrum kernel function was modified to account for the fact that TFs bind to double-stranded DNA. Not only was an exact kmer counted but also counted was its reverse complement kmer. Redundant kmers were then eliminated from the final feature set to remove the possible bias caused by double counting. Second, a step that generated negative sequence sets to match the distribution of sequence length, GC content and repeat fraction of the corresponding positive sets was used. This ensured that the SVM classification reflects the most biologically relevant mechanisms. Third, provided was a means to interpret and explain the results by calculating the SVM weights of kmers from a list of support vectors, the primary output of SVM training None of these functionalities provided by the present invention provided on a web server is available at the Galaxy server at Ratsch's laboratory.

### Example 7

### Gapped k-mers

k-mer based approaches may have difficulty in estimating long k-mer frequencies in a finite set of biological samples. Presented herein is a general solution to this problem, and the method can be applied to improve the statistical robustness of any of the aforementioned k-mer based approaches or others which use k-mer frequencies as direct features or as an intermediate step in the construction of more complex sequence descriptors.

When using k-mers, larger k's will resolve larger binding sites and more accurately reflect biological function. For example, some transcription factors (such as ABF1 or CTCF) have relatively long binding sites that cannot be completely represented by short k-mers. So longer k-mers capture more relevant information; however, there is a limitation on the maximum length k which can be effectively used in statistical algorithms. Because longer k-mers are more sparsely populated in any finite training sequence set, there is a maximum length k for which the k-mer frequencies can be robustly estimated. Thus in practice, a k is chosen which is a tradeoff between resolving features and robust estimation of their frequencies. To overcome the finite training set size problem, the present invention may employ gapped k-mer frequencies. A gapped k-mer has a length l, and a number of informative columns within that l-mer, k, which reflects the base pairs which actually affect the strength of the TF-DNA binding interaction. It was found that using gapped k-mers may improve the reliability of the l-mer frequency estimation for a finite genomic training set, because while l-mers become sparsely populated, gapped k-mers will still have many instances in the training set, and thus their frequencies can be more reliably estimated. The observed gapped k-mer frequency distribution was used for all gapped k-mers to estimate the ungapped l-mer frequencies, which are sparsely populated. Mathematically this turned out to be the minimum norm estimate for the l-mer frequencies given the frequencies for all gapped k-mers. he matrix, W, mapping between these two spaces was derived. A closed form for this matrix was obtained by studying the combinatorial properties of the incidence matrix.

### Problem Statement

In any given sequence sample, there are observed counts of gapped k-mers and ungapped l-mers. The fundamental assumption is that the counts of gapped k-mers in this sample are sufficient to define its biological function, and are also more robustly estimated from the sequence sample. Instead of using the observed counts of ungapped l-mers, the most robust set of ungapped l-mers were sought that was also consistent with the gapped k-mer distribution. By robust, it is meant that this estimate is resilient to small changes in the input or training set, even for large l for which the actual l-mer counts are very sparse. A classifier based on these more robustly estimated l-mer counts was consequently also more robust in the sense that it was less sensitive to small changes in the input or training set, and is therefore a more stable predictor than a classifier based on exact counts.

Because the mapping from ungapped l-mers to gapped k-mers is underdetermined, there are many sets of l-mer counts that could have produced the observed set of gapped k-mer counts. Proposed as the best set of l-mer counts is the minimum norm ell-mer distribution consistent with the gapped k-mer distribution. This is also the solution that minimizes the mean-squared error from a constant (flat) l-mer distribution. The observed set of ungapped l-mers is only one set of sequences which would have produced the given gapped k-mer counts. The minimum norm distribution was in some sense the most likely of all sequences which could have produced the observed gapped k-mer counts.

For the case of DNA sequences, the alphabet is {A, C, G, T}, so the length of the alphabet is b=4, but the solution for the optimal l-mer count distribution presented below is valid for any b. Ungapped l-mers, and gapped k-mers of length l, with k ungapped (informative) positions were considered.

Definition 1
The set of ungapped l-mers is ={uⱼ}≦j≦N=b^{l}, the set of all different sequences of length l over the alphabet {0, 1, . . . , b−1}.

Definition 2
The set of gapped k-mers is V={vᵢ}, ^{k}1≦i≦M=(ₖ^{l})b^{k}, the set of all gapped k-mers of length C with k known bits and l−k gaps, where k<l.

Definition 3
The matrix which maps ungapped l-mers to gapped k-mers is the matrix A M×N=[aᵢ, j], a binary matrix defined as the following:

$${a}_{i , j} = \{ \begin{matrix}1 & if {v}_{i} matches {u}_{j} \\ 0 & otherwise\end{matrix}$$

Here “vᵢ matches u₁” means that all ungapped positions in the gapped k-mer vᵢ have the same letter of the alphabet as the corresponding position in the ungapped l-mer uⱼ.

The ungapped count vector is defined as follows:

Definition 4
x is a vector of length N, where xⱼ is the count for uⱼ, and the gapped count vector is:
Definition 5
y is a vector of length M, where yᵢ is the count for vᵢ.

Given the above definitions, the mapping from l-mer counts to gapped k-mer counts can be written as:

y=Ax (1)

As shown below, while it is usually but not always the case that M<N, since the rank of the matrix A, rank (A)=Σₙ₌₀^{k}(ₙ^{l})(b−1)ⁿ<N=b^{l}=Σₙ₌₀^{l}(ₙ^{l})(b−1)ⁿ for k<l, this system is always underdetermined. Therefore, there are many possible l-mer count vectors x that would produce the same gapped k-mer count vector y. While the maximum entropy x is probably the most robust estimate to use, its solution is nonlinear and would likely require prohibitive numerical computation. As a reasonable and tractable alternative, chosen as the next best alternative was the minimum L2-norm solution to Eq. (1), \hat{x}.

### Theorem 1

Suppose that the matrices A, Q and A are defined as above. Then the minimum norm estimate for x is given by \hat{x}=Wy, where W_{N×M} can be written as the following:

W=A^{T}QΛ⁻¹Q^{T} (2)

### Proof

To find the x which minimizes the L2-norm x^{T}x, let

$$F = \frac{1}{2} {x}^{T} x - λ f , \qquad ( 3 )$$

where f=Ax−y=0 is the constraint that satisfies (1), and λ is a vector of Lagrange multipliers. Minimizing yields

$$\frac{\partial F}{\partial x} = x - {A}^{T} λ = 0 and \frac{\partial F}{\partial λ} = - ( Ax - y ) = 0. \qquad ( 4 )$$

Since A^{T} is not invertible, solve for x from x=A^{T}X and use this in Ax−y=0 to get

y=AA^{T}λ. (5)

Since AA^{T} is a positive semidefinite matrix, it admits the eigen decomposition AA^{T}=QΛQ^{T} where the matrix Λ is a diagonal matrix having nonzero eigenvalues of AA^{T} on its diagonal and the columns of Q are normalized orthogonal eigenvectors ordered similarly. It is obvious that Q^{T}Q=I and it is not hard to prove that QQ^{T}A=A
Multiplying on the left by A^{T}QΛ⁻¹Q^{T} yields the minimum norm solution:

Wy=A^{T}QΛ⁻¹Q^{T}y=A^{T}λ=\hat{x}. (6)

The derivation of a simple form for the matrix W=A^{T}QΛ⁻¹Q^{T}, generates the minimum norm x from the observed gapped k-mer counts y, by \hat{x}=Wy, is the main result of this paper.

It is worth noting that the minimum L2-norm x can also be thought of as the minimum mean square error or the most likely distribution under the assumption that the xj's are independent and have a joint normal prior probability distribution with equal variances and expected values for all the l-mer counts:

$$F ( x ) = {( 2 π )}^{- \frac{N}{λ}} {\vert {\sum }_{x} \vert}^{- \frac{1}{2}} {e}^{- \frac{1}{2} {( x - \overline{x} )}^{T} {\sum }_{x}^{- 1} ( x - \overline{x} )} \qquad ( 7 )$$

where Σx=σ²I_{N} is a diagonal matrix with constant elements on the diagonal and x̅ is a constant vector, i.e. x̅ᵢ=c. The x that maximizes (7) subject to the constraints given by (1) turns out to be the minimum norm solution. The proof for this is very similar to the proof of Theorem 1, as follows.

Proof

Applying the Lagrange multipliers technique to find the x that maximizes the logarithm of F(x) subject to the constraints given in (1):

x− x̅=A^{T}λ (8)

Reordering (8) and applying (1) the following was obtained

y=AA^{T}λ+A x̅. (9)

Now, consider the following eigen decomposition for AA^{T}:

AA^{T}=QΛQ^{T}. (10)

Multiplying both sides of (9) by A^{T}QΛ⁻¹Q^{T} and applying (10) the following was obtained

A^{T}QΛ⁻¹Q^{T}(y−A x̅)=A^{T}QΛ⁻¹Q^{T}AA^{T}λ (11)

Reordering (11) and applying (8) the following was obtained

\hat{x}=W(y−A x̅)+ x̅. (12)

In the case disclosed herein, there is no difference between the expected values for different l-mers counts, i.e. x̅ᵢ=c. Also it can be shown that the sum of the elements in rows of matrix WA is equal to 1, therefore, in this case W A x̅=I x̅, and equation (12) can be simplified to

\hat{x}=Wy=A^{T}QΛ⁻¹Q^{T}y. (13)

hence W=A^{T}QΛ⁻¹ Q^{T}, as required. Note that \hat{x} is independent of x only if all the c-mers have equal expected counts.

The derivation of an explicit form for the matrix W, which is shown to be the Moore-Penrose pseudoinverse of A and maps gapped k-mer counts to ungapped l-mers count estimates, is the central result of this Example. Although Eq. (2) gives a method to obtain the weight matrix W from the eigen decomposition of matrix AA^{T} given in (10), numerical calculation of the eigenvectors for AA^{T} would be computationally expensive as the size of matrix A grows very rapidly for large values of l, k, and b. For example, for (l=15, k=7, b=4), there is N≈10⁹, and M≈10⁸. However, considering the symmetry of matrix A, shown in the detailed proof that follows is that the matrix W has a simple structure. In this matrix, the entry w_{i, j} only depends on the number of mismatches between the l-mers uᵢ and the gapped-kmer vⱼ. So there exists a finite sequence of only k+1 values w₁, . . . , wₖ such that w_{i, j}=wₘ if uᵢ and vⱼ have exactly m mismatches. A mismatch is defined to be a difference between a gapped k-mer and an l-mers in an ungapped position. So, for example, if N denotes a gap, N A N G and AC G G have one mismatch, and AN GG and AC G G have zero mismatches. wₘ is largest for m=0 and typically becomes negative for m=1, and then oscillates about zero. See Sect. 7 for a concrete example. Thus, the entries of matrix W are limited to a small set of values {w₀, . . . , wₖ} and these values are specified by the following theorem:

### Theorem 2

The values of the elements of matrix W are given by the following equation, in which, l is the sequence length, b is the size of the alphabet, k is the number of known bits, and m is the number of mismatches between the corresponding l-mer uᵢ and the gapped-kmer vⱼ:

$${w}_{l , k , m} = \frac{( \begin{matrix}k - l \\ m\end{matrix} )}{{b}^{l} ( \begin{matrix}l \\ k\end{matrix} ) ( \begin{matrix}k \\ m\end{matrix} )} {\sum }_{n = 0}^{k - m} ( \begin{matrix}l \\ n\end{matrix} ) {( b - 1 )}^{n} \qquad ( 14 )$$

Note that matrix W clearly depends on t, k and b but for fixed t, k and b, the entry on row i and column j of this matrix only depends on m, the number of mismatches between vᵢ and uⱼ, i.e. differences between ungapped positions in the gapped k-mer and the ungapped l-mer. Hence elements of W are limited to a small set of k+1 values, as specified by the above theorem, and is very simple and easy to compute.

What is claimed is:

1. A computer-implemented method for identifying nucleic acid regulatory sequences, comprising,
a) providing a positive sequence set having a sequence profile;
b) providing a negative sequence set;
c) training a support vector machine classifier to generate a set of ranked kmer-SVM weights and a set of class predictions using cross-validation; and
d) analyzing the classifier performance and the resulting predictive sequence features.

2. The method of claim 1, wherein the positive sequence set is provided from experimental data.

3. The method of claim 1, wherein the negative sequence set is matched to the positive sequence set profile by GC content, length, and repeat fraction from known nucleic acid sequences.

4. The method of claim 3, wherein the negative sequence set is generated by random sampling.

5. The method of claim 1, wherein training a support vector machine classifier comprises using a string kernel and features comprising a set of kmers.

6. The method of claim 5, wherein the string kernel is a spectrum kernel using a single length kmer or a weighted spectrum kernel using a user specified range of k's with equal weighting.

7. The method of claim 5, wherein a normalized kmer count vector is generated for each sequence.

8. The method of claim 5, comprising identifying support vectors that most accurately distinguish the positive and negative sequence sets.

9. The method of claim 1, wherein initial positive and negative sets are randomly partitioned into a predetermined number of distinct test sets, and the receiver operating characteristic and precision-recall curves for each test set is generated using the trained support vector machine classifier trained on the plurality of test sets minus the single test set being examined.

10. The method of claim 1, further comprising testing the predictive sequence features in vitro assays, in vivo assays, or both.

11. The method of claim 1, wherein the support vector machine finds an optimal decision boundary using 6-mer sequences as features.

12. The method of claim 11, wherein the optimal decision boundary comprises a SVM discriminatory function comprising fsvm(x)=w(x)+b, where the distance of a sequence x from the decision boundary determines the predicted class of sequence x.

13. The method of claim 11, wherein the 6-mer sequences comprise the sequences shown in Table 1.

14. The method of claim 1, wherein the predictive sequence features are regulatory sequences.

15. The method of claim 14, wherein the regulatory sequences are enhancer sequences, repressor sequences or insulator sequences.

16. The method of claim 13, wherein the most predictive k-mer is AGCTGC for predicting enhancer sequences.

17. The method of claim 13, wherein the 6-mers having the largest positive SVM weights are in Table 1A.

18. The method of claim 1, comprising using a training data set of known sequences as a derived from EP300/CREBBP-bound enhancer sequences, ChIP-seq, ChIP-chip, or DNase I hypersensitivity data sets.

19. A computer program comprising machine-executable instructions to cause a computer system to implement a method for identifying nucleic acid regulatory sequences, comprising,
a) providing a positive sequence set having a sequence profile;
b) providing a negative sequence set;
c) training a support vector machine classifier to generate a set of ranked kmer-SVM weights and a set of class predictions using cross-validation; and
d) analyzing the classifier performance and the resulting predictive sequence features.

20. A computer system for implementing a method for nucleic acid regulatory sequences, comprising,
a processing unit operable to
a) provide a positive sequence set having a sequence profile;
b) provide a negative sequence set;
c) train a support vector machine classifier to generate a set of ranked kmer-SVM weights and a set of class predictions using cross-validation; and
d) analyze the classifier performance and the resulting predictive sequence features.
